(19) United States
(12) Patent Application Publication
(10) Pub. No.: US 2007/0087131 A1
(43) Pub. Date: Apr. 19, 2007

(54) Methods of forming multilayer articles by surface treatment applications

(76) Inventors: Gerald A. Hutchinson, Coto De Caza, CA (US); Robert A. Lee, Bowdon Cheshire (GB); Said K. Farha, Pleasantville, NY (US); Sriram Tharmapuram, Stamford, CT (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/546,654

(22) Filed: Oct. 12, 2006

Related U.S. Application Data
(60) Provisional application No. 60/726,973, filed on Oct. 14, 2005.
(60) Provisional application No. 60/737,536, filed on Nov. 17, 2005.
(60) Provisional application No. 60/761,667, filed on Jan. 24, 2006.

(51) Int. Cl. H05H 1/00

(52) U.S. Cl. 427/533

(57) ABSTRACT

Coated articles may comprise one or more coating layers, including water resistant coatings. A method comprises applying such coating layers by treating the article substrate by one or more methods selected from flame treatment, corona treatment, ionized air treatment, plasma air treatment and plasma arc treatment and dip, spray or flow coating. Additionally, a method comprises injection molding a first substrate material to form an article, treating the article surface by one or more methods selected from flame treatment, corona treatment, ionized air treatment, plasma air treatment and plasma arc treatment, and overmolding the article substrate with one or more barrier materials.

### CROSS-REFERENCE TO RELATED APPLICATIONS

This application claims the priority benefit under 35 U.S.C. § 119(e) of the provisional applications 60/726,973, filed Oct. 14, 2005, 60/737,536, filed Nov. 17, 2005, and 60/761,667, filed Jan. 24, 2006, which are hereby incorporated by reference in their entireties.

### BACKGROUND OF THE INVENTION

1. Field of the Invention

This invention relates to surface treatments of articles, including those having gas barrier and water-resistant layers. It also relates to methods of making such surface treated articles by treating one or more surfaces of the article prior to, during, and after formation of one or more layers on the article substrate.

2. Description of the Related Art

Preforms are the products from which articles, such as containers, are made by blow molding. A number of plastic and other materials have been used for containers and many are quite suitable. Some products such as carbonated beverages and foodstuffs need a container, which is resistant to the transfer of gases such as carbon dioxide and oxygen. Coating and layering of such containers with certain barrier or adhesive materials has been suggested for many years. A resin now widely used in the container industry is polyethylene terephthalate (PET), by which term we include not only the homopolymer formed by the polycondensation of [beta]-hydroxyethyl terephthalate but also copolyesters containing minor amounts of units derived from other glycols or diacids, for example isophthalate copolymers.

The manufacture of biaxially oriented PET containers is well known in the art. Biaxially oriented PET containers are strong and have good resistance to creep. Containers of relatively thin wall and light weight can be produced that are capable of withstanding, without undue distortion over the desired shelf life, the pressures exerted by carbonated liquids, particularly beverages such as soft drinks, including colas, and beer.

Thin-walled PET containers are permeable to some extent to gases such as carbon dioxide and oxygen and hence permit loss of pressurizing carbon dioxide and ingress of oxygen which may affect the flavor and quality of the bottle contents. In one method of commercial operation, preforms are made by injection molding and then blown into bottles. In the commercial two-liter size, a shelf life of 12 to 16 weeks can be expected but for smaller bottles, such as half liter, the larger surface-to-volume ratio severely restricts shelf life. Carbonated beverages can be pressured to 4.5 volumes of gas but if this pressure falls below acceptable product specific levels, the product is considered unsatisfactory. Many of the materials used to make plastic containers are also susceptible to water vapor. The transmission of water vapor into the containers often results in the rapid deterioration of the food stuffs packaged within the container.

Thus, it is important that the surfaces and various layers of containers provide an effective barrier against gas and/or water permeability. While many different types of materials have been used to act as barriers against such permeability, such materials are often incompatible with other barrier material or lack the desired adhesion between materials required in consumer container. Generally, plastics have chemically inert and nonporous surfaces with low surface tensions causing them to be non receptive to bonding with substrates, printing inks, coatings and adhesives.

### SUMMARY OF THE INVENTION

Described herein are coated articles and methods of making coating articles. In some embodiments, an article is coated with one or more layers of a coating material. Preferably, the articles are coated with one or more layer of functional coating material. In some embodiments, one or more layers comprise mixtures of two or more functional coating materials. In some embodiments, an article comprises a first layer and a second layer, wherein the first layer and second layer comprises different functional coating materials. In any of these embodiments, one or more surface treatments selected from the group consisting of flame treatment, corona treatment, ionized air treatment, plasma air treatment and plasma arc treatment may be applied to a surface of the article substrate prior to coatings or between coatings.

One aspect of some embodiments includes a method for reducing the water and gas permeability of an article substrate. In some embodiments, the method comprises treating an article substrate by one or more methods selected from flame treatment, corona treatment, ionized air treatment, plasma air treatment and plasma arc treatment, applying a first water-based solution, dispersion, or emulsion of a gas barrier material comprising one or more selected from a vinyl alcohol polymer or copolymer and a Phenoxy-type Thermoplastic to a surface of an article substrate by dip, spray or flow coating to form a first inner coating layer, drying the first inner coating layer. Optionally, the first inner coating layer may be treated by one or more methods selected from flame treatment, corona treatment, ionized air treatment, plasma air treatment and plasma arc treatment. The method may further comprise applying a second water-based solution, dispersion or emulsion of a water-resistant coating material comprising one or more selected from the group consisting of an acrylic polymer or copolymer, a polyolefin polymer or copolymer, a polyurethane, an epoxy polymer, and a wax to an outer surface of the article by dip, spray or flow coating to form a second coating layer, and drying the second coating layer. In some embodiments, the drying of one or more layers is performed so as to form an article that exhibits substantially no blushing when exposed to water.

In certain embodiments, the substrate and/or one or more coating layers are treated to aid the adhesion of a coating layer. Treatment modalities include flame treatment, corona treatment, ionized air treatment, plasma air treatment, plasma arc treatment, and combinations thereof. These treatments aid in interlayer adhesion, especially between dissimilar materials. Using such a system of surface pre-treatment prior to coating, it is possible to achieve excellent adhesion between polypropylene (with or without modification or grafting of maleic anhydride or other compound) and polylactic acid, EVOH or PET; between polylactic acid and polyethylene (with or without modification or grafting of maleic anhydride or other compound), between EvOH and EAA or polypropylene, and any and all combinations of the above individual materials with each other and with other resins such as phenoxy-type thermoplastics, thermoplastic epoxy resins, and other thermoplastics.

The treatment may be effected in-line as part of the coating apparatus. In a preferred method, a substrate, such as a preform or bottle, is treated with air plasma and/or chemical plasma, the treated substrate is then coated with a first layer of coating material to form a coated substrate. The coating may be done by flow coating, dip coating, spray coating, overmolding (such as by IOI or index), or any other suitable coating process. In some circumstances, most notably where the coating is solvent based, the coating is preferably cured and/or dried. The coated substrate is optionally treated with air plasma and/or chemical plasma, and then coated with a further layer. The process of treating, coating, and optionally curing/drying may be repeated as often as desired to obtain the desired number and character of layers upon the article. In some embodiments, the treating step is not performed between each coating step.

In another embodiment, one or more compounds are applied to the surface of a layer or substrate prior to coating to increase adhesion, e.g. by altering surface tension, polarity, and/or other surface properties that can affect adhesion. For example, a liquid comprising one or more polar molecules may be applied to a preform, container or other article by dip, flow or spray coating (with or without using the particular apparatus described herein). In one embodiment, the liquid comprises monomer, oligomer, and or polymer corresponding to the polymer of the layer or substrate. For example, a PLA substrate may be coated or otherwise exposed to a liquid comprising lactic acid, PLA oligomer and/or PLA polymer. The article may then be coated with a material such as EAA, polyolefin or a blend thereof.

In one particular embodiment, a method of applying one or more coatings to an article comprises treating a surface of an article substrate with one or more selected from the group consisting of flame treatment, corona treatment, ionized air treatment, plasma air treatment and plasma arc treatment. The method further comprises applying a first water-based solution, dispersion, or emulsion of a gas barrier material to a surface of the article substrate by dip, spray or flow coating to form a first coating layer, and drying the first coating layer. The method may also comprise applying a second water-based solution, dispersion or emulsion of a water-resistant coating material to an outer surface of the article by dip, spray or flow coating to form a second coating layer, and drying the second coating layer. In some embodiments, the step of treating a surface of an article substrate is prior to the step of applying the gas barrier material. In one particular embodiment, the method comprises treating the dried, first coating layer with one or more selected from the group consisting of flame treatment, corona treatment, ionized air treatment, plasma air treatment and plasma arc treatment, prior to applying a second water-based solution, dispersion or emulsion of a water-resistant coating material to an outer surface of the article by dip, spray or flow coating to form a second coating layer and drying the second coating layer.

As described herein, many different functional materials may be used including gas barrier material and water-resistant materials. In one embodiment, a gas barrier material comprises one or more of a vinyl alcohol polymer or copolymer and a Phenoxy-type Thermoplastic. In another embodiment, the gas barrier material comprises a vinyl alcohol polymer or copolymer. In another embodiment, the gas barrier material comprises one or more selected from EVOH and PVOH. In some embodiments, the gas barrier material comprises a Phenoxy-type Thermoplastic. In certain embodiments, the gas barrier materials comprises a PHAE. In other embodiments, the gas barrier material comprises a blend of two or more selected from EVOH, PVOH, and a PHAE.

In some embodiments, the water resistant coating material comprises a polyolefin polymer or copolymer. In some embodiments, the water resistant coating material comprises PE, PP, or copolymers thereof. In some embodiments, the PE comprises PEMA. In some embodiments, the PP comprises PPMA. In some embodiments, the water resistant coating material comprises a wax. In some embodiments, the water resistant coating material comprises an acrylic polymer or copolymer. In some embodiments, the water resistant coating material comprises blend of polypropylene and EAA.

In some of the foregoing embodiments, the article substrate comprises one or more selected from the group consisting of PET, PP, and PLA. In some embodiments, a top coat layer of the article comprises PEI. In some embodiments, the water resistant coating layer is a top coat layer.

In some embodiments, the coatings can be applied in more than one pass such that the coating properties are increased with each coating layer. The volume of coating deposition may be altered by the article temperature, the article angle, the solution/dispersion/emulsion/suspension/melt temperature or viscosity. The multiple coatings of preferred processes results in multiple layers with substantially no distinction between layers, improved coating performance and/or reduction of surface voids and coating holidays.

In some embodiments, the surface of the article substrate comprises one or more selected from a polyester, PLA, or polypropylene. In preferred embodiments, the surface comprises PET. In some embodiments, the surface comprises amorphous and/or semicystalline PET. In some embodiments, the article is a container. In other embodiments, the article is a preform.

In one embodiment, a method for making a barrier coated article comprises providing an article, said article having a surface and treating a surface of the article with one or more selected from the group consisting of flame treatment, corona treatment, ionized air treatment, plasma air treatment and plasma arc treatment. The method further comprises placing a first barrier material on the surface of the article to form a barrier-layered article. In some embodiments, the first barrier material is placed on the surface by a coating method selected from the group consisting of dip coating, spray coating, flow coating, and overmolding. In one preferred embodiment, the coating method is over molding. In another preferred embodiment, the coating method is flow coating. In some of the foregoing embodiments, the surface of the article comprises one or more selected from PET, PP, or PLA. In some embodiments, the first barrier material comprises one or more selected from a vinyl alcohol polymer or copolymer and a Phenoxy-type Thermoplastic.

In some embodiments, the foregoing method further comprises treating a surface of the barrier layered article with one or more selected from the group consisting of flame treatment, corona treatment, ionized air treatment, plasma air treatment and plasma arc treatment. The method may also comprise placing a second barrier material on the surface of the article to form a barrier-layered article. In some embodiments, the second barrier material is placed on the surface by a coating method selected from the group consisting of dip coating, spray coating, flow coating, and overmolding. In certain embodiments, the second barrier material comprises one or more selected from the group consisting of an acrylic. polymer or copolymer, a polyolefin polymer or copolymer, a polyurethane, an epoxy polymer, and a wax.

In one embodiment, a method of forming an injected molded preform comprises injection molding a first material in a first mold cavity. In certain embodiments, the first material comprising one or more selected from the group consisting of polyester, polyolefin, polylactic acid, and a Phenoxy-thermplastic. In some embodiments, the first material comprises PEI. The first material may be allowed to cool to form an article. At least a portion of a surface of the article may treated with one or more selected from flame treatment, corona treatment, ionized air treatment, plasma air treatment and plasma arc treatment. In preferred embodiments, a plasma treatment is used. In some embodiments, the article is treated in the first mold cavity. In some embodiments, the article may then be removed from the first mold cavity and treated with a surface treatment. In other embodiments, the article may be transferred to a second mold cavity prior to treatment. In certain embodiments, the article is transferred to a surface treatment module for treatment. In some embodiments, the plasma treatment is delivered to the article by one or more heads of the surface treatment module (e.g., the plasma treater). In another embodiment, the plasma treatment is delivered to the article by a tunnel configured to expose a surface of the article to the plasma treatment. While these are described in terms of a preferable method of plasma treatment, one or more other methods of surface treatment may be used prior to the overmolding step.

In some embodiments, the method may further comprise injection molding a second material on the article in a second mold cavity. In some embodiments, the second material comprises one or more selected from the group consisting of a polyester, a polyolefin, polylactic acid, and a polyamide. In certain embodiments, the second material is directly in contact with the plasma or otherwise treated portion of the surface.

In some embodiments, the coating material is a barrier material. In some preferred embodiments, the barrier material is a gas barrier material. An article may comprise one or more gas barrier layers comprising one or more gas barrier materials. Gas barrier materials may be used to reduce the rate of ingress and egress gas transmission through the article substrate and/or the other layers disposed on the article substrate. In some embodiments, one or more gas barrier material reduces the rate of oxygen transmission across the article substrate. In other embodiments, one or more gas barrier materials reduce the rate of carbon dioxide transmission through the article substrate.

In some embodiments, the gas barrier layer is an inner layer of the one or more layers coated on the article substrate. In some embodiments, the gas barrier layer is the innermost layer or base layer coated on the article substrate.

In some embodiments, a functional coating material is a water-resistant coating material. An article may comprise one or more water-resistant coating layers comprising one or more water-resistant coating materials. In some embodiments, one or more water-resistant coating materials may be used to reduce the rate of water vapor transmission through the article substrate. In some embodiments, a water-resistant coating layer is disposed as a base layer on the article substrate. In some preferred embodiments, the water-resistant coating layer is the top or outermost layer disposed on the article substrate.

In some embodiments, an article comprises one or more gas barrier layers and one or more water-resistant coating layers. In some embodiments, a water-resistant coating layer is disposed on the outside of a gas barrier layer. In other embodiments, a water-resistant coating layer is an outermost or top coating layer.

In some embodiments, the article substrate comprises one or more tie layers. In some embodiments, the tie layer comprises a functional adhesion material. In some embodiments, a tie layer is disposed between the surface of the article substrate and a coating layer. In some of these embodiments, the tie layer is the innermost coating layer. In other embodiments, a tie layer is disposed between two or more coating layers.

There can be various layers with one or more functionalities disposed on an article. In some embodiments, an article may comprise one or more selected from at least one gas-barrier layer, at least one water-resistant coating layer, and at least one tie layer. Any of these layers may be disposed on each other or on the article substrate. For example, a tie layer may be disposed on the surface of the article substrate. A gas barrier layer may be disposed on the tie layer. In some embodiments, a water-resistant coating layer may be disposed on the gas-barrier layer. In other embodiments, a second tie layer may be disposed on the gas-barrier layer. In these embodiments, a water-resistant coating layer may be disposed on the second tie layer.

In some embodiments, an article comprises one or more gas barrier layers comprising one or more of a vinyl alcohol polymer or copolymer and a Phenoxy-type Thermoplastic, and one or more water-resistant coating layers comprising one or more water-resistant materials, wherein the water-resistant material comprises one or more selected from the group consisting of an acrylic polymer or copolymer, a polyolefin polymer or copolymer, a polyurethane, an epoxy polymer, and a wax.

In some embodiments, the gas barrier layer comprises a barrier material having permeability to oxygen and carbon dioxide which is less than that of the material making the article substrate. In some embodiments, the gas barrier layer comprises a barrier material having permeability to oxygen and carbon dioxide which is less than that of polyethylene terephthalate.

In some embodiments, the gas barrier layer comprises a vinyl alcohol polymer or copolymer. In some embodiments, the gas barrier layer comprises EVOH. In other embodiments, the gas barrier layer comprises PVOH. In other embodiments, the gas barrier layer comprises a Phenoxy-type Thermoplastic. In some embodiments, the gas barrier layer comprises a PHAE. In some embodiments, the gas barrier layer comprises a blend of a vinyl alcohol polymer or copolymer and a Phenoxy-type Thermoplastic. In other embodiments, the gas barrier layer comprises a blend of one or more selected from EVOH, PVOH, and a PHAE. In some embodiments, EVOH has an ethylene content of about 60 to about 80 wt %.

In some embodiments, the gas barrier layer comprises a blend of EVOH and a PHAE. In some of these embodiments, the blend comprises about 5 to about 95 wt % of the PHAE, based on the total weight of the EVOH and the PHAE. In other embodiments, the blend comprises about 30 to about 70 wt % of the PHAE, based on the total weight of the EVOH and the PHAE. In some other embodiments, the blend comprises about 40 to about 60 wt % of the PHAE, based on the total weight of the EVOH and the PHAE.

In some embodiments, the water-resistant coating layer comprises one or more water-resistant materials, wherein the water-resistant material comprises one or more selected from the group consisting of an acrylic polymer or copolymer, a polyolefin polymer or copolymer, a polyurethane, an epoxy polymer, and a wax. In some embodiments, the water-resistant coating layer comprises a polyethylene or polypropylene. In other embodiments, the water-resistant coating layer comprises one or more waxes selected from carnauba and paraffins. In some embodiments, the waxes may be mixed with one or more other water-resistant coating materials. In some embodiments, the water-resistant coating layer comprises an acrylic polymer or copolymer. In some embodiments, the water-resistant coating layer comprises a blend of a polyolefin polymer or copolymer and an acrylic polymer or copolymer. In some of these embodiments, the water-resistant coating layer comprises EAA.

Some water-resistant coating layers may comprise a blend of a polypropylene and EAA. In some cases, the blend comprises 30 to about 50 wt % of the EAA based on the total weight of the EAA and the polypropylene. In other cases, the blend comprises 50 to about 70 wt % of the EAA based on the total weight of the EAA and the polypropylene.

In some embodiments, the water-resistant coating layer has permeability to water vapor which is less than that of the article substrate or the gas barrier layer.

One or more layers as described herein may comprise an adhesion enhancing compound. In some embodiments, one or more layers comprise PPMA or PEMA. In some embodiments, one or more layers comprise blends of PPMA and polypropylene: In some embodiments, one or more layers comprise polyethyleneimine (PEI). In some embodiments, one or more layers comprise one or more zirconium salts. In some embodiments, one or more layers comprise one or more organic aldehydes.

The coating layer(s) may container one or more of the following characteristics in preferred embodiments: gas-barrier protection, UV protection, scuff resistance, blush resistance, chemical resistance, water-resistance, and water repellency. In some embodiments, one or more layers comprise one or more selected from the group consisting of O₂ scavengers, CO₂ scavengers, and UV protection additives. In some embodiments, one or more layers is substantially free of VOCs. In some preferred embodiments, all of the layers coated on the article substrate are substantially free of VOCs.

In some embodiments, one or more layers as described herein may be applied to the surface of the article substrate. In some embodiments, one or more layers as described herein are coated on the entire body of the article substrate. In other embodiments, one or more layers as described herein are applied on a portion of the article substrate. In some embodiments, the one or more layers may be applied to a surface of the article substrate. In some embodiments, the surface may be heated before one or more layers is applied.

It is preferred that the one or more layers be applied by dip, spray or flow coating methods. In some embodiments, the layers are applied as aqueous solutions, aqueous dispersions, aqueous suspensions, aqueous emulsions, or melts of the coating materials. In other embodiments, solutions, emulsions, dispersions and suspensions may comprise solvents.

Additionally, in some embodiments, a preform may be made by an injection molding process. One or more article substrate materials described herein may be injected into a first mold cavity. Such material is allowed to cool to form a preform. Such preform may then be overmolded with one or more barrier materials as described herein.

In some embodiments, the article that is coated is a container or a preform. In embodiments where the article is a preform, the method may further comprise a blow molding operation, preferably including stretching the dried coated preform axially and radially, in a blow molding process, at a temperature suitable for orientation, into a bottle container.

All of these embodiments are intended to be within the scope of the inventions herein disclosed. These and other embodiments of the present inventions will become readily apparent to those skilled in the art from the following detailed description of a preferred embodiments having reference to the attached figures, the inventions not being limited to any particular preferred embodiment(s) disclosed.

### BRIEF DESCRIPTION OF THE DRAWINGS

FIG. 1 is an uncoated preform as is used as a starting material for preferred embodiments.

FIG. 2 is a cross-section of a preferred uncoated preform of the type that is coated in accordance with a preferred embodiment.

FIG. 3 is a cross-section of one preferred embodiment of a coated preform.

FIG. 4 is an enlargement of a section of the wall portion of a coated preform.

FIG. 5 is a cross-section of another embodiment of a coated preform.

FIG. 6 is a cross-section of a preferred preform in the cavity of a blow-molding apparatus of a type that may be used to make a preferred coated container of an embodiment of the present invention.

FIG. 7 is a coated container prepared in accordance with a blow molding process.

FIG. 8 is a cross-section of one preferred embodiment of a coated container having features in accordance with the present invention.

FIG. 9 is a three-layer embodiment of a preform.

FIG. 10 there is a non-limiting flow diagram that illustrates a preferred process.

FIG. 11 is a non-limiting flow diagram of one embodiment of a preferred process wherein the system comprises a single coating unit.

FIG. 12 is a non-limiting flow diagram of a preferred process wherein the system comprises multiple coating units in one integrated system.

FIG. 13 is a non-limiting flow diagram of a preferred process wherein the system comprises multiple coating units in a modular system.

FIG. 14 is a cross-section of an injection mold of a type that may be used to make a barrier-coated preform.

FIGS. 15 and 16 are two halves of a molding machine to make barrier-coated preforms.

FIGS. 17 and 18 are two halves of a molding machine to make forty-eight two-layer preforms.

FIG. 19 is a perspective view of a schematic of a mold with mandrels partially located within the molding cavities.

FIG. 20 is a perspective view of a mold with mandrels fully withdrawn from the molding cavities, prior to rotation.

Figures may not be drawn to scale.

### DETAILED DESCRIPTION OF THE PREFERRED EMBODIMENT

Articles having one or more layers and methods for making such articles comprising one or more layers are described herein. In some embodiments, the layers of the articles are coated thereon. In other embodiments, the layers of the articles are formed by other methods such as overmolding. Unless otherwise indicated, the term “article” is a broad term and is used in its ordinary sense and includes, without limitation, wherein the context permits, plates, molded or hollow bodies, pipes, cylinders, containers, blanks, parisons, and performs. Unless otherwise indicated the term “container” is a broad term and is used in its ordinary sense and includes, without limitation, both the preform and bottle container therefrom. The processes as described herein generally are used on preforms or in the formation of prefoms. In some embodiments, the processes are used on bottles or other articles, or in the formation of such articles.

The layers disposed on such articles may comprise thermoplastic materials with good gas-barrier characteristics as well as layers or additives that provide UV protection, scuff resistance, blush resistance, chemical resistance, and/or active properties for O₂ and/or CO₂ scavenging. Preferably, at least one layer of the article is also water resistant.

As presently contemplated, one embodiment of an article is a preform of the type used for beverage containers. Alternatively, embodiments of the articles according to preferred embodiments could take the form of jars, tubes, trays, bottles for holding liquid foods, medical products, or other products, including those sensitive to oxygen exposure or other effects of gas transmission through the container. However, for the sake of simplicity, these embodiments will be described herein primarily as articles or preforms.

Furthermore, the articles described herein may be described specifically in relation to a particular substrate, such as polyethylene terephthalate (PET), but preferred methods are applicable to many other thermoplastics. As used herein, the term “substrate” is a broad term used in its ordinary sense and includes embodiments wherein “substrate” refers to the material used to form the base article. As suggested, one or more layers may be disposed on the article substrate by methods described herein including coating, overmolding, or deposition processes. Other suitable article substrates include, but are not limited to, various polymers such as polyesters, polyolefins, including polypropylene and polyethylene, polycarbonate, polylactic acid (PLA), polyamides, including nylons, or acrylics. These substrate materials may be used alone or in conjunction with each other. More specific substrate examples include, but are not limited to, polyethylene 2,6- and 1,5-naphthalate (PEN), PETG, polytetramethylene 1,2-dioxybenzoate and copolymers of ethylene terephthalate and ethylene isophthalate.

In one embodiment, PET is used as the polyester substrate which is coated. As used herein, “PET” includes, but is not limited to, modified PET as well as PET blended with other materials. One example of a modified PET is “high IPA PET” or IPA-modified PET. The term “high IPA PET” refers to PET in which the IPA content is preferably more than about 2% by weight, including about 2-10% IPA by weight.

One or more layers of coating materials are employed in preferred methods and processes. The layers may comprise one or more barrier layers, one or more UV protection layers, one or more gas barrier layers, one or more oxygen scavenging layers, one or more carbon dioxide scavenging layers, one or more water-resistant layers, and/or other layers as needed for the particular application. In one preferred, but nonlimiting, embodiments, an article comprises one or more water-resistant coating layers and one or more gas barriers layers, wherein the gas is oxygen or carbon dioxide.

As used herein, the terms “barrier material,” “barrier resin,” and the like are broad terms and are used in their ordinary sense and refer, without limitation, to materials which, preferably adhere well to the article substrate and/or one or more other layers. Barrier materials may include “gas barrier materials” which refers to one or more materials having a lower permeability to oxygen or carbon dioxide than the article substrate. Barrier materials may also refer to “water-resistant barrier materials” which refers to one or more materials having a lower water vapor transmission rate or high water resistance than the article substrate. As used herein, the terms “UV protection” and the like are broad terms and are used in their ordinary sense and refer, without limitation, to materials which, when used to coat articles, preferably adhere well to the article substrate and have a higher UV absorption rate than the article substrate. As used herein, the terms “oxygen scavenging” and the like are broad terms and are used in their ordinary sense and refer, without limitation, to materials which, when used to coat articles, preferably adhere well to the article substrate and have a higher oxygen absorption rate than the article substrate. As used herein, the terms “carbon dioxide scavenging” and the like are broad terms and are used in their ordinary sense and refer, without limitation, to materials which, when used to coat articles, preferably adhere well to the article substrate and have a higher carbon dioxide absorption rate than the article substrate. As used herein, the terms “crosslink,” “crosslinked,” and the like are broad terms and are used in their ordinary sense and refer, without limitation, to materials and coatings which vary in degree from a very small degree of crosslinking up to and including fully cross linked materials such as a thermoset epoxy. The degree of crosslinking can be adjusted to provide the appropriate degree of chemical or mechanical abuse resistance for the particular circumstances.

As used herein, the terms “water-resistant,” “water-repellant” and the like are broad terms and are used in their ordinary sense and refer, without limitation, to characteristics of certain material which results in the reduction of rate of water transmission through the material. In some cases, it also refers to the ability of the material to remain substantially chemically unaltered upon exposure to water in its solid, liquid, or gaseous states at various temperatures. In may also include the ability of certain materials to further impede access of water to materials which are water sensitive or which degrade upon exposure to water. As used herein, the term “chemical resistance” and the like is a broad term and is used in its ordinary sense and refers, without limitation, to characteristics of certain materials to remain substantially chemically unaltered upon exposure to chemicals, including water, whether in their gaseous, liquid, or solid state, including, but not limited to, water.

In some embodiments, each layer of a multi-layered article may provide a different function. For example, EVOH and nylon films can be used as oxygen barrier materials in an oxygen barrier layer. As these barrier materials are sensitive to water and moisture, they may be used together with a polyolefin barrier layer to prevent water from entering the article substrate or degrading the oxygen barrier layer. In addition, one or more additional layers comprising a gas barrier material, a water-resistant layer material, or a UV-protective material could be used together with other barrier layers. In some embodiments, tie layers are needed for sufficient cohesion between the one or more layers and/or the article substrate surface.

Once suitable layer materials are chosen, an apparatus and method for commercially manufacturing an article may become necessary. Some such methods of dip, spray and flow coating and apparatuses for dip, spray, or flow coating are described in U.S. patent application Ser. No. 10/614,731 entitled “Dip, Spray and Flow Coating Process for Forming Coated Articles”, now published as 2004/0071885 A1, and PCT/US2005/024726, entitled “Coating Process and Apparatus for Forming Coated Articles”, now published as WO 2006/010141 A2, both of which are herein incorporated by reference in their entireties. Additional methods and materials for coating articles are described in U.S. patent application Ser. No. 11/405,761, entitled “Water-Resistant Coated Articles and Methods of Making Same,” which is herein incorporated by reference in its entirety. Other methods of forming multi-layered articles are described in U.S. Pat. Nos. 6,312,641, 6,391,408, 6,352,426, 6,676,883, 6,939,951, which are herein incorporated by reference in its entirety.

Preferred methods provide for a layer to be coated on an article, specifically a preform, which is later blown into a bottle. Such methods are, in many instances, preferable to placing coatings on the bottles themselves. Preforms are smaller in size and of a more regular shape than the containers blown therefrom, making it simpler to obtain an even and regular coating. Furthermore, bottles and containers of varying shapes and sizes can be made from preforms of similar size and shape. Thus, the same equipment and processing can be used to coat preforms to form several different types of containers. The blow-molding may take place soon after molding and coating, or preforms may be made and stored for later blow-molding. If the preforms are stored prior to blow-molding, their smaller size allows them to take up less space in storage. Even though it is often times preferable to form containers from coated preforms, containers may also be coated.

The blow-molding process presents several challenges. One step where the greatest difficulties arise is during the blow-molding process where the container is formed from the preform. During this process, defects such as delamination of the layers, cracking or crazing of the coating, uneven coating thickness, and discontinuous coating or voids can result. These difficulties can be overcome by using suitable coating materials and coating the preforms in a manner that allows for good adhesion between the layers.

Thus, preferred embodiments comprise suitable coating materials. When a suitable coating material is used, the coating sticks directly to the preform without any significant delamination and will continue to stick as the preform is blow-molded into a bottles and afterwards. Use of a suitable coating material also helps to decrease the incidence of cosmetic and structural defects which can result from blow-molding containers as described above.

One common problem seen in articles formed by coating using certain coating solutions or dispersions is “blushing” or whitening when the article is immersed in (which includes partial immersion) or exposed directly to water, steam or high humidity (which includes at or above about 70% relative humidity). In preferred embodiments, the articles disclosed herein and the articles produced by methods disclosed herein exhibit minimal or substantially no blushing or whitening when immersed in or otherwise exposed directly to water or high humidity. Such exposure may occur for several hours or longer, including about 6 hours, 12 hours, 24 hours, 48 hours, and longer and/or may occur at temperatures around room temperature and at reduced temperatures, such as would be seen by placing the article in a cooler containing ice or ice water. Exposure may also occur at an elevated temperature, such elevated temperature generally not including temperatures high enough to cause an appreciable softening of the materials which form the container or coating, including temperatures approaching the Tg of the materials. In one embodiment, the coated articles exhibit substantially no blushing or whitening when immersed in or otherwise exposed directly to water at a temperature of about 0° C. to 30° C., including about 5° C., 10° C., 15° C., 20° C., 22° C., and 25° C. for about 24 hours. The process used for curing or drying coating layers appears to have an effect on the blush resistance of articles.

It is desirable to achieve the barrier and coating with a water-based solution, dispersion, or emulsion of compositions having barrier properties, gas barrier properties, oxygen barrier properties, carbon dioxide barrier properties, water-resistant properties, or adhesion properties. In preferred embodiments, the water-based solutions, dispersions and emulsions as described herein are substantially or completely free of VOCs and/or halogenated compounds.

### DETAILED DESCRIPTION OF THE DRAWINGS

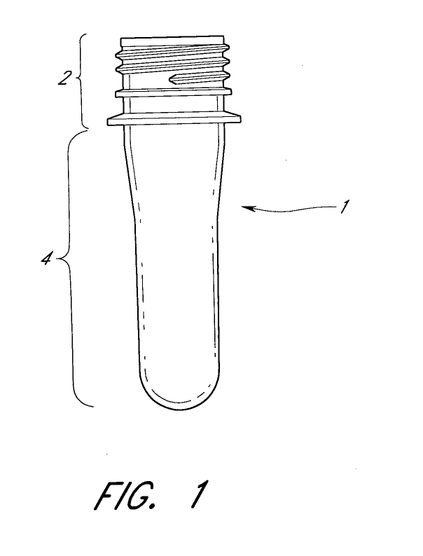

Referring to FIG. 1, a preferred uncoated preform 1 is depicted. The preform is preferably made of an FDA approved material such as virgin PET and can be of any of a wide variety of shapes and sizes. The preform shown in FIG. 1 is a 24 gram preform of the type which will form a 16 oz. carbonated beverage bottle, but as will be understood by those skilled in the art, other preform configurations can be used depending upon the desired configuration, characteristics and use of the final article. The uncoated preform 1 may be made by injection molding as is known in the art or by other suitable methods.

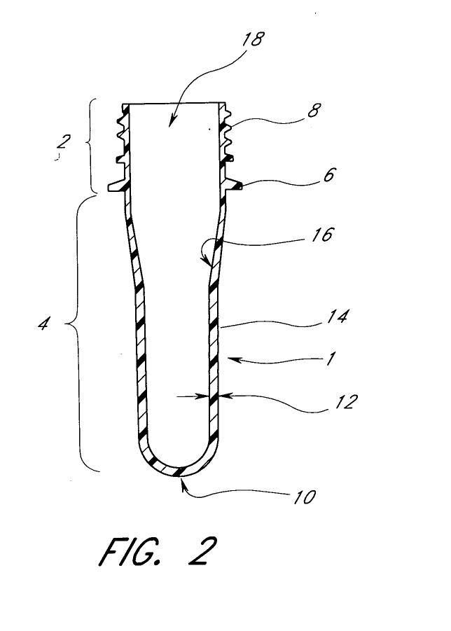

Referring to FIG. 2, a cross-section of a preferred uncoated preform 1 of FIG. 1 is depicted. The uncoated preform 1 has a neck portion 2 and a body portion 4. The neck portion 2, also called the neck finish, begins at the portion 18 to the interior of the preform 1 and extends to and includes the support ring 6. The neck 2 is further characterized by the presence of the threads 8, which provide a way to fasten a cap for the bottle produced from the preform 1. The body portion 4 is an elongated and cylindrically shaped structure extending down from the neck 2 and culminating in the rounded end cap 10. The preform thickness 12 will depend upon the overall length of the preform 1 and the wall thickness and overall size of the resulting container. It should be noted that as the terms “neck” and “body” are used herein, in a container that is colloquially called a “logneck” container, the elongate portion just below the support ring, threads, and/or lip where the cap is fastened would be considered part of the “body” of the container and not a part of the “neck.” In other embodiments which are not illustrated, the neck portion 2 does not include a neck finish (e.g. it does not have threads 8) but does include the support ring. In other non-illustrated embodiments the neck portion 2 does not include a neck finish or a support ring.

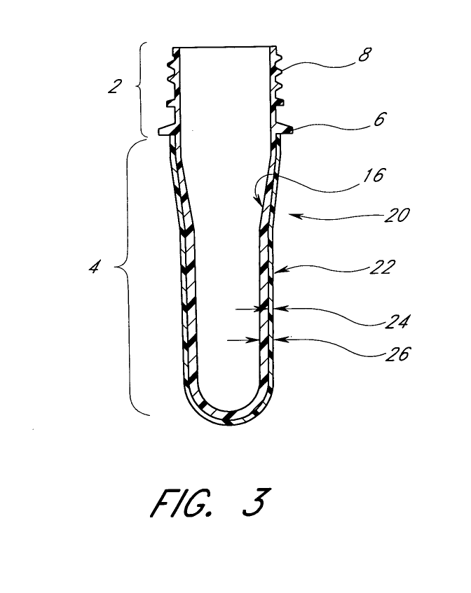

Referring to FIG. 3, a cross-section of one type of coated preform 20 having features in accordance with a preferred embodiment is depicted. The coated preform 20 has a neck portion 2 and a body portion 4 as in the uncoated preform 1 in FIGS. 1 and 2. The coating layer 22 is disposed about the entire surface of the body portion 4, terminating at the bottom of the support ring 6. A coating layer 22 in the embodiment shown in the figure does not extend to the neck portion 2, nor is it present on the interior surface 16 of the preform which is preferably made of an FDA approved material such as PET. The coating layer 22 may comprise one layer of a single material, one layer of several materials combined, or several layers of at least two materials. The overall thickness 26 of the preform is equal to the thickness of the initial preform plus the thickness 24 of the coating layer or layers, and is dependent upon the overall size and desired coating thickness of the resulting container.

In some preferred embodiments, coating layer 22 is a barrier layer. In some embodiments, coating layer 22 is a gas barrier layer. In other embodiments, coating layer 22 is a water-resistant coating layer.

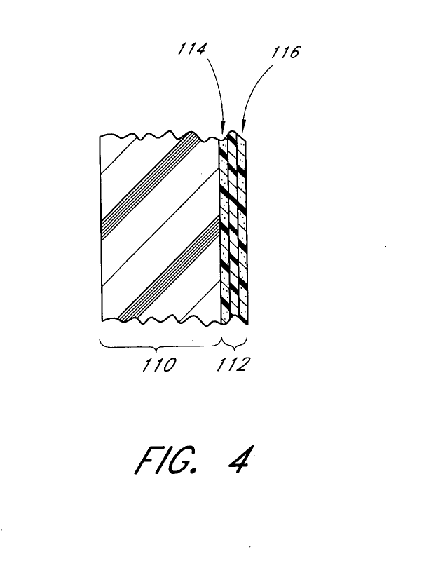

FIG. 4 is an enlargement of a wall section of the preform showing the makeup of the coating layers in one embodiment of a preform. The layer 110 is the substrate layer of the preform while 112 comprises the coating layers of the preform. The outer coating layer 116 comprises one or more layers of material, while 114 comprises the inner coating layer. In preferred embodiments there may be one or more outer coating layers. As shown here, the coated preform has one inner coating layer and two outer coating layers. Not all preforms of FIG. 4 will be of this type.

In some embodiments, inner coating layer 114 is a gas barrier layer and outer coating layer 116 is a water-resistant coating layer. However, in some embodiments, inner coating layer 114 may be a water-resistant coating layer and outer coating layer is an oxygen, carbon dioxide, or a UV resistant layer.

Some of the Figures provide general illustrations of multi-layer preforms, and the configurations of the layers on the preform. Surface treatment of such multi-layer preforms, whether on the article substrate prior to a first coating, between coating layers, and/or after a top coating layer, are not depicted. Many types of the described surface treatments change characteristics of the respective polymers or substrates on the surface of the preform, but do not deposit a layer. However, some surface treatments as described herein deposit layers. In some embodiments, these deposited layers resulting from the surface treatment are very thin, and may be thinner than the illustrated layer.

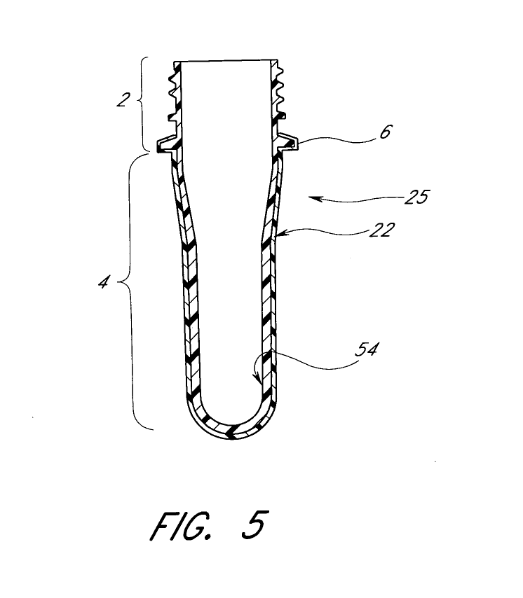

Referring to FIG. 5, another embodiment of a coated preform 25 is shown in cross-section. The primary difference between the coated preform 25 and the coated preform 20 in FIG. 3 is that the coating layer 22 is disposed on the support ring 6 of the neck portion 2 as well as the body portion 4. Preferably any coating that is disposed on, especially on the upper surface, or above the support ring 6 is made of an FDA approved material such as PET.

The coated preforms and containers can have layers which have a wide variety of relative thicknesses. In view of the present disclosure, the thickness of a given layer and of the overall preform or container, whether at a given point or over the entire container, can be chosen to fit a coating process or a particular end use for the container. Furthermore, as discussed above in regard to the coating layer in FIG. 3, the coating layer in the preform and container embodiments disclosed herein may comprise a single material, a layer of several materials combined, or several layers of at least two or more materials.

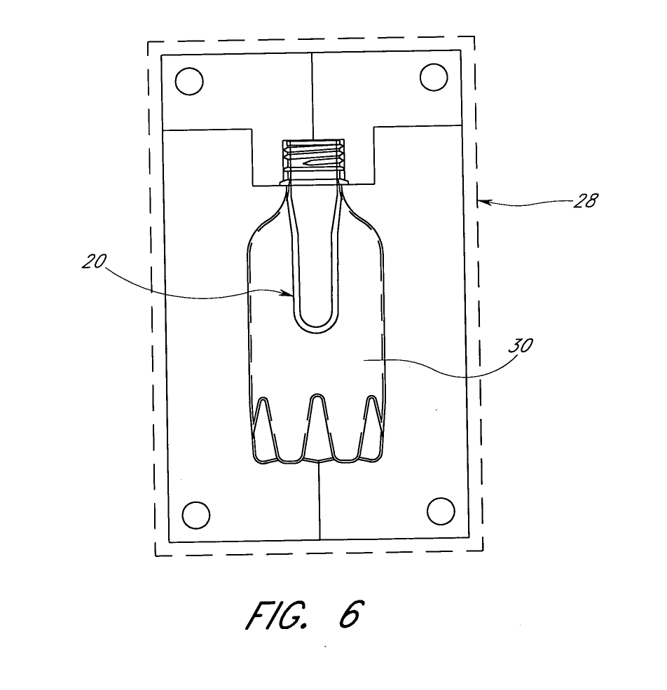

After a coated preform, such as that depicted in FIG. 3, is prepared by a method and apparatus such as those discussed in detail below, it is subjected to a stretch blow-molding process. Referring to FIG. 6, in this process a coated preform 20 is placed in a mold 28 having a cavity corresponding to the desired container shape. The coated preform is then heated and expanded by stretching and by air forced into the interior of the preform 20 to fill the cavity within the mold 28, creating a coated container 30. The blow molding operation normally is restricted to the body portion 4 of the preform with the neck portion 2 including the threads, pilfer ring, and support ring retaining the original configuration as in the preform.

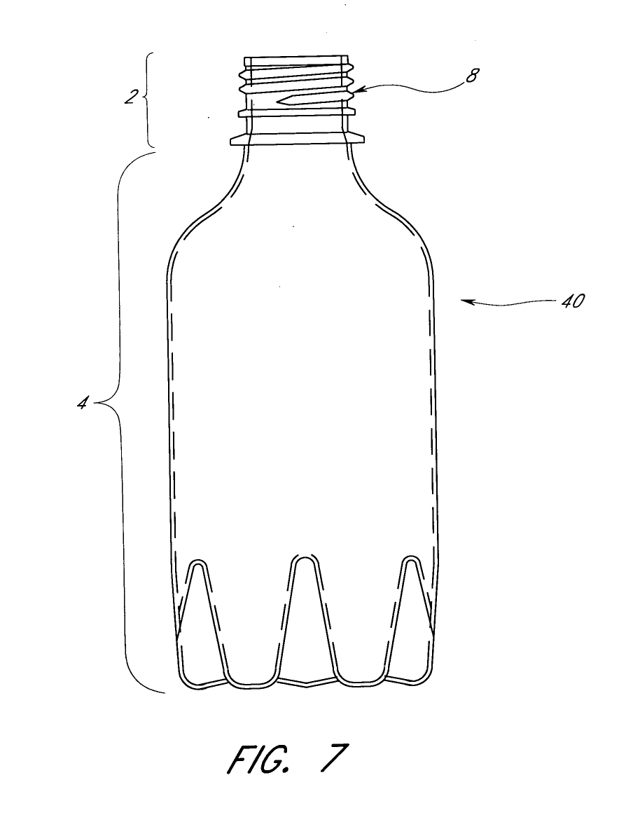

Referring to FIG. 7, there is disclosed an embodiment of coated container 40 in accordance with a preferred embodiment, such as that which might be made from blow molding the coated preform 20 of FIG. 3. The container 40 has a neck portion 2 and a body portion 4 corresponding to the neck and body portions of the coated preform 20 of FIG. 3. The neck portion 2 is further characterized by the presence of the threads 8 which provide a way to fasten a cap onto the container.

When the coated container 40 is viewed in cross-section, as in FIG. 8, the construction can be seen. The coating 42 covers the exterior of the entire body portion 4 of the container 40, stopping just below the support ring 6. The interior surface 50 of the container, which is made of an FDA-approved material, preferably PET, remains uncoated so that only the interior surface 50 is in contact with the packaged product such as beverages, foodstuffs, or medicines. In one preferred embodiment that is used as a carbonated beverage container, a 24 gram preform is blow molded into a 16 ounce bottle with a coating ranging from about 0.05 to about 0.75 grams, including about 0.1 to about 0.2 grams.

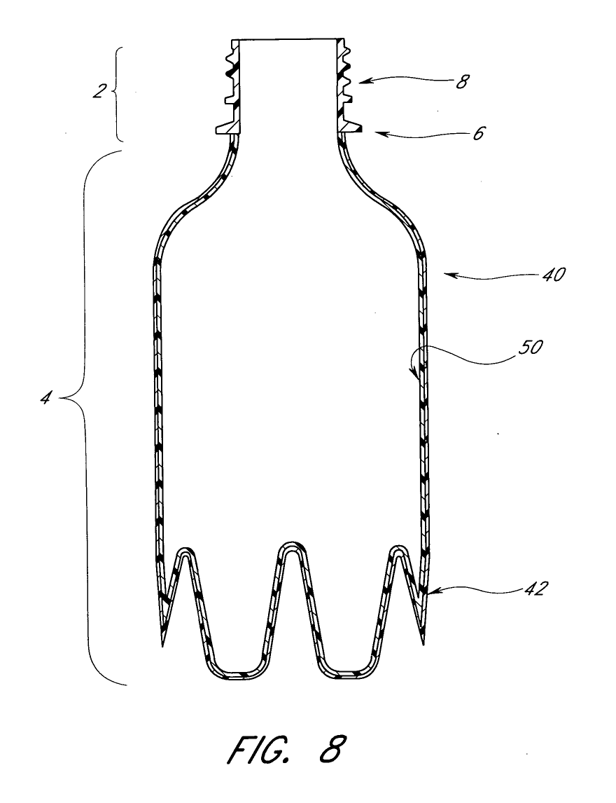

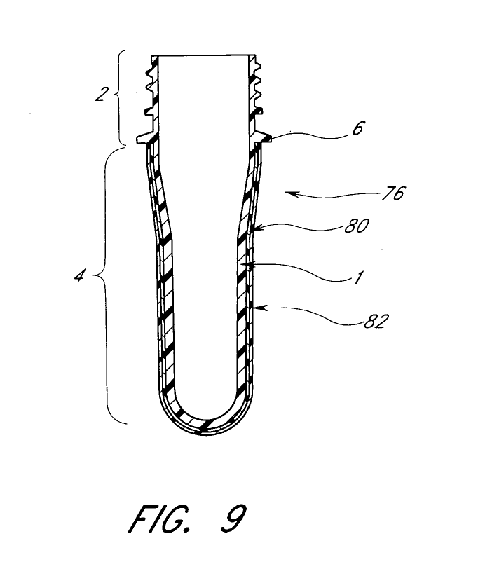

Referring to FIG. 9 there is shown a three-layer coating 76. This embodiment of coated preform is preferably made by placing two coating layers 80 and 82 on a preform 1 such as that shown in FIG. 1. In preferred embodiments, coating layer 80 comprises a gas barrier material and coating layer 82 comprises a water-resistant coating material.

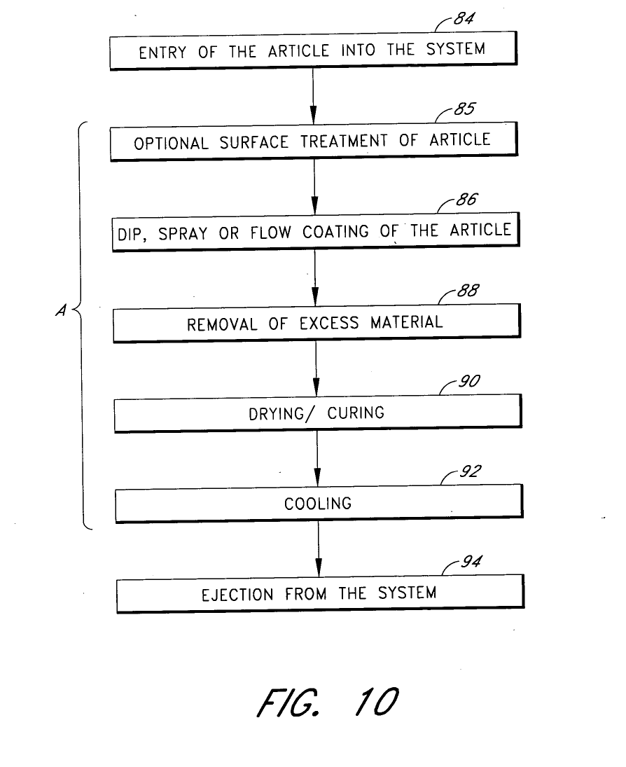

Referring to FIG. 10 there is shown a non-limiting flow diagram that illustrates a preferred process and apparatus. A preferred process and apparatus involves entry of the article into the system 84, optionally surface treating the article with one or more methods selected from flame treatment, corona treatment, ionized air treatment, plasma air treatment and plasma arc treatment 85, dip, spray, or flow coating of the article 86, removal of excess material 88, drying/curing 90, cooling 92, and ejection from the system 94.

Referring to FIG. 11 there is shown a non-limiting flow diagram of one embodiment of a preferred process wherein the system comprises a single coating unit, A, of the type in FIG. 10 which produces a single coat article. The article enters the system 84 prior to the coating unit and exits the system 94 after leaving the coating unit.

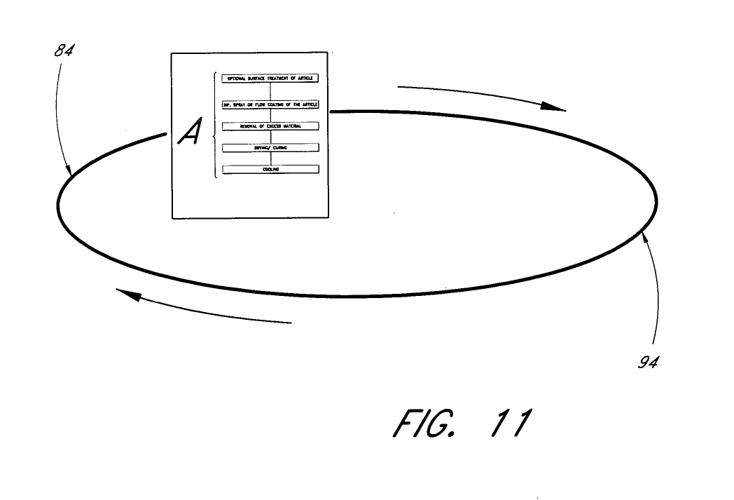

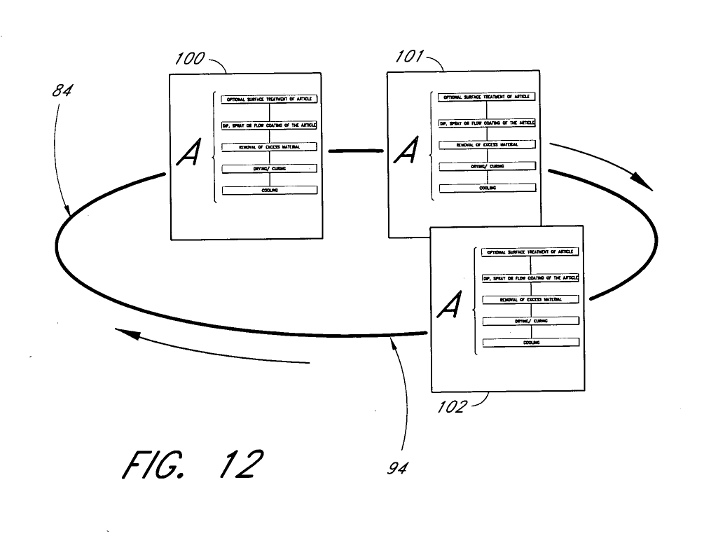

Referring to FIG. 12 there is shown a non-limiting flow diagram of a preferred process wherein the system comprises a single integrated processing line that contains multiple stations 100, 101, 102 wherein each station surface treats (optional), coats and dries or cures the article thereby producing an article with multiple coatings. The article enters the system 84 prior to the first station 100 and exits the system 94 after the last station 102. The embodiment described herein illustrates a single integrated processing line with three coating units, it is to be understood that numbers of coating units above or below are also included.

Referring to FIG. 13, there is shown a non-limiting flow diagram of one embodiment of a preferred process. In this embodiment, the system is modular wherein each processing line 107, 108, 109 is self-contained with the ability to handoff to another line 103, thereby allowing for single or multiple coatings depending on how many modules are connected thereby allowing maximum flexibility. The article first enters the system at one of several points in the system 84 or 120. The article can enter 84 and proceed through the first module 107, then the article may exit the system at 118 or continue to the next module 108 through a hand off mechanism 103 known to those of skill in the art. The article then enters the next module 108 at 120. The article may then continue on to the next module 109 or exit the system. The number of modules may be varied depending on the production circumstances required. Further the individual coating units 104 105 106 may comprise different coating materials depending on the requirements of a particular production line. The interchangeability of different modules and coating units provides maximum flexibility.

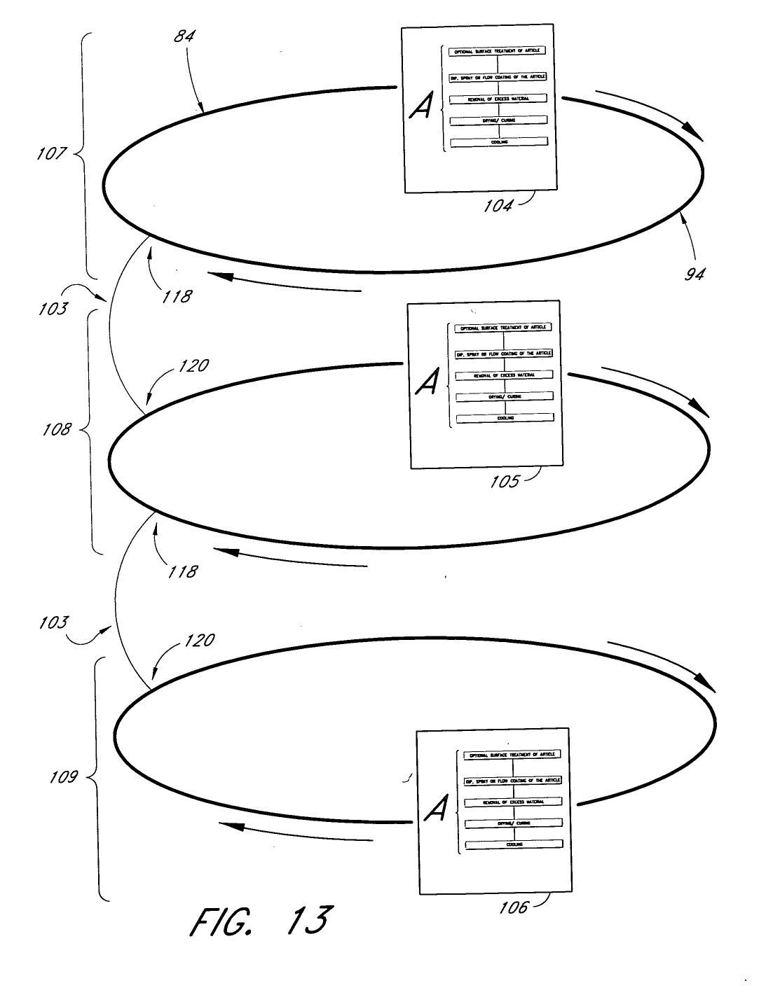

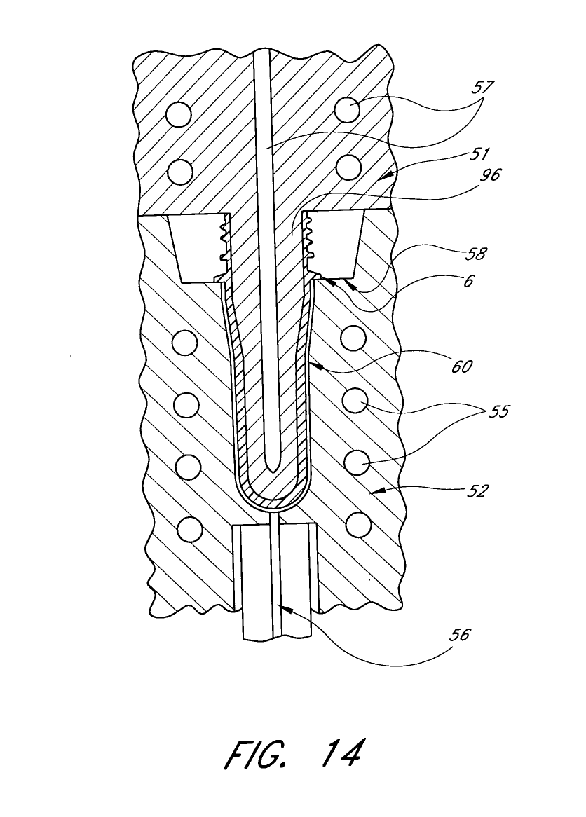

FIG. 14 illustrates a preferred type of mold for use in methods which utilize overmolding. The mold comprises two halves, a cavity half 52 and a mandrel half 51. The cavity half 52 comprises a cavity in which an uncoated preform is placed. The preform is held in place between the mandrel half 51, which exerts pressure on the top of the preform and the ledge 58 of the cavity half 52 on which the support ring 6 rests. The neck portion of the preform is thus sealed off from the body. portion of the preform. Inside the preform is the mandrel 96. As the preform sits in the mold, the body portion of the preform is completely surrounded by a void space 60. The preform, thus positioned, acts as an interior die mandrel in the subsequent injection procedure, in which the melt of the overmolding material is injected through the gate 56 into the void space 60 to form the coating. The melt, as well as the uncoated preform, is cooled by fluid circulating within channels 55 and 57 in the two halves of the mold. Preferably the circulation in channels 55 is completely separate from the circulation in the channels 57.

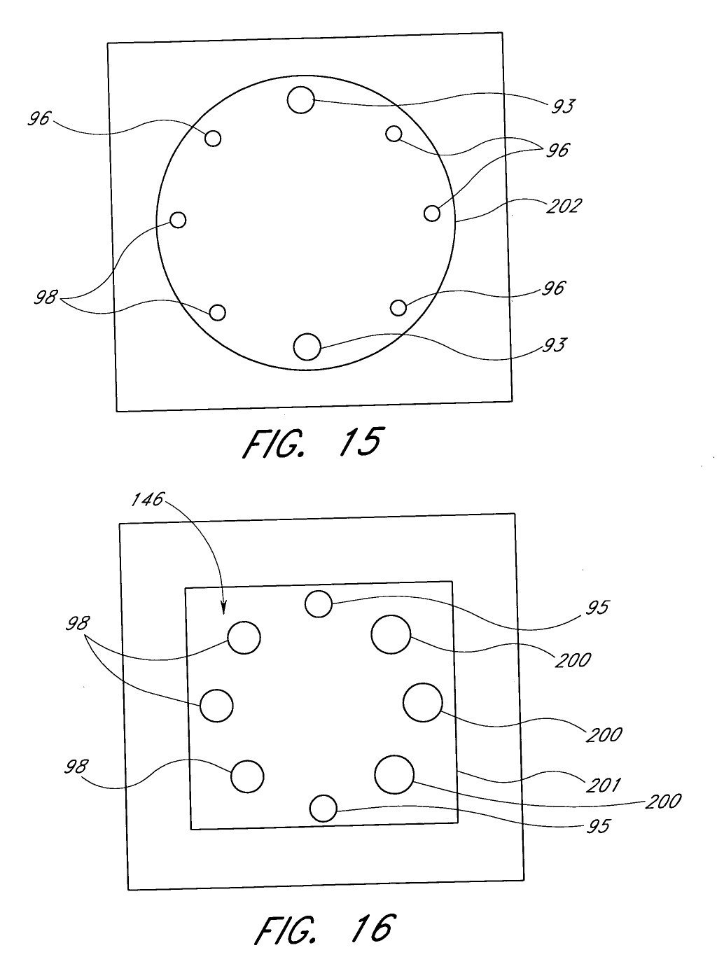

FIGS. 15 and 16 are a schematic of a portion of the preferred type of apparatus to make coated preforms in accordance with the present invention. The apparatus is an injection molding system designed to make one or more uncoated preforms and subsequently coat the newly-made preforms by over-injection of a barrier material. FIGS. 15 and 16 illustrate the two halves of the mold portion of the apparatus which will be in opposition in the molding machine. The alignment pegs 93 in FIG. 16 fit into their corresponding receptacles 95 in the other half of the mold.

The mold half depicted in FIG. 16 has several pairs of mold cavities, each cavity being similar to the mold cavity depicted in FIG. 14. The mold cavities are of two types: first injection preform molding cavities 98 and second injection preform coating cavities 200. A surface treatment of the preform may also be possible in the molding cavities 98 or the coating cavities 200. Alternatively, a surface treatment may be performed after withdrawal from the molding cavities 98. The two types of cavities are equal in number and are preferably arranged so that all cavities of one type are on the same side of the injection block 201 as bisected by the line between the alignment peg receptacles 95. This way, every preform molding cavity 98 is 180° away from a preform coating cavity 200.

The mold half depicted in FIG. 15 has several mandrels 96, one for each mold cavity (98 and 200). When the two halves which are FIGS. 15 and 16 are put together, a mandrel 96 fits inside each cavity and serves as the mold for the interior of the preform for the preform molding cavities 98 and as a centering device for the uncoated preforms in preform coating cavities 200, filling what becomes the interior space of the preform after it is molded. The mandrels are mounted on a turntable 202 which rotates 180° about its center so that a mandrel originally positioned over a preform molding cavity 98 will, after rotation, be positioned over a preform coating cavity 200, and vice-versa. As described in greater detail below, this type of setup allows a preform to be molded and then coated in a two-step process using the same piece of equipment. Optionally, the preform may be molded and then surface treated, prior to processes which includes an overmolding process.

It should be noted that the drawings in FIGS. 15 and 16 are merely illustrative. For instance, the drawings depict an apparatus having three molding cavities 98 and three coating cavities 200 (a 3/3 cavity machine). However, the machines may have any number of cavities, as long as there are equal numbers of molding and coating cavities, for example 12/12, 24/24, 48/48 and the like. The cavities may be arranged in any suitable manner, as can be determined by one skilled in the art. These and other minor alterations are contemplated as part of this invention.

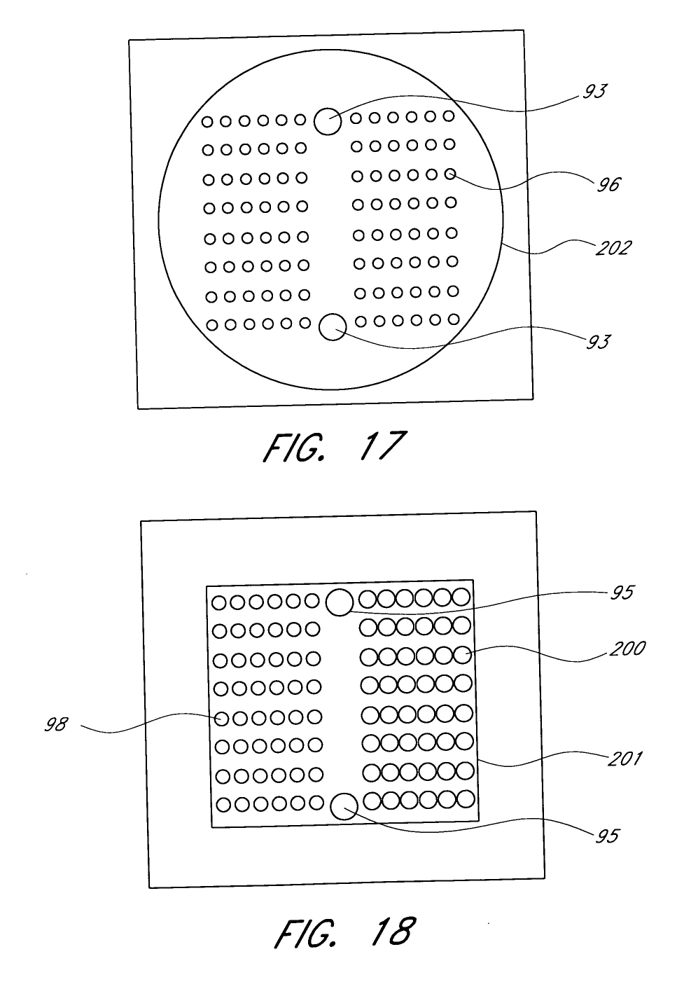

The two mold halves depicted in FIGS. 17 and 18 illustrate an embodiment of a mold of a 48/48 cavity machine as discussed for FIGS. 15 and 16.

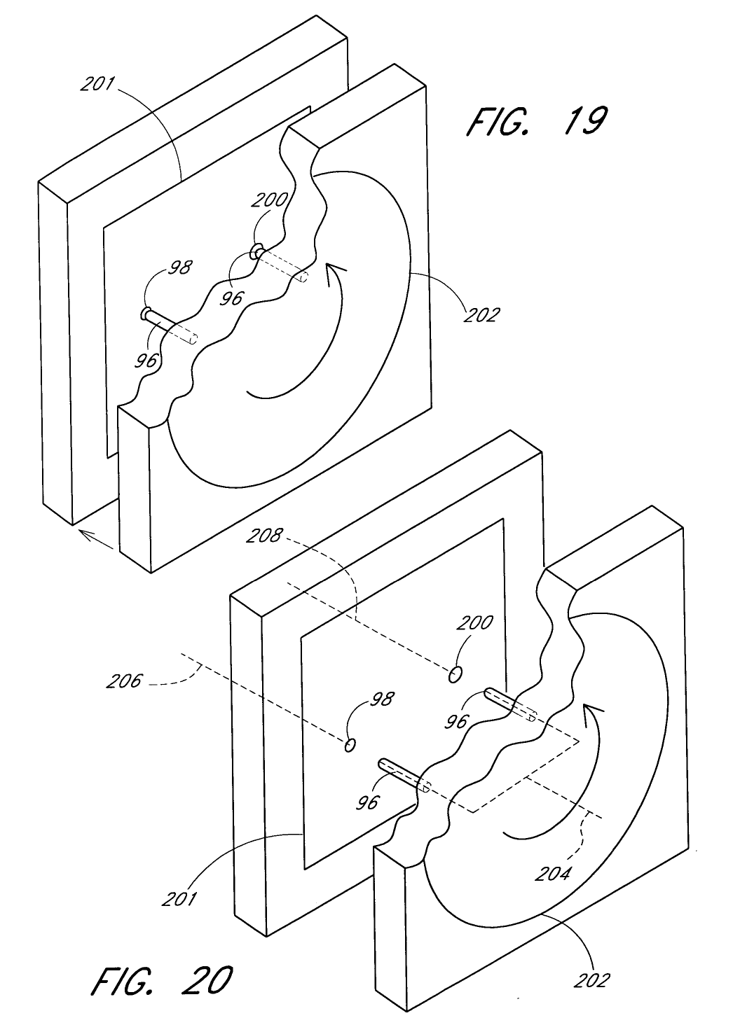

Referring to FIG. 19 there is shown a perspective view of a mold of the type for an overmolding (inject-over-inject) process, in which the mandrels 96 are partially located within the cavities 98 and 200. The arrow shows the movement of the movable mold half, on which the mandrels 96 lie, as the mold closes.

FIG. 20 shows a perspective view of a mold of the type used in an overmolding process, wherein the mandrels 96 are fully withdrawn from the cavities 98 and 200. The arrow indicates that the turntable 202 rotates 180° to move the mandrels 96 from one cavity to the next. Also shown are schematics depicting the cooling means for the mold halves. On the stationary half, the cooling for the preform molding cavity 206 is separate from the cooling for the preform coating cavity 208. Both of these are separate from the cooling for the mandrels 104 in the movable half. In some embodiments, the preforms may be treated by a surface treatment within the molding cavities 98 or the coating cavity 200. Alternatively, the preform may be treated outside of the cavities or in a separate surface treatment cavity. Such a treatment may occur after the preform has been removed from the molding cavity 98.

### I. Surface Treatment of Articles

Prior to one or all forming or coating steps and/or following a coating, drying, curing, and/or cooling step, the preform substrate may be subjected to a surface treatment, such as flame, corona or plasma treatment. Such treatment may be done to activate or modify the surface in a physical and/or chemical manner, including, but not limited to, increase the surface energy, clean the surface, deposit material, microetch the surface, cross-link the surface, modify the mechanical properties of the surface, modify the chemical properties of the surface and/or modify the morphology of the surface. In a preferred embodiment, the treatment is performed to a bare substrate prior to coating and/or between coating layers. In some embodiments, a surface treatment is performed on the inside of the article substrate prior to a coating on the inside surface of the preform. In preferred embodiments, the surface treatment is performed on the outside of the article substrate or between coating layers that are present on the outside of the preform. The effect of such surface treatment may include increased adhesion of a coating layer to the substrate or another coating layer, increased hydrophilicity or hydrophobicity of a surface, increased barrier properties, increased surface toughness or resistance to chemical or physical degradation, cleaner surface of the one or more layers or the article substrate, and/or other useful properties.

In corona treatment, a surface, such as the outer surface of a substrate, is exposed to a high voltage, high frequency electrical discharge. The corona treatment may cause increased surface energy of the treated surface, such as by oxidation of the surface, micropitting of the surface, or carbonization of portions of the polymer to form a more reactive surface. In the case of a polymer substrate, such as PET, the polymer surface may be oxidized by this treatment, such as by ambient oxygen, leaving functional groups, such as hydroxyl, carbonyl, and carboxyl groups, on the surface which are more reactive and may increase the ability of the polymer surface to adhere to other materials. Corona treatment may be performed, for example, using apparatus available from Pillar Technologies (Hartland, Wis.

In some embodiments, a corona treated surface comprising one or more plastic materials, such as a barrier material as described herein, increases the surface energy of the one or more plastic materials as compared to untreated plastic materials. In some embodiments, a corona treated surface has improved wettability and adhesion of inks, coatings, and adhesives. Thus, such corona treated layers comprising one or more materials, whether barrier layers or not, may demonstrate improved printing or coating quality, as well as stronger lamination strength compare to those layers or materials which have not been treated.

In one embodiment, an article is placed between a high potential electrode and a ground potential electrode, which are space a distance apart. As voltage is applied to the high potential electrode, the voltage buildup between the high potential electrode and the ground potential electrode ionizes the air in the air gap. This creates a corona which is exposed to a selected surface of the article substrate. This exposure may increase the surface tension of the article substrate surface between the high potential and the ground potential electrode. As this type of treatment may be applied to the substrate itself or a layer which is disposed on the substrate, the surface treatment may be repeated as desired.

In some embodiments, the corona treatment system is configured to cause an increase in the surface tension of at least part of the surface of the article substrate. To impart increased surface tension, the one or more properties of the corona treatment system may be varied. Such properties include, but are not limited to, power, watt density, length of the electrodes, type of electrode, time of treatment, the treatment station size, roll diameter of the treater, gap between the electrodes, and time between the treatment and subsequent processes. These factors may be varied by a person having ordinary skill in the art to produce an increase in the surface tension of the surface of the article, while not overexposing the article to the corona treatment. In one embodiment, the electrode is placed about 0.1 to about 5 mm from the surface of the preform.

Additionally, the materials of the surface being treated will have variable surface tensions prior to treatment and variable response to corona treatment. Some materials, such as polyesters, accept treatment readily and exhibit rapid increases in surface tension under relatively low watt density level. In some embodiments low watt density levels may range from about 0.9 to about 1.2 watts/ft²/min. Other materials, such as polyethylene, will increase in surface tension under moderate watt density levels. In some embodiments, moderate watt density levels may vary from about 1.3 to about 2.4 watts/ft²/min. Some materials, such as polypropylene, require even higher watt density levels to increase their surface tensions. Such levels may require about 2.5 to about 3.0 watts/ft²/min to cause an increase in surface tension of the material. Some materials may also vary according to their pretreatment methods of processing. For example, extruded materials may have different surface tensions than the same material which was not extruded in its formation.

Another type of treatment is flame or thermal treatment. In flame treatment, the surface is briefly exposed to a flame. Flame treatment is believed to cause surface activation or surface treatment in a polymer substrate by inducing radical formation and/or chain scission. The radicals or other reactive species form then can react with surrounding gas, such as nitrogen, oxygen and carbon dioxide if the surrounding gas is air. The reaction may then form hydroxyl, carbonyl, amide, and/or carboxyl groups on the surface. In other embodiments, flame treatment may result in oxidation of species on the treated surface. This oxidation may also result in the polarization of surface molecules. Flame treatment is also believed to modify electron distributions and densities of molecules on the treated surface. In some embodiments, the flame treatment is configured to cause one or more of the above mentioned effects on the article surface, which includes the substrate or the one or more layer disposed theron.

In some embodiments, a flame treated surface has improved adhesion to one or more other materials as described herein. Such flame treatments are advantageous in part because of a large process window between treatment of the article surface and subsequent process, such as coating. Additionally, flame treatments may occur at relatively high rates. Flame temperature may be modified according to the various gases and amounts of gases used in the process. Additionally, flame treatments may be controlled over three dimensional surfaces through the use of different flame heads and other control methods.

Another type of treatment is plasma treatment, including that which is also known as “glow discharge” treatment. Plasma arc treatment and/or plasma jet treatment may also be used, but in one embodiment, the low pressure plasma is preferred, as some arc and jet treatments may not be suitable for plastics. There is some similarity between corona treatment and glow discharge plasma, but the plasma treatment is somewhat less sensitive to the geometry of the substrate, which has advantages in certain embodiments.

In treatment of a substrate using plasma, there is frequently a competition between etching and deposition. Which one predominates is determined by choice of materials and processing conditions or parameters such as gas type, flow rate, pressure, exposure time or rate, power, and/or temperature, as are known to those skilled in the art. Although the term “plasma treatment” is frequently used in the art to be synonymous with treatment that is predominantly etching, in this disclosure it is used to mean all surface modification, including both etching predominant and deposition predominant modes.

Types of surface modification that can be achieved by plasma treatment include surface activation, surface cleaning, microetching, deposition or adsorption of chemicals/materials, cross-linking, chemical modification, polymerization (including depositing material that polymerizes with materials on the surface and depositing material that forms a new polymer on the surface), alteration or modification of surface energy, electrical properties, mechanical properties, chemical properties, and/or morphology, and the like. By selecting the gas or gases used and processing parameters, one or more of these properties can be emphasized over others, as is known in the art. Advantages of plasma treatment include environmental benefits in that there is little or no waste produced, a higher degree of surface activation may be achieved as compared to flame or corona treatment, there is little or no substrate damage that occurs, the treatment does not generally affect the bulk properties of the material, and the treatment is not substantially limited or affected by the geometry of the substrate. In one embodiment, a Dyne-A-Mite plasma treatment (e.g. glow discharge) apparatus (Enercon Industries) or similar apparatus is used to effect the plasma treatment.

In one embodiment, a Dyne-A-Mite VCP plasma treatment apparatus or similar apparatus is used. In some of these embodiments, the apparatus may use one or more gases as described herein, including blends of gases, to deposit various chemical groups on the surface to improve the surface energy. In some embodiments, such a treatment improves adhesion between layers. In some embodiments, such treatment provides improved adhesion of adhesives, inks, labels and other markings.

The gas used depends upon the desired effect of treatment and also the substrate material. Suitable gases include oxygen (e.g. modification of polymers, cleaning, oxidize surface, degreasing, increase of hydrophilicity), hydrogen (e.g. cleaning, reduce oxidation of surface), hydrocarbon (e.g. polymerization, increase hydrophobicity), fluorinated materials and fluorocarbons (e.g. polymerization, increase hydrophobicity, non-stick or easy release surfaces), inert/noble gas (e.g. surface activation, cleaning, degreasing), nitrogen containing gas (e.g. N₂O, NH₃, N₂) and/or carbon dioxide (e.g. modification of chemical properties), silicon oxides (e.g. polymerization), and other suitable materials.

In some embodiments, the preform is placed in a chamber to evacuate air or the presence of other gases prior to treatment. In one embodiment, the chamber may be evacuated by a vacuum. The desired gas may then be delivered to the preform or the electrodes to produce the plasma. Such plasma may then be delivered to the surface of the preform. In some embodiments, the treatment chamber may be partially evacuated and contain gases at sub-atmospheric pressures.

In some embodiments, use of carbon dioxide may result in the formation of carboxyl or carboxylic acid groups on the surface of the article substrate. In other embodiments, use of ammonia gas may result in the formation of nitrile or amide groups on the surface of the article substrate. In another embodiment, use of oxygen may results in formation of hydroxyl groups on the surface of the article substrate. In some embodiments, one or more gases may be used to provide different reactive groups on the surface of the article substrate. Such reactive groups may allow additional adhesion between the surface and a subsequently applied plastic material.

Among the ways that adhesion properties can be enhanced by plasma or other treatment is surface activation, deposition of a layer of material that is compatible with a desired coating to be applied to the surface (e.g. polymerization), modification of chemical properties to form a surface more compatible with the desired coating material than the bulk material, microscopic etching of the surface to increase physical surfaces for bonding, and/or cleaning of the surface to remove grease, dirt or oil that could interfere with bonding.

In one embodiment, free radicals or compounds which form free radicals upon exposure to radiation or other external or applied energy, material or force are employed in the polymer or supplied in an associated gas to give a higher polarization of the surface during flame, corona or plasma treatment.

Equipment for the above surface treatment modalities is available commercially from, several sources. Such apparatus can be incorporated onto the flow coating system to deliver a highly effective and substantially uniform treatment to three dimensional surfaces. The design of the deposit head or electrodes can be modified to focus the treatment onto a substrate of a particular shape, such as a preform or container, and for an effective treatment consistent with the speed of the coating machine. In one embodiment, the article may be rotated during the surface treatment to treat all sides and surfaces of the article. In another embodiment, the article is selectively treated in certain areas to provide the desired treatment of finish to the article. Alternatively, a treatment system may be rotated around the preform or container. To achieve a high level of polymer/coating adhesion, plasma treatment can be used and further optimized by selecting an appropriate gas which is compatible with the coated substances.

In some embodiments, the preforms are exposed to the surface treatment under certain conditions used to promote adhesion and/or other functional properties of the surfaces. A person having ordinary skill in the art will understand the conditions for different surface treatments and how to configure those treatments to increase the adhesion between certain substrates. Some conditions for plasma treatments are described in U.S. Pat. No. 5,074,770 and references cited therein, which are herein incorporated by reference in its entirety. However, the conditions which can be used in various embodiments of this invention are not limited thereto. In some embodiments, the preform is exposed to the surface treatment for about 5 seconds to about 300 seconds. In preferred embodiments, these times are required for the high output of surface coated preforms or articles in a high speed manufacturing process.

As noted above, in some embodiments, the preform may be rotated while being treated. In some embodiment, the treatment is part of an in-line commercial process. To make such forming, treating and/or coating processes commercially viable, a high speed inline treatment process may be used according to some embodiments. In one embodiment, the treatment apparatus remains stationary while the article is moved into the field of treatment. In some embodiments, the field of treatment is a plasma field. The preform may optionally be moved into one or more fields to treatment. In some embodiments, the article is rotated in a field of treatment. In some commercial processes, the article is rotated along an axis from the neck finish to the end cap of the article. In one embodiment, the article is rotated along an axis from about 10 to about 100 rotations per minute. In one embodiment, the article is rotated along an axis from about 40 to about 80 rotations per minute. Additionally, the article may then be exposed to about 0.5 to about 10 seconds of the field of treatment. In some embodiments, the entire surface of the article is adapted to pass through the treatment field one or more times.

In any of the above described processes, the preform may be rotated to treat the entire surface of the article. In some embodiments, the preform may be rotated multiple times to expose the surface of the article to multiple passes of the surface treatment. In one embodiment, a preform is rotated while the surface treater is passed back and forth substantially parallel to the longitudinal direction of the preform. In some embodiments, the treater is stationary as the treatment head extends the length of the desired surface to be treated.

In some embodiments, the preform is heated prior to and during the treatment to promote better adhesion between coating layers and/or the article substrate.

As discussed above, one or more functional groups may be deposited on the treated surface according to various methods and embodiments described herein. These functional groups and the methods of altering the surface chemistries of the treated surface may be varied to promote adhesion between certain layers. In some embodiments, one or more surface treatments may be used to enhance adhesion between materials which are dissimilar and often have poor adhesion to one another. For example, one or more surface treatments may be used to enhance adhesion between polyesters, such as PET, and vinyl alcohol polymers or copolymers, such as EVOH, or polyolefins, such as PE or PP. In another example, the adhesion between one or more layers of vinyl alcohol polymers or copolymers and polyolefins may be enhanced. In some embodiment, the adhesion between polar and non-polar materials is enhanced.

In some embodiments, the functional groups deposited or created through a surface treatment may be based on the subsequent coating layer to be deposited on the surface. For example, carbon dioxide gas may be used in a plasma treatment to provide carboxyl groups which are especially preferred for a subsequent layer of Phenoxy-type material. In some embodiments, two different surface treatments may be required for the basecoat and topcoat.

### II. Preferred Material and Methods for Surface Treament Applications

A. General Description of Preferred Materials

1. Materials of the Article Substrate

The articles disclosed herein may be made from any of a wide variety of materials as discussed herein. In some embodiments, the article substrate is made of one or more materials selected from glass, plastic, or metal. Polymers, such as thermoplastic materials are preferred. Examples of suitable thermoplastics include, but are not limited to, polyesters (e.g. PET, PEN), polyolefins (PP, HDPE), polylactic acid, polycarbonate, and polyamide.

Although some articles may be described specifically in relation to a particular base preform material and/or coating material, these same articles, and the methods used to make the articles are applicable to many polymeric materials including thermoplastic and thermosetting polymers. In some embodiments, substrate materials may comprise thermoplastic materials such as polyesters, polyolefins, including polypropylene and polyethylene, polycarbonate, polylactic acid (PLA), polyamides, including nylons (e.g. Nylon 6, Nylon 66) and MXD6, polystyrenes, epoxies, acrylics, copolymers, blends, grafted polymers, and/or modified polymers (monomers or portion thereof having another group as a side group, e.g. olefin-modified polyesters). These substrate materials may be used alone or together with another substrate material. More specific substrate examples include, but are not limited to, polyethylene 2,6- and 1,5-naphthalate (PEN), PETG, polytetramethylene 1,2-dioxybenzoate and copolymers of ethylene terephthalate and ethylene isophthalate. Additionally, modified PET such as high IPA PET or IPA-modified PET may also be used in some embodiments.

The article substrate materials may include materials of the barrier layer materials to make the article substrate. For example, the article substrate may comprise a vinyl alcohol polymer or copolymer together with PET. The article substrate material can also be combined with different additives, such as nanoparticle barrier materials, oxygen scavengers, UV absorbers, foaming agents and the like.

In certain embodiments preferred substrate materials may be virgin, pre-consumer, post-consumer, regrind, recycled, and/or combinations thereof. For example, PET can be virgin, pre or post-consumer, recycled, or regrind PET, PET copolymers and combinations thereof. In preferred embodiments, the finished container and/or the materials used therein are benign in the subsequent plastic container recycling stream. This includes the article substrate materials and/or the materials used to make the barrier layers coated on the article substrate.

As used herein, the term “polyethylene terephthalate glycol” (PETG) refers to a copolymer of PET wherein an additional comonomer, cyclohexane di-methanol (CHDM), is added in significant amounts (e.g. approximately 40% or more by weight) to the PET mixture. In one embodiment, preferred PETG material is essentially amorphous. Suitable PETG materials may be purchased from various sources. One suitable source is Voridian, a division of Eastman Chemical Company. Other PET copolymers include CHDM at lower levels such that the resulting material remains crystallizable or semi-crystalline. One example of PET copolymer containing low levels of CHDM is Voridian 9921 resin. Another example of modified PET is “high IPA PET” or IPA-modified PET, which refers to PET in which the IPA content is preferably more than about 2% by weight, including about 2-20% IPA by weight, also including about 5-10% IPA by weight. Throughout the specification, all percentages in formulations and compositions are by weight unless stated otherwise.

In some embodiments, polymeric substrate materials and barrier materials may comprise polymers or copolymers that have been grafted or modified with other organic compounds, polymers, or copolymers.

In preferred embodiments, a substrate that is an article such as a container, jar, bottle or preform (sometimes referred to as a base preform) is coated using apparatus, methods, and materials described herein. The base preform or substrate may be made by any suitable method, including those known in the art including, but not limited to, injection molding including monolayer injection molding, inject-over-inject molding, and coinjection molding, extrusion molding, and compression molding, with or without subsequent blow molding.

2. Materials of the Coating Layers

One or more layers that coat the substrate is formed by applying a coating layer composition according to methods disclosed herein. Preferred coating layer compositions include solutions, suspensions, emulsions, dispersions, and/or melts comprising at least one polymeric material (preferably a thermoplastic material) and optionally one or more additives. Additives, whether solids or liquids, preferably provide functionality to the dried or cured coating layer (e.g. UV resistance, barrier, scratch resistance) and/or to the coating composition during the process (e.g. thermal enhancer, anti-foaming agent) of forming the article substrate, forming the final containers, or applying coating layers. A polymeric material used in a layer composition may, itself, provide functional properties such as barrier, water resistance, and the like.

In embodiments of preferred methods and processes one or more layers may comprise barrier layers, UV protection layers, oxygen scavenging layers, oxygen barrier layers, carbon dioxide scavenging layers, carbon dioxide barrier layers, water-resistant coating layers and. other layers as needed for the particular application. As used herein, the terms “barrier material,” “barrier resin,” and the like are broad terms and are used in their ordinary sense and refer, without limitation, to materials which, when used in preferred methods and processes, have a lower permeability to oxygen, carbon dioxide, and/or than the one or more of the other layers of the finished article (including the substrate). As used herein, the terms “UV protection” and the like are broad terms and are used in their ordinary sense and refer, without limitation, to materials which have a higher UV absorption rate than one or more other layers of the article. As used herein, the terms “oxygen scavenging” and the like are broad terms and are used in their ordinary sense and refer, without limitation, to materials which have a higher oxygen absorption rate than one or more other layers of the article. As used herein, the terms “oxygen barrier” and the like are broad terms and are used in their ordinary sense and refer, without limitation, to materials which are passive or active in nature and slow the transmission of oxygen into and/or out of an article. As used herein, the terms “carbon dioxide scavenging” and the like are broad terms and are used in their ordinary sense and refer, without limitation, to materials which have a higher carbon dioxide absorption rate than one or more other layers of the article. As used herein, the terms “carbon dioxide barrier” and the like are broad terms and are used in their ordinary sense and refer, without limitation, to materials which are passive or active in nature and slow the transmission of carbon dioxide into and/or out of an article. Without wishing to be bound to any theory, applicants believe that in applications wherein a carbonated product, e.g. a soft-drink beverage, contained in an article is over-carbonated, the inclusion of a carbon dioxide scavenger in one or more layers of the article allows the excess carbonation to saturate the layer which contains the carbon dioxide scavenger. Therefore, as carbon dioxide escapes to the atmosphere from the article it first leaves the article layer rather than the product contained therein. As used herein, the terms “crosslink,” “crosslinked,” and the like are broad terms and are used in their ordinary sense and refer, without limitation, to materials and coatings which vary in degree from a very small degree of crosslinking up to and including fully cross linked materials. The degree of crosslinking can be adjusted to provide desired or appropriate physical properties, such as the degree of chemical or mechanical abuse resistance for the particular circumstances.

As used herein, the terms “water resistant,” “water repellant” and the like are broad terms and are used in their ordinary sense and refer, without limitation, to characteristics of certain material which results in the reduction of water transmission through the material. In some cases, it also refers to the ability of the material to remain substantially chemically unaltered upon exposure to water in its solid, liquid, or gaseous states at various temperatures. As used herein, the term “chemical resistance” and the like is a broad term and is used in its ordinary sense and refers, without limitation, to characteristics of certain materials to remain substantially chemically unaltered upon exposure to chemicals, including water, whether in their gaseous, liquid, or solid state, including, but not limited to, water.

a. Gas Barrier Materials

Article substrates may comprise one or more gas barrier layers. In these embodiments, the gas barrier material comprises one or more materials which decrease the transmission of gases permeating the article substrate material or other layers coated on the article substrate. In some embodiments, the gas barrier layer comprises a material which results in the substantial decrease of gas permeation through the article substrate material or other coating layers. To this end, gas barrier materials may be deposited as layers on the outside of at least a portion of article substrate or on top of layers already deposited on the article substrate.

There are many materials which decrease the transmission of certain gases, including oxygen and carbon dioxide, through coating layers or the article substrate. As described herein, the material to be used in gas barrier layers is not particularly limited. In some embodiments, selection of materials may be based on the most compatible material in consideration of the article substrate material and the other coating layers materials For example, some particular material may work in combination to substantially decrease the rate of gas transmission through the walls of the article substrate, while enhancing the adhesion between certain layers and/or the article substrate.

In one preferred embodiment, coating materials comprise thermoplastic materials. Vinyl alcohol polymers and copolymers have excellent resistance to permeation by gases, particularly to oxygen Generally, a gas barrier layer comprising vinyl alcohol polymers or copolymers imparts advantages such as reduced permeability of oxygen, good resistance to oil, and stiffness to the article substrate. Vinyl alcohol polymers and copolymers include polyvinyl alcohol (PVOH) and ethylene vinyl alcohol (EVOH) copolymer. Thus in some embodiments, a gas barrier layer may comprise one or more of PVOH and EVOH. In some embodiments, EVOH can be a hydrolyzed ethylene vinyl acetate (EVA) copolymer. In some embodiments, vinyl alcohol polymers or copolymers include EVA.

One preferred gas barrier material is EVOH copolymer. Layers prepared with EVOH differ in properties according to the ethylene content, saponification degree and molecular weight of EVOH. Examples of preferred EVOH materials include, but are not limited to, those having ethylene content of about 35 to about 90 wt %. In some embodiments, the ethylene content is about 50 to about 70 wt %. In other embodiments, the ethylene content is about 65 to about 80 wt %. In some embodiments, the ethylene content is about 25 to about 55 wt %. In some embodiments, it is preferred that the ethylene content is about 27 to about 40 wt %, based on the total weight of the ethylene and the vinyl alcohol. In some embodiments, lower ethylene content is preferred. In some embodiments, a lower ethylene content correlates with higher barrier potency of the gas barrier layer. In some embodiments, the saponification degree is about 20 to about 95%. In other embodiments, the saponification degree is about 70 to about 90%. However, the saponification degree can be less than or greater than the recited values depending on the application.

Generally, preferred vinyl alcohol polymer and copolymer materials form relatively stable aqueous based solutions, dispersions, or emulsions. In embodiments, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages, although values above and below these values are also contemplated. Preferably, the material used dissolves or disperses in polar solvents. These polar solvents include, but are not limited to, water, alcohols, and glycol ethers. Some dispersions comprises about 20 to about 50 mol % of EVOH copolymer. Other dispersions comprise from about 25 to about 45 mol % of EVOH copolymer.

In some embodiments, an ion-modified vinyl alcohol polymer or copolymer material can be used in the formation of a stabilized aqueous dispersions as described in U.S. Pat. No. 5,272,200 and U.S. Pat. No. 5,302,417 to Yamauchi et al. Other methods for producing aqueous EVOH copolymer compositions are described in U.S. Pat. Nos. 6,613,833 and 6,838,029 to Kawahara et al.

In some embodiments, commercially available EVOH solutions and dispersions may be used. For example, a suitable EVOH dispersion includes, but it not limited to, the EVAL™ product line as manufactured by Evalca of Kuraray Group.

Polyvinyl alcohol (PVOH) can also be used in gas barrier layers. PVOH is highly impermeable to gases, oxygen and carbon dioxide and aromas. In some embodiments, a gas barrier layer comprising PVOH is also water resistant. In some preferred embodiments, PVOH is partially hydrolyzed or fully hydrolyzed. Examples of PVOH material include, but is not limited to, the Dupont™ Elvanol® product line.

Preferably, the Phenoxy-Type Thermoplastics used in some embodiments comprise one of the following types:
(1) hydroxy-funtinctional poly(amide ethers) having repeating units represented by any one of the Formulae Ia, Ib or Ic: 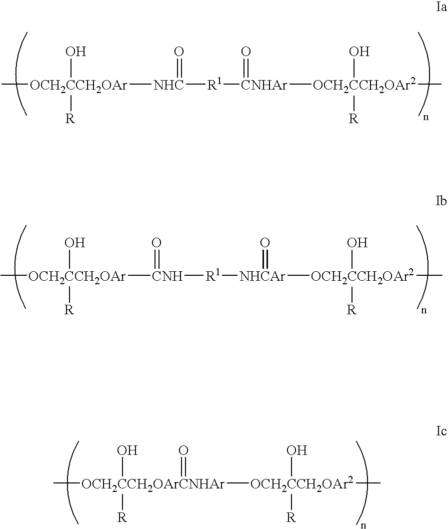
(2) poly(hydroxy amide ethers) having repeating units represented independently by any one of the Formulae IIa, IIb or IIc: 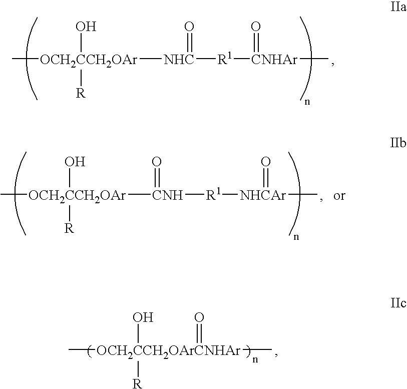
(3) amide- and hydroxymethyl-functionalized polyethers having repeating units represented by Formula III: 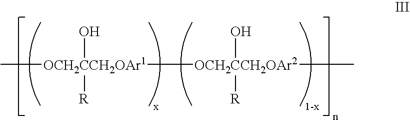
(4) hydroxy-functional polyethers having repeating units represented by Formula IV: 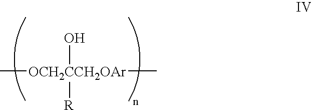
(5) hydroxy-functional poly(ether sulfonamides) having repeating units represented by Formulae Va or Vb: 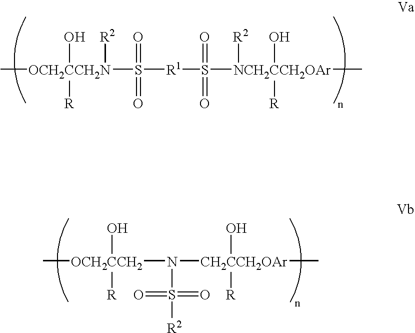
(6) poly(hydroxy ester ethers) having repeating units represented by Formula VI: 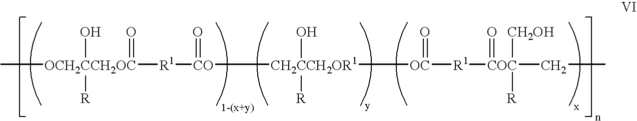
(7) hydroxy-phenoxyether polymers having repeating units represented by Formula VII: 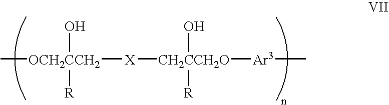
(8) poly(hydroxyamino ethers) having repeating units represented by Formula VIII: 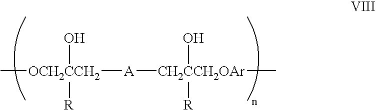
   wherein each Ar individually represents a divalent aromatic moiety, substituted divalent aromatic moiety or heteroaromatic moiety, or a combination of different divalent aromatic moieties, substituted aromatic moieties or heteroaromatic moieties; R is individually hydrogen or a monovalent hydrocarbyl moiety; each Ar₁ is a divalent aromatic moiety or combination of divalent aromatic moieties bearing amide or hydroxymethyl groups; each Ar₂ is the same or different than Ar and is individually a divalent aromatic moiety, substituted aromatic moiety or heteroaromatic moiety or a combination of different divalent aromatic moieties, substituted aromatic moieties or heteroaromatic moieties; R₁ is individually a predominantly hydrocarbylene moiety, such as a divalent aromatic moiety, substituted divalent aromatic moiety, divalent heteroaromatic moiety, divalent alkylene moiety, divalent substituted alkylene moiety or divalent heteroalkylene moiety or a combination of such moieties; R₂ is individually a monovalent hydrocarbyl moiety; A is an amine moiety or a combination of different amine moieties; X is an amine, an arylenedioxy, an arylenedisulfonamido or an arylenedicarboxy moiety or combination of such moieties; and Ar₃ is a “cardo” moiety represented by any one of the Formulae:

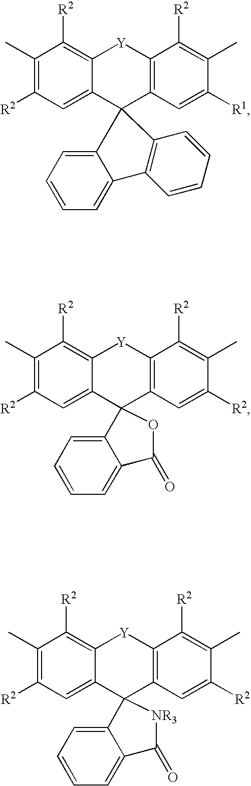

wherein Y is nil, a covalent bond, or a linking group, wherein suitable linking groups include, for example, an oxygen atom, a sulfur atom, a carbonyl atom, a sulfonyl group, or a methylene group or similar linkage; n is an integer from about 10 to about 1000; x is 0.01 to 1.0; and y is 0 to 0.5.

The term “predominantly hydrocarbylene” means a divalent radical that is predominantly hydrocarbon, but which optionally contains a small quantity of a heteroatomic moiety such as oxygen, sulfur, imino, sulfonyl, sulfoxyl, and the like.

The hydroxy-functional poly(amide ethers) represented by Formula I are preferably prepared by contacting an N,N′-bis(hydroxyphenylamido)alkane or arene with a diglycidyl ether as described in U.S. Pat. Nos. 5,089,588 and 5,143,998.

The poly(hydroxy amide ethers) represented by Formula II are prepared by contacting a bis(hydroxyphenylamido)alkane or arene, or a combination of 2 or more of these compounds, such as N,N′-bis(3-hydroxyphenyl) adipamide or N,N′-bis(3-hydroxyphenyl)glutaramide, with an epihalohydrin as described in U.S. Pat. No. 5,134,218.

The amide- and hydroxymethyl-functionalized polyethers represented by Formula III can be prepared, for example, by reacting the diglycidyl ethers, such as the diglycidyl ether of bisphenol A, with a dihydric phenol having pendant amido, N-substituted amido and/or hydroxyalkyl moieties, such as 2,2-bis(4-hydroxyphenyl)acetamide and 3,5-dihydroxybenzamide. These polyethers and their preparation are described in U.S. Pat. Nos. 5,115,075 and 5,218,075.

The hydroxy-functional polyethers represented by Formula IV can be prepared, for example, by allowing a diglycidyl ether or combination of diglycidyl ethers to react with a dihydric phenol or a combination of dihydric phenols using the process described in U.S. Pat. No. 5,164,472. Alternatively, the hydroxy-functional polyethers are obtained by allowing a dihydric phenol or combination of dihydric phenols to react with an epihalohydrin by the process described by Reinking, Barnabeo and Hale in the Journal of Applied Polymer Science, Vol. 7, p. 2135 (1963).

The hydroxy-functional poly(ether sulfonamides) represented by Formula V are prepared, for example, by polymerizing an N,N′-dialkyl or N,N′-diaryldisulfonamide with a diglycidyl ether as described in U.S. Pat. No. 5,149,768.

The poly(hydroxy ester ethers) represented by Formula VI are prepared by reacting diglycidyl ethers of aliphatic or aromatic diacids, such as diglycidyl terephthalate, or diglycidyl ethers of dihydric phenols with, aliphatic or aromatic diacids such as adipic acid or isophthalic acid. These polyesters are described in U.S. Pat. No. 5,171,820.

The hydroxy-phenoxyether polymers represented by Formula VII are prepared, for example, by contacting at least one dinucleophilic monomer with at least one diglycidyl ether of a cardo bisphenol, such as 9,9-bis(4-hydroxyphenyl)fluorene, phenolphthalein, or phenolphthalimidine or a substituted cardo bisphenol, such as a substituted bis(hydroxyphenyl)fluorene, a substituted phenolphthalein or a substituted phenolphthalimidine under conditions sufficient to cause the nucleophilic moieties of the dinucleophilic monomer to react with epoxy moieties to form a polymer backbone containing pendant hydroxy moieties and ether, imino, amino, sulfonamido or ester linkages. These hydroxy-phenoxyether polymers are described in U.S. Pat. No. 5,184,373.

The poly(hydroxyamino ethers) (“PHAE” or polyetheramines) represented by Formula VIII are prepared by contacting one or more of the diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. These compounds are described in U.S. Pat. No. 5,275,853. For example, polyhydroxyaminoether copolymers can be made from resorcinol diglycidyl ether, hydroquinone diglycidyl ether, bisphenol A diglycidyl ether, or mixtures thereof. The hydroxy-phenoxyether polymers are the condensation reaction products of a dihydric polynuclear phenol, such as bisphenol A, and an epihalohydrin and have the repeating units represented by Formula IV wherein Ar is an isopropylidene diphenylene moiety. The process for preparing these is described in U.S. Pat. No. 3,305,528, incorporated herein by reference in its entirety.

Generally, preferred phenoxy-type materials form relatively stable aqueous based solutions or dispersions. Preferably, the properties of the solutions/dispersions are not adversely affected by contact with water. Preferred materials range from about 10% solids to about 50% solids, including about 15%, 20%, 25%, 30%, 35%, 40% and 45%, and ranges encompassing such percentages, although values above and below these values are also contemplated. Preferably, the material used dissolves or disperses in polar solvents. These polar solvents include, but are not limited to, water, alcohols, and glycol ethers. See, for example, U.S. Pat. Nos. 6,455,116, 6,180,715, and 5,834,078 which describe some preferred phenoxy-type solutions and/or dispersions.

One preferred phenoxy-type material is a polyhydroxyaminoether (PHAE), dispersion or solution. The dispersion or solution, when applied to a container or preform, greatly reduces the permeation rate of a variety of gases through the container walls in a predictable and well known manner. One dispersion or latex made thereof comprises 10-30 percent solids. A PHAE solution/dispersion may be prepared by stirring or otherwise agitating the PHAE in a solution of water with an organic acid, preferably acetic or phosphoric acid, but also including lactic, malic, citric, or glycolic acid and/or mixtures thereof. These PHAE solution/dispersions also include organic acid salts as may be produced by the reaction of the polyhydroxyaminoethers with these acids.

In some embodiments, phenoxy-type thermoplastics are mixed or blended with other materials using methods known to those of skill in the art. In some embodiments a compatibilizer may be added to the blend. When compatibilizers are used, preferably one or more properties of the blends are improved, such properties including, but not limited to, color, haze, and adhesion between a layer comprising a blend and other layers. One preferred blend comprises one or more phenoxy-type thermoplastics and one or more polyolefins. A preferred polyolefin comprises polypropylene. In one embodiment polypropylene or other polyolefins may be grafted or modified with a polar molecule, group, or monomer, including, but not limited to, maleic anhydride, glycidyl methacrylate, acryl methacrylate and/or similar compounds to increase compatibility.

The following PHAE solutions or dispersions are examples of suitable phenoxy-type solutions or dispersions which may be used if one or more layers of resin are applied as a liquid such as by dip, flow, or spray coating, such as described in WO 04/004929 and U.S. Pat. No. 6,676,883.

Examples of polyhydroxyaminoethers are described in U.S. Pat. No. 5,275,853 to Silves et al. One suitable polyhydroxyaminoether is BLOX® experimental barrier resin, for example XU-19061.00 made with phosphoric acid manufactured by Dow Chemical Corporation. This particular PHAE dispersion is said to have the following typical characteristics: 30% percent solids, a specific gravity of 1.30, a pH of 4, a viscosity of 24 centipoise (Brookfield, 60 rpm, LVI, 22° C.), and a particle size of between 1,400 and 1,800 angstroms. Other suitable materials include BLOX® 588-29 resins based on resorcinol have also provided superior results as a barrier material. This particular dispersion is said to have the following typical characteristics: 30% percent solids, a specific gravity of 1.2, a pH of 4.0, a viscosity of 20 centipoise (Brookfield, 60 rpm, LVI, 22° C.), and a particle size of between 1500 and 2000 angstroms. Other suitable materials include BLOX® 5000 resin dispersion intermediate, BLOX® XUR 588-29, BLOX® 0000 and 4000 series resins. The solvents used to dissolve these materials include, but are not limited to, polar solvents such as alcohols, water, glycol ethers or blends thereof. Other suitable materials include, but are not limited to, BLOX® R1.

A preferred gas barrier layer comprises a blend of at least one polyhydroxyaminoether and a vinyl alcohol polymer or copolymer. In some embodiments, a PHAE may be blended with EVOH to provide a gas barrier layer for an article substrate. In these embodiments, the EVOH/PHAE blends may be applied to the article substrate by dip, spray, or flow coating an aqueous solution, dispersion or emulsion as described herein.

Blends of vinyl alcohol polymers or copolymers and Phenoxy-type Thermoplastics form stable aqueous solutions, dispersion, or emulsions. In some embodiments, a blend may comprises 5, 10, 15, 20, 25, 30, 35, 40, 45, 50, 55, 60, 65, 70, 75, 80, 85, 90, and about 95 wt % of at least one vinyl alcohol polymer or copolymer, based on the total weight of the vinyl alcohol polymer or copolymer and the Phenoxy-Type Thermoplastic. In preferred embodiments, the vinyl alcohol polymer or copolymer is EVOH or PVOH, as further described herein. In preferred embodiments, the Phenoxy-Type Thermoplastic is a PHAE.

Other variations of the polyhydroxyaminoether chemistry may prove useful such as crystalline versions based on hydroquinone diglycidylethers. Other suitable materials include polyhydroxyaminoether solutions/dispersions by Imperial Chemical Industries (“ICI,” Ohio, USA) available under the name OXYBLOK. In one embodiment, PHAE solutions or dispersions can be crosslinked partially (semi-cross linked), fully, or to the desired degree as appropriate for an application including by using a formulation that includes cross linking material. The benefits of cross linking include, but are not limited to, one or more of the following: improved chemical resistance, improved abrasion resistance, lower blushing, and lower surface tension. Examples of cross linker materials include, but are not limited to, formaldehyde, acetaldehyde or other members of the aldehyde family of materials. Suitable cross linkers can also enable changes to the T_{g} of the material, which can facilitate formation of certain containers. In one embodiment, preferred phenoxy-type thermoplastics are soluble in aqueous acid. A polymer solution/dispersion may be prepared by stirring or otherwise agitating the thermoplastic epoxy in a solution of water with an organic acid, preferably acetic or phosphoric acid, but also including lactic, malic, citric, or glycolic acid and/or mixtures thereof. In a preferred embodiment, the acid concentration in the polymer solution is preferably in the range of about 5%-20%, including about 5%-10% by weight based on total weight. In other preferred embodiments, the acid concentration may be below about 5% or above about 20%; and may vary depending on factors such as the type of polymer and its molecular weight. In other preferred embodiments, the acid concentration ranges from about 2.5 to about 5% by weight. The amount of dissolved polymer in a preferred embodiment ranges from about 0.1% to about 40%. A uniform and free flowing polymer solution is preferred. In one embodiment a 10% polymer solution is prepared by dissolving the polymer in a 10% acetic acid solution at 90° C. Then while still hot the solution is diluted with 20% distilled water to give an 8% polymer solution. At higher concentrations of polymer, the polymer solution tends to be more viscous. One preferred non-limiting hydroxy-phenoxyether polymer, PAPHEN 25068-38-6, is commercially available from Phenoxy Associates, Inc. Other preferred phenoxy resins are available from InChem® (Rock Hill, S.C.), these materials include, but are not limited to, the INCHEMREZ™ PKHH and PKHW product lines.

Other suitable coating materials include preferred copolyester materials as described in U.S. Pat. No. 4,578,295 to Jabarin. They are generally prepared by heating a mixture of at least one reactant selected from isophthalic acid, terephthalic acid and their C₁ to C₄ alkyl esters with 1,3 bis(2-hydroxyethoxy)benzene and ethylene glycol. Optionally, the mixture may further comprise one or more ester-forming dihydroxy hydrocarbon and/or bis(4-β-hydroxyethoxyphenyl)sulfone. Especially preferred copolyester materials are available from Mitsui Petrochemical Ind. Ltd. (Japan) as B-010, B-030 and others of this family.

Examples of preferred polyamide materials include MXD-6 from Mitsubishi Gas Chemical (Japan). Other preferred polyamide materials include Nylon 6, and Nylon 66. Other preferred polyamide materials are blends of polyamide and polyester, including those comprising about 1-20% polyester by weight, including about 1-10% polyester by weight, where the polyester is preferably PET or a modified PET, including PET ionomer. In another embodiment, preferred polyamide materials are blends of polyamide and polyester, including those comprising about 1-20% polyamide by weight, and 1-10% polyamide by weight, where the polyester is preferably PET or a modified PET, including PET ionomer. The blends may be ordinary blends or they may be compatibilized with one or more antioxidants or other materials. Examples of such materials include those described in U.S. Patent Publication No. 2004/0013833, filed Mar. 21, 2003, which is hereby incorporated by reference in its entirety. Other preferred polyesters include, but are not limited to, PEN and PET/PEN copolymers.

One suitable aqueous based polyester resin is described in U.S. Pat. No. 4,977,191 (Salsman), incorporated herein by reference. More specifically, U.S. Pat. No. 4,977,191 describes an aqueous based polyester resin, comprising a reaction product of 20-50% by weight of terephthalate polymer, 10-40% by weight of at least one glycol and 5-25% by weight of at least one oxyalkylated polyol.

Another suitable aqueous based polymer is a sulfonated aqueous based polyester resin composition as described in U.S. Pat. No. 5,281,630 (Salsman), herein incorporated by reference. Specifically, U.S. Pat. No. 5,281,630 describes an aqueous suspension of a sulfonated water-soluble or water dispersible polyester resin comprising a reaction product of 20-50% by weight terephthalate polymer, 10-40% by weight at least one glycol and 5-25% by weight of at least one oxyalkylated polyol to produce a prepolymer resin having hydroxyalkyl functionality where the prepolymer resin is further reacted with about 0.10 mole to about 0.50 mole of alpha, beta-ethylenically unsaturated dicarboxylic acid per 100 g of prepolymer resin and a thus produced resin, terminated by a residue of an alpha, beta-ethylenically unsaturated dicarboxylic acid, is reacted with about 0.5 mole to about 1.5 mole of a sulfite per mole of alpha, beta-ethylenically unsaturated dicarboxylic acid residue to produce a sulfonated-terminated resin.

Yet another suitable aqueous based polymer is the coating described in U.S. Pat. No. 5,726,277 (Salsman), incorporated herein by reference. Specifically, U.S. Pat. No. 5,726,277 describes coating compositions comprising a reaction product of at least 50% by weight of waste terephthalate polymer and a mixture of glycols including an oxyalkylated polyol in the presence of a glycolysis catalyst wherein the reaction product is further reacted with a difunctional, organic acid and wherein the weight ratio of acid to glycols in is the range of 6:1 to 1:2.

While the above examples are provided as preferred aqueous based polymer coating compositions, other aqueous based polymers are suitable for use in the products and methods describe herein. By way of example only, and not meant to be limiting, further suitable aqueous based compositions are described in U.S. Pat. No. 4,104,222 (Date, et al.), incorporated herein by reference. U.S. Pat. No. 4,104,222 describes a dispersion of a linear polyester resin obtained by mixing a linear polyester resin with a higher alcohol/ethylene oxide addition type surface-active agent, melting the mixture and dispersing the resulting melt by pouring it into an aqueous solution of an alkali under stirring Specifically, this dispersion is obtained by mixing a linear polyester resin with a surface-active agent of the higher alcohol/ethylene oxide addition type, melting the mixture, and dispersing the resulting melt by pouring it into an aqueous solution of an alkanolamine under stirring at a temperature of 70-95° C., said alkanolamine being selected from the group consisting of monoethanolamine, diethanolamine, triethanolamine, monomethylethanolamine, monoethylethanolamine, diethylethanolamine, propanolamine, butanolamine, pentanolamine, N-phenylethanolamine, and an alkanolamine of glycerin, said alkanolamine being present in the aqueous solution in an amount of 0.2 to 5 weight percent, said surface-active agent of the higher alcohol/ethylene oxide addition type being an ethylene oxide addition product of a higher alcohol having an alkyl group of at least 8 carbon atoms, an alkyl-substituted phenol or a sorbitan monoacylate and wherein said surface-active agent has an HLB value of at least 12.

Likewise, by example, U.S. Pat. No. 4,528,321 (Allen) discloses a dispersion in a water immiscible liquid of water soluble or water swellable polymer particles and which has been made by reverse phase polymerization in the water immiscible liquid and which includes a non-ionic compound selected from C₄₋₁₂ alkylene glycol monoethers, their C₁₋₄alkanoates, C₆₋₁₂ polyakylene glycol monoethers and their C₁₋₄ alkanoates.

Additional gas barrier layers may additionally comprise one or more of ethylene vinyl acetate (EVA), linear low density polyethylene (LLDPE), polyethylene 2,6- and 1,5-naphthalate (PEN), polyethylene terephthalate glycol (PETG), poly(cyclohexylenedimethylene terephthalate), polylactic acid (PLA), polycarbonate, polyglycolic acid (PGA), polyhydroxyaminoethers, polyethylene imines, epoxy resins, urethanes, acrylates, polystyrene, cycloolefin, poly-4-methylpentene-1, poly(methyl methacrylate), acrylonitrile, polyvinyl chloride, polyvinylidine chloride (PVDC), styrene acrylonitrile, acrylonitrile-butadiene-styrene, polyacetal, polybutylene terephthalate, polymeric ionomers such as sulfonates of PET, polysulfone, polytetra-fluoroethylene, polytetramethylene 1,2-dioxybenzoate, polyurethane, and copolymers of ethylene terephthalate and ethylene isophthalate, and copolymers and/or blends of one or more of the foregoing.

In one embodiment, the gas-barrier resistant coating may comprise poly(glycolic) acid (PGA). This material may be deposited on the article substrate as a base coating layer. In some embodiment, an aqueous dispersion or solution of PGA is deposited on the article substrate to form a coating layer.

In embodiments, the gas-barrier resistant coating may be applied as a water-soluble polymer solution, a water-based polymer dispersion, or an aqueous emulsion of the polymer.

A person having ordinary skill in the art will also understand that certain gas-barrier materials as described herein may also be used as water resistant coating materials, or in combination with such materials.

b. Water-Resistant Coating Materials

Certain coating materials are preferably applied as part of a top coat or layer that provides improved chemical resistance such as to hot water, steam, caustic or acidic materials, compared to one or more layers or the article substrate material beneath the top coat. In certain embodiments, these top coats or layers are aqueous based or non-aqueous based polyesters, acrylics, acrylic acid copolymers such as EAA, polyolefins polymers or copolymers such as polypropylene or polyethylene, and blends thereof which are optionally partially or fully cross linked. One preferred aqueous based polyester is polyethylene terephthalate; however other polyesters may also be used.

Water-resistant coating layers are particularly useful in being applied to an article substrate comprising a material or a layer of a material which degrades in the presence of water. Vinyl alcohol polymer or copolymers such as PVOH and EVOH tend to degrade when exposed to water. Thus, exposure to water degrades the performance of a gas barrier layer comprising vinyl alcohol polymer or copolymers, or other water sensitive gas barrier materials. In addition, some additives and other barrier materials such as UV protective barrier materials may also be sensitive to exposure to water.

In some embodiments, crosslinking between materials in an outer layer will substantially increase the water-resistant properties of inner layers and the article substrate. In some embodiments, the degree of crosslinking can be adjusted by cross linking density and degree.

i. Polymeric Water-Resistant Coating Materials

In some embodiments, the substrate article which may comprise an uncoated surface or a surface coated with one or more layers, can additionally be coated with a water-resistant coating material. In preferred embodiments, a material employed in a water-resistant coating layer is an acrylic polymer or copolymer. In some embodiments, the acrylic polymer or copolymer comprises one or more of a acrylic acid polymer or copolymer, a methacrylic acid polymer or copolymer, or the alkyl esters of methacrylic acid or acrylic acid polymers or copolymers. In some embodiments, the acrylic acid copolymer comprises ethylene acrylic acid (EAA) copolymer. EAA is produced by the high pressure copolymerization of ethylene and acrylic acid. In embodiments, EAA is a copolymer comprising from about 75 to about 95 wt % of ethylene and about 5 to about 25 wt % of acrylic acid. The copolymerization results in bulky carboxyl groups along the backbone and side chain of the copolymer. These carboxyl groups are free to form bonds and interact with polar substrates such as water. In addition, hydrogen bonds of the carboxyl groups may result in increased toughness of the barrier layer. EAA materials may also enhance the clarity, low melting point and softening point of the copolymer.

Salts of acrylic acid polymer or copolymers, such as an ammonium salt of EAA, permit the formation of aqueous dispersions of acrylic acid which allow ease of application in dip, spray, and flow coating processes as described herein. However, some embodiments of a composition comprising acrylate polymers or copolymers may also be applied as emulsions and solutions.

Commercially available examples of EAA aqueous dispersion include PRIMACOR available from DOW PLASTICS, as an aqueous dispersions having 25% solids content and obtained from the copolymerization of 80 wt % ethylene and 20 wt % acrylic acid. Michem® Prime 4983, Prime 4990R, Prime 4422R, and Prime 48525R, are available from Michelman as aqueous dispersions of EAA with solid content ranging from about 20% to about 40%. In some embodiments, EAA may be applied as a water-based or wax emulsion. In some embodiments, EAA dispersions or emulsions have low VOC content and are generally less than about 0.25 wt % of VOCs. However, some EAA dispersions or emulsions are substantially or completely free of VOCs.

In some embodiments, polyolefin polymers or copolymers may be used as a water-resistant coating material. For example, an article comprising a gas barrier layer comprising a vinyl alcohol polymer or copolymer can be further coated with a polyolefin polymer or copolymer such as polypropylene as a water-resistant coating layer. In some embodiments, blends of polyolefins and acrylic polymers and copolymers can be used as a water-resistant coating material. For example, polypropylene (PP) and EAA can be used as a water-resistant coating layer. Blends of EAA and PP may comprise about 5, 10, 15, 20, 25, 30, 35, 40, 45, 50, 55, 60, 65, 70, 76, 80, 85, 90, and 95 wt % of EAA, based on the total weight of the PP and EAA in the water-resistant coating layer.

One or more layers of polyolefin polymers or copolymers, such polyethylene or propylene, may be coated on a dried coating layer comprising a vinyl alcohol polymer or copolymer, such as EVOH or PVOH, to reduce the water sensitivity and decrease water vapor transmission rate of the article substrate. In some embodiments, gas barrier layers comprising a vinyl alcohol polymer or copolymer, such as EVOH, and a Phenoxy-type thermoplastic, such as a PHAE, can be overcoated with layers of polyolefin polymer or copolymers such as polyethylene, polypropylene, or combinations thereof. In some embodiments, gas barrier layers comprising a vinyl alcohol polymer or copolymer, such as EVOH, and a Phenoxy-type thermoplastic, such as a PHAE, can be overcoated with a layer comprising EAA.

In other embodiments, the barrier layer comprising a vinyl alcohol polymer or copolymer, such as EVOH, may also comprise an additional additive which reduces the sensitivity of the vinyl alcohol polymer or copolymer to water, and/or increases the water resistance of the barrier layer. For example, a gas barrier layer comprising EVOH can be can substantially increase the water-resistance of the layer by adding a Phenoxy-type Thermoplastic, such as a PHAE. In some of these embodiments where EVOH is blended with polyhydroxyaminoethers, an additional top water-resistant coating layer may be used to further decrease the sensitivity of an underlying layer to water and to decrease the water transmission rate of the article substrate material. In any of the above examples, EVOH can be substituted with PVOH, or blends of EVOH/PVOH.

ii. Waxes

In some embodiments, a water-resistant coating layer comprises a wax. In some embodiments, the wax is a natural wax such as carnauba or paraffin. In other embodiments, the wax is a synthetic wax such polyethylene, polypropylene and Fischer-Tropsch waxes. Wax dispersions may be micronized waxes dispersed in water. Solvent dispersions are composed of wax combined with solvents. In some embodiments, the particle size of a wax dispersion typically is greater than one micron (1μ). However, the particle size of some dispersions may vary according to the desired coating layer and/or wax material.

In one preferred embodiment, a water-resistant coating layer comprises carnauba. Carnauba wax is a natural wax derived from the fronds of a Brazilian palm tree (Copemica cerifera). Because of its source, carnauba offers the benefit of being FDA-compliant. In addition, carnauba and carnauba-blend emulsions offer performance advantages where additional slip, mar resistance and block resistance are required.

Some calabash are available as high-solids emulsions and can be applied to article substrates as described herein. Some emulsions may comprise from about 10 to about 80 percent solids.

In other embodiments, a water-resistant coating layer comprises paraffins. In some embodiments, paraffins are low-molecular weight waxes with melt points ranging from 48° C. to 74° C. They may be highly refined, have low oil content and are straight-chain hydrocarbons. In preferred embodiments, a water-resistant coating layer comprising paraffins provide anti-blocking, slip, water resistance or moisture vapor transmission resistance. Some embodiments of water-resistant coating layers may comprise blends of carnauba and paraffins. In further embodiments, a water-resistant coating layer may comprises blends of polyolefins and waxes. Some embodiments of water-resistant coating materials may comprise blends of natural waxes and/or synthetic waxes. For example blends of carnauba wax and paraffins may be used in the water-resistant coating layers of some embodiments.

Water-based wax emulsions are commercially available from Michelson. In preferred embodiments, the waterborne wax emulsion has a low VOC content. Examples of a water-based carnauba wax emulsions with low VOC content is Michem Lube 156 and Michem Lube 160. Examples of a water-based blend of carnauba and paraffins with a low VOC content include Michem Lube 180 and Michem Lube 182. One example of a blended polyolefin/wax material for a water-resistant coating layer is Michem Lube 110 which contains polyethylene and paraffins.

c. Foaming Materials

In some embodiments, a foam material may be used in a substrate (base article or preform) or in a coating layer. As used herein, the term “foam material” is a broad term and is used in accordance with its ordinary meaning and may include, without limitation, a foaming agent, a mixture of foaming agent and a binder or carrier material, an expandable cellular material, and/or a material having voids. The terms “foam material” and “expandable material” are used interchangeably herein. Preferred foam materials may exhibit one or more physical characteristics that improve the thermal and/or structural characteristics of articles (e.g., containers) and may enable the preferred embodiments to be able to withstand processing and physical stresses typically experienced by containers. In one embodiment, the foam material provides structural support to the container. In another embodiment, the foam material forms a protective layer that can reduce damage to the container during processing. For example, the foam material can provide abrasion resistance which can reduce damage to the container during transport. In one embodiment, a protective layer of foam may increase the shock or impact resistance of the container and thus prevent or reduce breakage of the container. Furthermore, in another embodiment foam can provide a comfortable gripping surface and/or enhance the aesthetics or appeal of the container.

In one embodiment, foam material comprises a foaming or blowing agent and a carrier material. In one preferred embodiment, the foaming agent comprises expandable structures (e.g., microspheres) that can be expanded and cooperate with the carrier material to produce foam. For example, the foaming agent can be thermoplastic microspheres, such as EXPANCEL® microspheres sold by Akzo Nobel. In one embodiment, microspheres can be thermoplastic hollow spheres comprising thermoplastic shells that encapsulate gas. Preferably, when the microspheres are heated, the thermoplastic shell softens and the gas increases its pressure causing the expansion of the microspheres from an initial position to an expanded position. The expanded microspheres and at least a portion of the carrier material can form the foam portion of the articles described herein. The foam material can form a layer that comprises a single material (e.g., a generally homogenous mixture of the foaming agent and the carrier material), a mix or blend of materials, a matrix formed of two or more materials, two or more layers, or a plurality of microlayers (lamellae) preferably including at least two different materials. Alternatively, the microspheres can be any other suitable controllably expandable material. For example, the microspheres can be structures comprising materials that can produce gas within or from the structures. In one embodiment, the microspheres are hollow structures containing chemicals which produce or contain gas wherein an increase in gas pressure causes the structures to expand and/or burst. In another embodiment, the microspheres are structures made from and/or containing one or more materials which decompose or react to produce gas thereby expanding and/or bursting the microspheres. Optionally, the microsphere may be generally solid structures. Optionally, the microspheres can be shells filled with solids, liquids, and/or gases. The microspheres can have any configuration and shape suitable for forming foam. For example, the microspheres can be generally spherical. Optionally, the microspheres can be elongated or oblique spheroids. Optionally, the microspheres can comprise any gas or blends of gases suitable for expanding the microspheres. In one embodiment, the gas can comprise an inert gas, such as nitrogen. In one embodiment, the gas is generally non-flammable. However, in certain embodiments non-inert gas and/or flammable gas can fill the shells of the microspheres. In some embodiments, the foam material may comprise foaming or blowing agents as are known in the art. Additionally, the foam material may be mostly or entirely foaming agent.

Although some preferred embodiments contain microspheres that generally do not break or burst, other embodiments comprise microspheres that may break, burst, fracture, and/or the like. Optionally, a portion of the microspheres may break while the remaining portion of the microspheres do not break. In some embodiments up to about 0.5%, 1%, 2%, 3%, 4%, 5%, 10%, 20%, 30%, 40%, 50%, 60% 70%, 80%, 90% by weight of microspheres, and ranges encompassing these amounts, break. In one embodiment, for example, a substantial portion of the microspheres may burst and/or fracture when they are expanded. Additionally, various blends and mixtures of microspheres can be used to form foam material.

The microspheres can be formed of any material suitable for causing expansion. In one embodiment, the microspheres can have a shell comprising a polymer, resin, thermoplastic, thermoset, or the like as described herein. The microsphere shell may comprise a single material or a blend of two or more different materials. For example, the microspheres can have an outer shell comprising ethylene vinyl acetate (“EVA”), polyethylene terephthalate (“PET”), polyamides (e.g. Nylon 6 and Nylon 66) polyethylene terephthalate glycol (PETG), PEN, PET copolymers, and combinations thereof. In one embodiment a PET copolymer comprises CHDM comonomer at a level between what is commonly called PETG and PET. In another embodiment, comonomers such as DEG and IPA are added to PET to form microsphere shells. The appropriate combination of material type, size, and inner gas can be selected to achieve the desired expansion of the microspheres. In one embodiment, the microspheres comprise shells formed of a high temperature material (e.g., PETG or similar material) that is capable of expanding when subject to high temperatures, preferably without causing the microspheres to burst. If the microspheres have a shell made of low temperature material (e.g., as EVA), the microspheres may break when subjected to high temperatures that are suitable for processing certain carrier materials (e.g., PET or polypropylene having a high melt point). In some circumstances, for example, EXPANCEL® microspheres may be break when processed at relatively high temperatures. Advantageously, mid or high temperature microspheres can be used with a carrier material having a relatively high melt point to produce controllably, expandable foam material without breaking the microspheres. For example, microspheres can comprise a mid temperature material (e.g., PETG) or a high temperature material (e.g., acrylonitrile) and may be suitable for relatively high temperature applications. Thus, a blowing agent for foaming polymers can be selected based on the processing temperatures employed.

The foam material can be a matrix comprising a carrier material, preferably a material that can be mixed with a blowing agent (e.g., microspheres) to form an expandable material. The carrier material can be a thermoplastic, thermoset, or polymeric material, such as ethylene acrylic acid (“EAA”), ethylene vinyl acetate (“EVA”), linear low density polyethylene (“LLDPE”), polyethylene terephthalate glycol (PETG), poly(hydroxyamino ethers) (“PHAE”), PET, polyethylene, polypropylene, polystyrene (“PS”), pulp (e.g., wood or paper pulp of fibers, or pulp mixed with one or more polymers), mixtures thereof, and the like. However, other materials suitable for carrying the foaming agent can be used to achieve one or more of the desired thermal, structural, optical, and/or other characteristics of the foam. In some embodiments, the carrier material has properties (e.g., a high melt index) for easier and rapid expansion of the microspheres, thus reducing cycle time thereby resulting in increased production.

In another embodiment foaming agents may be added to the coating materials in order to foam the coating layer. In a further embodiment a reaction product of a foaming agent is used. Useful foaming agents include, but are not limited to azobisformamide, azobisisobutyronitrile, diazoaminobenzene, N,N-dimethyl-N,N-dinitroso terephthalamide, N,N-dinitrosopentamethylene-tetramine, benzenesulfonyl-hydrazide, benzene-1,3-disulfonyl hydrazide, diphenylsulfon-3-3, disulfonyl hydrazide, 4,4′-oxybis benzene sulfonyl hydrazide, p-toluene sulfonyl semicarbizide, barium azodicarboxylate, butylamine nitrile, nitroureas, trihydrazino triazine, phenyl-methyl-urethane, p-sulfonhydrazide, peroxides, ammonium bicarbonate, and sodium bicarbonate. As presently contemplated, commercially available foaming agents include, but are not limited to, EXPANCEL®, CELOGEN®, HYDROCEROL®, MIKROFINE®, CEL-SPAN®, and PLASTRON® FOAM. Foaming agents and foamed layers are described in greater detail below.

The foaming agent is preferably present in the coating material in an amount from about 1 up to about 20 percent by weight, more preferably from about 1 to about 10 percent by weight, and, most preferably, from about 1 to about 5 percent by weight, based on the weight of the coating layer (i.e. solvents are excluded). Newer foaming technologies known to those of skill in the art using compressed gas could also be used as an alternate means to generate foam in place of conventional blowing agents listed above.

In preferred embodiments, the formable material may comprise two or more components including a plurality of components each having different processing windows and/or physical properties. The components can be combined such that the formable material has one or more desired characteristics. The proportion of components can be varied to produce a desired processing window and/or physical properties. For example, the first material may have a processing window that is similar to or different than the processing window of the second material. The processing window may be based on, for example, pressure, temperature, viscosity, or the like. Thus, components of the formable material can be mixed to achieve a desired, for example, pressure or temperature range for shaping the material.

In one embodiment, the combination of a first material and a second material may result in a material having a processing window that is more desirable than the processing window of the second material. For example, the first material may be suitable for processing over a wide range of temperatures, and the second material may be suitable for processing over a narrow range of temperatures. A material having a portion formed of the first material and another portion formed of the second material may be suitable for processing over a range of temperatures that is wider than the narrow range of processing temperatures of the second material. In one embodiment, the processing window of a multi-component material is similar to the processing window of the first material. In one embodiment, the formable material comprises a multilayer sheet or tube comprising a layer comprising PET and a layer comprising polypropylene. The material formed from both PET and polypropylene can be processed (e.g., extruded) within a wide temperature range similar to the processing temperature range suitable for PET. The processing window may be for one or more parameters, such as pressure, temperature, viscosity, and/or the like.

Optionally, the amount of each component of the material can be varied to achieve the desired processing window. Optionally, the materials can be combined to produce a formable material suitable for processing over a desired range of pressure, temperature, viscosity, and/or the like. For example, the proportion of the material having a more desirable processing window can be increased and the proportion of material having a less undesirable processing window can be decreased to result in a material having a processing window that is very similar to or is substantially the same as the processing window of the first material. Of course, if the more desired processing window is between a first processing window of a first material and the second processing window of a second material, the proportion of the first and the second material can be chosen to achieve a desired processing window of the formable material.

Optionally, a plurality of materials each having similar or different processing windows can be combined to obtain a desired processing window for the resultant material.

In one embodiment, the rheological characteristics of a formable material can be altered by varying one or more of its components having different rheological characteristics. For example, a substrate (e.g., PP) may have a high melt strength and is amenable to extrusion. PP can be combined with another material, such as PET which has a low melt strength making it difficult to extrude, to form a material suitable for extrusion processes. For example, a layer of PP or other strong material may support a layer of PET during co-extrusion (e.g., horizontal or vertical co-extrusion). Thus, formable material formed of PET and polypropylene can be processed, e.g., extruded, in a temperature range generally suitable for PP and not generally suitable for PET.

In some embodiments, the composition of the formable material may be selected to affect one or more properties of the articles. For example, the thermal properties, structural properties, barrier properties, optical properties, rheological properties, favorable flavor properties, and/or other properties or characteristics disclosed herein can be obtained by using formable materials described herein.

d. Adhesion Materials

In some embodiments, certain adhesion materials may be added to one or more layers of an article substrate. In other embodiments, one or more layers comprises an adhesion material. Thus, as described herein, embodiments may include barrier layers comprising adhesion materials. In other embodiments, tie layers may comprise adhesion materials.

In some preferred embodiments, a polyolefin layer is used as an adhesion layer and/or a barrier layer. In some embodiments, one or more layers may comprise a modified polyolefin composition. In embodiments, an ethylene or propylene homopolymer or copolymer is used as material for an adhesion layer. In one embodiment polypropylene or other polymers may be grafted or modified with polar groups including, but not limited to, maleic anhydride, glycidyl methacrylate, acryl methacrylate and/or similar compounds to improve adhesion. In preferred embodiments, maleic anhydride modified polypropylene homopolymer or maleic anhydride modified polypropylene copolymer can also be used. As used herein, “PPMA” is an acronym for both maleic anhydride modified polypropylene homopolymer and copolymer. As used herein, “PEMA” is an acronym for both maleic anhydride modified polyethylene homopolymer and copolymer. These materials may be interblended with other gas barrier and water-resistant coating materials to aid in the adhesion of these layers to each other or the article substrate material. Alternatively, the materials can be applied as tie layers which adhere the substrate or coating layers to another coating layer.

In some embodiments, blends of polypropylene and PPMA are used. In some embodiments, PPMA is about 20 to about 80 wt % based on the total weight of the polypropylene and PPMA.

In other embodiments polypropylene also refers to clarified polypropylene. As used herein, the term “clarified polypropylene” is a broad term and is used in accordance with its ordinary meaning and may include, without limitation, a polypropylene that includes nucleation inhibitors and/or clarifying additives. Clarified polypropylene is a generally transparent material as compared to the homopolymer or block copolymer of polypropylene. The inclusion of nucleation inhibitors can help prevent and/or reduce crystallinity or the effects of crystallinity, which contributes to the haziness of polypropylene, within the polypropylene or other material to which they are added. Some clarifiers work not so much by reducing total crystallinity as by reducing the size of the crystalline domains and/or inducing the formation of numerous small domains as opposed to the larger domain sizes that can be formed in the absence of a clarifier. Clarified polypropylene may be purchased from various sources such as Dow Chemical Co. Alternatively, nucleation inhibitors may be added to polypropylene or other materials. One suitable source of nucleation inhibitor additives is Schulman.

In some embodiments, Phenoxy-type Thermoplastics may be used together with other layers, whether these are tie layers or barrier layers. For example, a PHAE may be added to one or more layers to increase adhesion between the article substrate material and/or other barrier layers. Other hydroxyl functionalized epoxy resins can also be used as gas barrier materials and/or adhesion materials.

In some embodiments, an adhesion material is polyethyleneimine (PEI) which can be used in one or more coating layers. These polymers have numerous available primary, secondary or tertiary amine groups, which are effective in increasing the adhesion of barrier layers. In some embodiments, PEI is a highly branched polymer with about 25% primary amine groups, 50% secondary amine groups, and 25% tertiary amine groups.

A PEI can promote adhesion, disperse fillers and pigments, and enhance wetting characteristics. In some embodiments, a PEI may additionally scavenge oxides of carbon, nitrogen, sulfur, volatile aldehydes, chlorine, bromine and organic halides. In some embodiments, PEIs may be present in an aqueous emulsion or dispersion. In some embodiments, the molecular weight of PEIs is from about 5,000-1,000,000. In some embodiments, the addition of polyethylene amine to a gas barrier coating layer or a water-resistant coating layer results in a decrease in the rate of transmission of CO₂ through the barrier layers and article substrate. In some embodiments, PEI comprises a copolymer of ethylene imine such as the copolymer of acrylamide and ethylene imine. In some embodiments, one or more PEI can be used in amount of less than about 10 wt % based on the total weight of the layer. In some embodiments, the PEI is about 10 to about 20 wt %. In other embodiments, the PEI is about 0.01 to about 5 wt %.

In preferred embodiments, PEI may be blended together with a vinyl alcohol polymer or copolymer prior to coating. For example, PEI may be blended with EVOH and/or PVOH before being applied as a coated layer on the article substrate. Mixtures of the components may be obtained, in some embodiments, by injecting liquid PEI into an extruder containing EVOH, or placing the liquid PEI and EVOH in the feed hopper prior to mixing by the screw of the extruder. In other embodiments, PEI may be blended with one or more other gas barrier or water-resistant coating materials including Phenoxy-type Thermoplastics such as a PHAE.

In some embodiments, one or more zirconium salts may also be used as an adhesion enhancer for one or more layers coated on the article substrate. In some embodiments, a zirconium salt is one or more of a titanate or a zirconate. Titanates and zirconates may be used as adhesion promoters. In some embodiments, organozirconates may be used as adhesion promoters. In some embodiments, one or more selected from coordinate zirconium, neoalkoxyzirconate, zirconium propionate, zircoaluminates, zirconium acetylacetonate, and zirconium methacrylate may be used as an adhesion promoter. In some embodiments, the zirconium salt is dissolved in a solvent. Examples of zirconium salts may include: halogenated zirconium salts such as zirconium oxychloride, hydroxy zirconium chloride, zirconium tetrachloride, and zirconium bromide; zirconium salts of mineral acid such as zirconium sulfate, basic zirconium sulfate, and zirconium nitrate; zirconium salts of organic acid such as zirconium formate, zirconium acetate, zirconium propionate, zirconium caprylate, and zirconium stearate; zirconium complex salts such as zirconium ammonium carbonate, zirconium sodium sulfate, zirconium ammonium acetate, zirconium sodium oxalate, zirconium sodium citrate, zirconium ammonium citrate; etc. In some embodiments, the zirconium salts may act as a crosslinking agent for a hydrogen-bonding group (such as a hydroxyl group). In addition, the zirconium salt may also improve the water resistance of a highly hydrogen-bonding resin such as a vinyl alcohol polymer or copolymer like PVOH and EVOH, or a Phenoxy-type thermoplastic like polyhydroxyaminoethers, and combinations thereof. In some of these embodiments, the one or more zirconium salt compounds is about 0.1 to about 30 weight percent, based on the total weight of the layer to which the zirconium salt is added. In other embodiments, the one or more zirconium salt compound is about 0.05 to about 3 wt %. In other embodiments, the one or more zirconium salt compound is about 5 to about 15 wt %. In some embodiments, the weight of the adhesion agent is less than 10 wt %. In some embodiments, the weight may exceed 30 wt %, including about 50 wt %. Zirconium salts or dispersions of zirconium salts may be added to the solutions, dispersion, or emulsions of the other barrier materials.

In some embodiments, one or more organic aldehydes may be used as an adhesion enhancer for one or more coating layers. Examples of suitable organic aldehydes include formaldehyde, acetaldehyde, benzaldehyde, polymerizable aldehydes and propionaldehyde, but is not limited thereto. In some embodiments, the organic aldehyde is present in the solution in which the article is dip, spray, or flow coated to form one or more layers. In other embodiments, the organic aldehyde is added to the coating layer after the coating layer is applied to the article substrate. In embodiments, the organic aldehyde is about 0.1 to about 50 weight percent, based on the total weight of the layer to which it is added. In some embodiments, the organic aldehyde is about 10 to about 30 weight percent. In further embodiments, the organic aldehyde is about 0.5 to about 5 weight percent. In other embodiments, the organic aldehyde is less than about 10 wt %.

3. Additives of Coating Layers

One or more coating layers may also comprise additives, such as nanoparticle barrier materials, oxygen scavengers, UV absorbers, colorants, dyes, pigments, abrasion resistant additives, fillers and the like.

An advantage of preferred methods disclosed herein are their flexibility allowing for the use of multiple functional additives in various combinations and/or in one or more layers. Additives known by those of ordinary skill in the art for their ability to provide enhanced CO2 barriers, O2 barriers, UV protection, scuff resistance, blush resistance, impact resistance, water resistance, and/or chemical resistance are among those that may be used. For additives listed herein, the percentages given are percent by weight of the materials in the coating solution exclusive of solvent, sometimes referred to as the “solids” although not all non-solvent materials are solid.

Preferred additives may be prepared by methods known to those of skill in the art. For example, the additives may be mixed directly with a particular material, they may be dissolved/dispersed separately and then added to a particular material, or they may be combined with a particular material to addition of the solvent that forms the material solution/dispersion. In addition, in some embodiments, preferred additives may be used alone as a single layer or as part of a single layer.

In preferred embodiments, the barrier properties of a layer may be enhanced by the use of additives. Additives are preferably present in an amount up to about 40% of the material, also including up to about 30%, 20%, 10%, 5%, 2% and 1% by weight of the material. In other embodiments, additives are preferably present in an amount less than or equal to 1% by weight, preferred ranges of materials include, but are not limited to, about 0.01% to about 1%, about 0.01% to about 0.1%, and about 0.1% to about 1% by weight. In some embodiments additives are preferably stable in aqueous conditions.

Derivatives of resorcinol (m-dihydroxybenzene) may be used in conjunction with various preferred materials as blends or as additives or monomers in the formation of the material. The higher the resorcinol content the greater the barrier properties of the material. For example, resorcinol diglycidyl ether can be used in PHAE and hydroxyethyl ether resorcinol can be used in PET and other polyesters and Copolyester Barrier Materials.

Another type of additive that may be used are “nanoparticles” or “nanoparticulate material.” For convenience the term nanoparticles will be used herein to refer to both nanoparticles and nanoparticulate material. These nanoparticles are tiny, micron or sub-micron size (diameter), particles of materials including inorganic materials such as clay, ceramics, zeolites, elements, metals and metal compounds such as aluminum, aluminum oxide, iron oxide, and silica, which enhance the barrier properties of a material usually by creating a more tortuous path for migrating gas molecules, e.g. oxygen or carbon dioxide, to take as they permeate a material. In preferred embodiments nanoparticulate material is present in amounts ranging from 0.05 to 1% by weight, including 0.1%, 0.5% by weight and ranges encompassing these amounts.

One preferred type of nanoparticulate material is a microparticular clay based product available from Southern Clay Products. One preferred line of products available from Southern Clay products is Cloisite® nanoparticles. In one embodiment preferred nanoparticles comprise monmorillonite modified with a quaternary ammonium salt. In other embodiments nanoparticles comprise monmorillonite modified with a ternary ammonium salt. In other embodiments nanoparticles comprise natural monmorillonite. In further embodiments, nanoparticles comprise organoclays as described in U.S. Patent No. 5,780,376, the entire disclosure of which is hereby incorporated by reference and forms part of the disclosure of this application. Other suitable organic and inorganic microparticular clay based products may also be used. Both man-made and natural products are also suitable.

Another type of preferred nanoparticulate material comprises a composite material of a metal. For example, one suitable composite is a water based dispersion of aluminum oxide in nanoparticulate form available from BYK Chemie (Germany). It is believed that this type of nanoparticular material may provide one or more of the following advantages: increased abrasion resistance, increased scratch resistance, increased Tg, and thermal stability.

Another type of preferred nanoparticulate material comprises a polymer-silicate composite. In preferred embodiments the silicate comprises montmorillonite. Suitable polymer-silicate nanoparticulate material are available from Nanocor and RTP Company. Other preferred nanoparticle materials include fumed silica, such as Cab-O-Sil.

In preferred embodiments, the UV protection properties of the material may be enhanced by the addition of different additives. In a preferred embodiment, the UV protection material used provides UV protection up to about 350 nm or lower, including about 370 nm or lower, and about 400 nm or lower. The UV protection material may be used as an additive with layers providing additional functionality or applied separately from other functional materials or additives in one or more layers. Preferably additives providing enhanced UV protection are present in the material from about 0.05 to 20% by weight, but also including about 0.1%, 0.5%, 1%, 2%, 3%, 5%, 10%, and 15% by weight, and ranges encompassing these amounts. Preferably the UV protection material is added in a form that is compatible with the other materials. For example, a preferred UV protection material is Milliken UV390A ClearShield®. UV390A is an oily liquid for which mixing is aided by first blending the liquid with water, preferably in roughly equal parts by volume. This blend is then added to the material solution, for example, BLOX® 599-29, and agitated. The resulting solution contains about 10% UV390A and provides UV protection up to 390 nm when applied to a PET preform. As previously described, in another embodiment the UV390A solution is applied as a single layer. In other embodiments, a preferred UV protection material comprises a polymer galled or modified with a UV absorber that is added as a concentrate. Other preferred UV protection materials include, but are not limited to, benzotriazoles, phenothiazines, and azaphenothiazines. UV protection materials may be added during the melt phase process prior to use, e.g. prior to injection molding extrusion, or palletizing, or added directly to a coating material that is in the form of a solution or dispersion. Suitable UV protection materials include those available from Milliken, Ciba and Clariant.

Carbon dioxide (CO2) scavenging properties can be added to one or more materials and/or layers. In one preferred embodiment such properties are achieved by including one or more scavengers, such as an active amine reacts with CO2 to form a high gas barrier salt. This salt then acts as a passive CO2 barrier. The active amine may be an additive or it may be one or more moieties in the resin material of one or more layers. Suitable carbon dioxide scavenger materials other than amines may also be used.

Oxygen (O2) scavenging properties can be added to preferred materials by including one or more O2 scavengers such as anthraquinone and others known in the art. In another embodiment, one suitable O2 scavenger is AMOSORB® O2 scavenger available from BP Amoco Corporation and ColorMatrix Corporation which is disclosed in U.S. Pat. No. 6,083,585 to Cahill et al., the disclosure of which is hereby incorporated in its entirety. In one embodiment, O2 scavenging properties are added to preferred phenoxy-type materials, or other materials, by including O2 scavengers in the phenoxy-type material, with different activating mechanisms. Preferred O2 scavengers can act spontaneously, gradually or with delayed action, e.g. not acting until being initiated by a specific trigger. In some embodiments the O2 scavengers are activated via exposure to either UV or water (e.g., present in the contents of the container), or a combination of both. The O2 scavenger, when present, is preferably present in an amount of from about 0.1 to about 20 percent by weight, more preferably in an amount of from about 0.5 to about 10 percent by weight, and, most preferably, in an amount of from about 1 to about 5 percent by weight, based on the total weight of the coating layer.

The materials of certain embodiments may be cross-linked to enhance thermal stability for various applications, for example hot fill applications. In one embodiment, inner layers may comprise low-cross linking materials while outer layers may comprise high crosslinking materials or other suitable combinations. For example, an inner coating on a PET surface may utilize non crosslinked or low cross-linked material, such as the BLOX® 588-29, and the outer coat may utilize another material, such as EXP 12468-4B from ICI, capable of cross linking such as to provide greater adhesion to the underlying layer, such as a PET or PP layer. Suitable additives capable of cross linking may be added to one or more layers. Suitable cross linkers can be chosen depending upon the chemistry and functionality of the resin or material to which they are added. For example, amine cross linkers may be useful for crosslinking resins comprising epoxide groups. Preferably cross linking additives, if present, are present in an amount of about 1% to 10% by weight of the coating solution/dispersion, preferably about 1% to 5%, more preferably about 0.01% to 0.1% by weight, also including 2%, 3%, 4%, 6%, 7%, 8%, and 9% by weight. Optionally, a thermoplastic epoxy (TPE) can be used with one or more crosslinking agents. In some embodiments, agents (e.g. carbon black) may also be coated onto or incorporated into a layer material, including TPE material. The TPE material can form part of the articles disclosed herein. It is contemplated that carbon black or similar additives can be employed in other polymers to enhance material properties.

The materials of certain embodiments may optionally comprise a curing enhancer. As used herein, the term “curing enhancer” is a broad term and is used in its ordinary meaning and includes, without limitation, chemical cross-linking catalyst, thermal enhancer, and the like. As used herein, the term “thermal enhancer” is a broad term and is used in its ordinary meaning and includes, without limitation, materials that, when included in a polymer layer, increase the rate at which that polymer layer absorbs thermal energy and/or increases in temperature as compared to a layer without the thermal enhancer. Preferred thermal enhancers include, but are not limited to, transition metals, transition metal compounds, radiation absorbing additives (e.g., carbon black). Suitable transition metals include, but are not limited to, cobalt, rhodium, and copper. Suitable transition metal compounds include, but are not limited to, metal carboxylates. Preferred carboxylates include, but are not limited to, neodecanoate, octoate, and acetate. Thermal enhancers may be used alone or in combination with one or more other thermal enhancers.

The thermal enhancer can be added to a material and may significantly increase the temperature of the material that can be achieved during a given curing process, as compared to the material without the thermal enhancer. For example, in some embodiments, the thermal enhancer (e.g., carbon black) can be added to a polymer so that the rate of heating or final temperature of the polymer subjected to a heating or curing process (e.g., IR radiation) is significantly greater than the polymer without the thermal enhancer when subjected to the same or similar process. The increased heating rate of the polymer caused by the thermal enhancer can increase the rate of curing or drying and therefore increase production rates because less time is required for the process.

In some embodiments, the thermal enhancer is present in an amount of about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm and ranges encompassing these amounts. The amount of thermal enhancer may be calculated based on the weight of layer which comprises the thermal enhancer or the total weight of all layers comprising the article.

In some embodiments, a preferred thermal enhancer comprises carbon black. In one embodiment, carbon black can be applied as a component of a coating material in order to enhance the curing of the coating material. When used as a component of a coating material, carbon black is added to one or more of the coating materials before, during, and/or after the coating material is applied (e.g., impregnated, coated, etc.) to the article. Preferably carbon black is added to the coating material and agitated to ensure thorough mixing. The thermal enhancer may comprise additional materials to achieve the desire material properties of the article. In another embodiment wherein carbon black is used in an injection molding process, the carbon black may be added to the polymer blend in the melt phase process.

In some embodiments, the polymer includes about 5 to 800 ppm, preferably about 20 to about 150 ppm, preferably about 50 to 125 ppm, preferably about 75 to 100 ppm, also including about 10, 20, 30, 40, 50, 75, 100, 125, 150, 175, 200, 300, 400, 500, 600, and 700 ppm thermal enhancer and ranges encompassing these amounts. In a further embodiment, the coating material is cured using radiation, such as infrared (IR) heating. In preferred embodiments, the IR heating provides a more effective coating than curing using other methods. Other thermal and curing enhancers and methods of using same are disclosed in U.S. patent application Ser. No. 10/983,150, filed Nov. 5, 2004, entitled “Catalyzed Process for Forming Coated Articles,” the disclosure of which is hereby incorporated by reference it its entirety.

In some embodiments the addition of anti-foam/bubble agents is desirable. In some embodiments utilizing solutions or dispersion the solutions or dispersions form foam and/or bubbles which can interfere with preferred processes. One way to avoid this interference is to add anti-foam/bubble agents to the solution/dispersion. Suitable anti-foam agents include, but are not limited to, nonionic surfactants, alkylene oxide based materials, siloxane based materials, and ionic surfactants. Preferably anti-foam agents, if present, are present in an amount of about 0.01% to about 0.3% of the solution/dispersion, preferably about 0.01% to about 0.2%, but also including about 0.02%, 0.03%, 0.04%, 0.05%, 0.06%, 0.07%, 0.08%, 0.09%, 0.1%, 0.25%, and ranges encompassing these amounts.

B. Description of Preferred Articles

Generally, preferred articles herein include preforms or containers having one or more coating layers. The coating layer or layers preferably provide some functionality such as barrier protection, UV protection, impact resistance, scuff resistance, blush resistance, chemical resistance, water-repellency, resistance to water vapor, antimicrobial properties, and the like. The layers may be applied as multiple layers, each layer having one or more functional characteristics, or as a single layer containing one or more functional components. The layers are applied sequentially with each coating layer being partially or fully dried/cured prior to the next coating layer being applied.

As described herein, preferred articles are formed using surface treatment applications. In some embodiments, a preferred article is treated with one or more selected from flame treatment, corona treatment, ionized air treatment, plasma air treatment and plasma arc treatment. In preferred embodiments, one or more of these treatment methods leads to increased adhesion between the article substrate and a layer disposed on the article substrate, or between the layers disposed on the articles. Additionally, in some embodiments, one or more treatments may be used to produce a desired finish to the article. In some embodiments, one or more treatments may be used to configure the bottles to receive indicia or labels.

A preferred substrate is a PET preform or container as described above. However, other substrate materials may also be utilized. Other suitable substrate materials include, but are not limited to, polyesters, polylactic acid, polypropylene, polyethylene, polycarbonate, polyamides and acrylics.

In certain preferred embodiments, the finished article is formed from a process which comprises two or more coating layers applied sequentially upon a base article, which may be in the form of a preform, or a bottle, or any other type of container. As discussed herein, one or more surface treatments may be applied prior to or between coats. The base article may be manufactured from a thermoplastic material that has a lesser gas barrier performance and water vapor barrier performance than one or more of the coating layers to be applied subsequently, and may comprise PET, but in other embodiments may also be PEN, PLA, PP, polycarbonate or other materials as described hereinabove. In another embodiment the base preform or article may incorporate an oxygen scavenger, preferably one that is benign to the subsequent recycling stream after the finished article has been discarded.

For example, in one multiple layer article, the inner layer is a primer or base coat having functional properties for enhanced adhesion to PET (i.e. as a tie layer for other additional coating layers applied over the basecoat), O2 scavenging, UV resistance and passive barrier and the one or more outer coatings provide passive barrier and scuff resistance. In the descriptions herein with regard to coating layers, inner is taken as being closer to the substrate and outer is taken as closer to the exterior surface of the container. Any layers between inner and outer layers are generally described as “intermediate” or “middle.” In other embodiments, multiple coated articles comprise an inner coating layer comprising an O2 scavenger, an intermediate active UV protection layer, followed by an outer layer of the partially or highly cross-linked material. In another embodiment, multiple coated preforms comprise an inner coating layer comprising an O2 scavenger, an intermediate CO2 scavenger layer, an intermediate active UV protection layer, followed by an outer layer of partially or highly cross-linked material. These combinations provide a hard increased cross linked coating that is suitable for carbonated beverages such as beer. In another embodiment useful for carbonated soft drinks, the inner coating layer is a UV protection layer followed by an outer layer of cross linked material. Although the above embodiments have been described in connection with particular beverages, they may be used for other purposes and other layer configurations may be used for the referenced beverages.

In one embodiment, a coating layer applied onto the base article preferably comprises a thermoplastic material that, when applied in a layer having a low thickness as compared to the base substrate, imparts improved gas and/or aroma barrier properties over the base article alone. Suitable materials to be used in a barrier coating layer include thermoplastic epoxy, PHAE, Phenoxy-type thermoplastics, blends including phenoxy-type thermoplastics, EVOH, PVOH, MXD6, Nylon, nanoparticles or nanocomposites and blends thereof, PGA, PVDC, and/or other materials disclosed herein. The material is preferably applied in the form of a water based solution, dispersion, or emulsion but can also be applied as a solvent based solution, dispersion, or emulsion, preferably exhibiting low VOCs or as a melt. Materials are preferably those approved by the FDA for direct food contact, but such approval is not necessary. Additives to a barrier or any other coating layer may include UV absorbers, coloring agents and adhesion promoters to enhance adhesion of the coating to the substrate or another layer which it covers. Additionally, adhesion may be enhanced by one or more surface treatments as described herein. To achieve desired properties, suitable materials may be partially heat cured and/or crosslinked to various degrees dependant on the application. The coating layer material is preferably applied by dip, spray or flow coating as described herein, followed by drying and/or curing as necessary, preferably with IR or other suitable means. If the coating material is applied in the form of a solution, dispersion, or the like, the coated substrate is preferably completely dry before any subsequent coating layer is applied, if any.

In one embodiment, the outermost or top coating layer, such as the second coat in a two-layer coating process for a three or more layer article or preform or the first coating layer in a one-layer coating process to make a preform or container having at least two layers, preferably comprises a water-resistant coating material, that is a thermoplastic material that imparts a barrier to water vapor, exhibits water repellency and/or exhibits chemical resistance to hot water. In preferred embodiments, the material is fast curing and/or heat stable. Optionally, additives such as those to increase lubricity and abrasion resistance over the base article alone are also included. To achieve desired properties, suitable materials may be partially heat cured and/or crosslinked to various degrees dependant on the application. In addition, one or more base layers or top layer may be surface treated.

Suitable materials for water-resistant coating layers include ethylene-acrylic acid copolymers, polyolefins, polyethylene, blends of polyethylene/polypropylene/other polyolefins with EAA, urethane polymer, epoxy polymer, and paraffins. Other suitable materials include those disclosed in U.S. Pat. No. 6,429,240, which is hereby incorporated by reference in its entirety. Among polyolefins, one preferred class is low molecular weight polyolefins, preferably using metallocene technology which can facilitate tailoring a material to desired properties as is known in the art. For example, the metallocene technology can be used to fine-tune the material to improve the handling, achieve desired melting temperature or other melting behaviour, achieve a desired viscosity, achieve a particular molecular weight or molecular weight distribution (e.g. Mw, Mn) and/or improve the compatibility with other polymers. An example of suitable materials is the LICOCENE range of polymers manufactured by Clariant. The range includes olefin waxes such as polyethylene, polypropylene and PE/PP waxes available from Clariant under the tradenames LICOWAX, LICOLUB and LICOMONT. More information is available at www.clariant.com. Other materials include grafted or modified polymers, including polyolefins such as polypropylene, where the grafting or modification includes polar compounds such as maleic anhydride, glycidyl methacrylate, acryl methacrylate and/or similar compounds. Such grafted or modified polymers alter the properties of the materials and can, for example, enable better adhesion to both polyolefins such as polypropylene and/or PET or other polyesters. Materials are preferably those approved by the FDA for direct food contact, but such approval is not necessary.

In polyethylene/EAA blends, generally speaking, the higher the polyethylene content the better the resultant water resistance, but the lower the EAA content the poorer the adhesion. Similar trade-offs may occur with other blends comprising one or more of the materials listed above. Accordingly, the percentage of each component in a blend are chosen to maximize whichever characteristics are deemed more important in a given application and given the other materials used in the article.

In one embodiment a preform or container made of a suitable base material, including but not limited to PET or PLA, is provided. The preform further comprises a water-resistant coating layer of polyolefin such as polypropylene (PP), EAA, a PP/EAA blend, or any other water-resistant coating material. In some embodiments, the preform also comprises a layer of one or more gas barrier material, such as a phenoxy-type thermoplastic, such as PHAE or a thermoplastic epoxy, or a vinyl alcohol polymer or copolymer, such as EVOH. In some embodiments, blends of Phenoxy-type Thermoplastics and vinyl alcohol polymers or copolymers are used. In preferred embodiments, a gas barrier layer comprises blends of EVOH and a PHAE. In some embodiments, the gas barrier layer is the base coat and the water-resistant coating layer is an outer coating layer.

In one preferred embodiment, an article substrate comprises a surface, a gas-barrier layer disposed on the surface, and a water-resistant coating layer. In this embodiment, specific combination of materials may allow for substantial reduction of gas and water transmission across the one or more barrier layers and the surface of the article substrate.

In one embodiment, the surface of the article substrate comprises PET. In these embodiments, the gas barrier layer comprises a vinyl alcohol polymer or cpolymer. In some embodiments, the vinyl alcohol polymer or copolymer is EVOH. In some embodiments, EVOH has an ethylene content from about 75 wt % to about 95 wt %. In other embodiments, EVOH has an ethylene content from about 65 wt % to about 85 wt %. In other embodiments, the vinyl alcohol polymer or copolymer is PVOH. In some of these embodiments, an adhesion agent is added to the composition prior to application or prior to curing. In some preferred embodiments, a gas barrier layer comprises a vinyl alcohol polymer or copolymer, such as EVOH or PVOH, or blends thereof, and polyethyleneimine. On top of the gas barrier layer may be disposed another coating layer. In some embodiments, the coating layer is a water-resistant coating layer. In some embodiments, the water-resistant coating layer comprises a polyolefin polymer or copolymer. In some cases the polyolefin is polyethylene, polypropylene, or copolymers thereof. In other embodiments, the top water-resistant coating layer comprises an acrylic polymer or copolymer such as EAA. Additionally some of these embodiments comprise one or more layers containing polyethyleneimine. In one particular embodiment, an inner layer comprises excess polyethyleneimine. In some cases, wherein CO2 reaches the layer comprising excess polyethyleneimine, a salt is formed that additionally aids in the gas barrier properties of the layer comprising PEI as well as that of the overall article substrate.

In other embodiments, the gas barrier layer comprises a blend of vinyl alcohol polymers or copolymers, such as a blend of EVOH and PVOH. In some embodiments, the blend comprises about 5, 10, 15, 20, 25, 30, 35, 40, 45, 50, 55, 60, 65, 70, 75, 80, 85, 90, and 95 wt % of EVOH, based on the total weight of the blend of EVOH and PVOH. In some of these embodiments, an additional water-resistant coating layer is coated thereon. In these embodiments, the water-resistant coating layer comprises a polyolefin polymer or copolymer. In some cases, the polyolefin polymer or copolymer is polyethylene, polypropylene, or copolymers thereof. In other embodiments, the water-resistant coating layer comprises EAA.

In some embodiments, the gas barrier layer comprises a blend of a vinyl alcohol polymer or copolymer and Phenoxy-type thermoplastic such as a polyhydroxyaminoether. In some of these embodiments, the vinyl alcohol polymer or copolymer is PVOH. In other embodiments, the vinyl alcohol polymer or copolymer is EVOH. In some embodiments, the blend comprises about 5, 10, 15, 20, 25, 30, 35, 40, 45, 50, 55, 60, 65, 70, 75, 80, 85, 90, and about 95 wt % of the polyhydroxyaminoether. A water-resistant coating layer may be coated as a top layer on the gas barrier layer. In some embodiments, the water-resistant coating layer comprises a polyolefin polymer or copolymer. In some embodiments, the polyolefin is polyethylene, polypropylene, or copolymers thereof. In other embodiments, the water-resistant coating layer comprises EAA.

Some embodiments comprise blends of EVOH and other thermoplastic reactive materials. In some embodiments, EVOH may be blended with an epoxy based thermoplastic material such as a PHAE. In other embodiments, EVOH may be blended with a polyester polymeric material. In other embodiments, EVOH may be blended with a polyether based thermoplastic which in some cases may be a polyurethane.

Some articles may comprise a surface, wherein the surface comprises PLA. In some of these embodiments, the articles comprising PLA may be biodegradable. In some embodiments, one or more layers may be coated on the PLA article substrate surface. In some embodiments, PP/PPMA blends are disposed on the PLA surface. In some embodiments, a tie layer is disposed between the PLA surface and a gas-barrier layer and/or a water-resistant coating layer. In some embodiments, a water-resistant coating layer is disposed on the gas barrier layer or a tie layer comprising polyolefin polymer or copolymer. In these embodiments, the gas barrier layer may comprise a vinyl alcohol polymer or copolymer. In other embodiments, the gas barrier layer comprises a Phenoxy-type thermoplastic, such as polyhydroxyaminoether. In some embodiments, the gas barrier layer comprises a blend of a vinyl alcohol polymer or copolymer and a polyhydroxyaminoether. Blends of vinyl alcohol polymer or copolymers and polyhydroxyaminoethers may comprises about 5, 10, 15, 20, 25, 30, 35, 40, 45, 50, 55, 60, 65, 70, 75, 80, 85, 90, and 95% of the one or more vinyl alcohol polymers or copolymers, based on the total weight of the one or more vinyl alcohols and the one or more polyhydroxyaminoethers. In embodiments, a gas barrier layer comprises a polyhydroxyaminoether and a polyethyleneimine.

In other embodiments, wherein the substrate is made of PLA, a layer comprising a blend of polypropylene and PPMA may be coated on the substrate surface. In other embodiments, polyethylene is coated in the PLA surface. In some embodiments, wherein the substrate is made of a Thermoplastic material, such as a polyester, which in some cases is PET, a layer comprising blend of polypropylene and PPMA may be coated on the substrate surface. In some embodiments, a layer comprising a blend of polypropylene and PPMA may be coated with a gas barrier coating material comprising one or more of vinyl alcohol polymers or copolymers such as EVOH and/or PVOH. . In some embodiments, a layer comprising EVOH and PVOH may be coated with a water-resistant coating material comprising one or more of EAA and PP.

In some embodiments, when the article substrate is made of a thermoplastic material, such as a polyester, a gas-barrier layer comprising EVOH is applied to form a first coating layer. To this layer is applied another coating layer comprising a modified polyolefin, such as PPMA or PEMA to form a first inner coating layer. On top of the modified polyolefin polymer or copolymer layer may be deposited one or more selected from EAA, EVA, PP. In some embodiments, the top layer comprises a nylon. All of the forementioned layers may be applied as aqueous solutions, dispersions, or emulsions by dip, spray, or flow coating methods as described herein.

In some embodiments, the article substrate is made of a thermoplastic material. In some embodiments, a polyamide film is disposed on the surface of the article substrate to form a first polyamide coating layer. In one embodiment, a gas barrier layer comprising a vinyl alcohol polymer or copolymer is disposed on the first polyamide coating layer. In some of these embodiments, an additional water-resistant coating layer may be disposed on the layer comprising the vinyl alcohol polymer or copolymer. In other embodiments, a second polyamide layer may be disposed on the gas barrier layer comprising vinyl alcohol polymer or copolymer. Additionally, the second polyamide layer may comprise a polyolefin polymer or copolymer. In some embodiments, the gas barrier layer, the polyamide layer, or the water-resistant coating layer may additionally comprise excess polyethyleneimine. In all of these embodiments, the layers can be applied as aqueous solutions, dispersion, or emulsions by dip, spray, or flow coating as described herein.

In some embodiments, an article substrate comprising a Thermoplastic material is coated with a first tie layer, a gas barrier layer, a second tie layer, and a water-resistant coating layer. In these embodiments, the first and second tie layer may comprise one or adhesive materials as described herein. In some embodiments, the first and second tie layers comprising PPMA and or PPMA/PP blends. In some embodiments, a water-resistant layer comprising a wax may be disposed on one or more tie layers. In some embodiments, the wax is a natural wax like carnauba wax or paraffins. In other embodiments, the wax is a synthetic wax. In some of these embodiments, the gas barrier layer comprises a vinyl alcohol polymer or copolymer. In other embodiments, the gas barrier layer comprises a Phenoxy-type material such as a PHAE. In other embodiments, the gas barrier layer comprises a blend of a PHAE and EVOH.

The coating is preferably applied in a liquid form. The liquid may be a solution, dispersion or emulsion, or a melt. In some embodiments, the liquid is water which forms a water-based solution, dispersion, or emulsion. In one embodiment, the material is applied as a melt. The melt may comprise one or more materials as described above and elsewhere herein, and may also comprise one or more additives, including functional additives, such as are described elsewhere herein. The temperature of the melt during application depends upon the melt temperature of the one or more components, and may also depend upon one or more other characteristics such as the viscosity, additives, mode of application, and the like. One should also consider the melt temperature and Tg of the substrate and underlying coating materials prior to selecting an application temperature for the melt coating. In one embodiment, the hot melt material is heated to about 120-150 ° C. and applied to a preform or container by dip or flow coating, or spray coating, followed by cooling to solidify the coating. One advantage to the melt coating is that it allows for a water repellent or resistant coating to be applied without exposing the substrate or other coating layer(s) to water. One preferred material for hot melt dip or flow coating is low molecular weight polyester, such as polypropylene.

In other embodiments, water and/or water vapor-resistant material is applied in the form of a melt or an aqueous or solvent based solution or dispersion, preferably exhibiting low VOCs. Additives to a coating layer may include silicone based lubricants, waxes, paraffins, thermal enhancers, UV absorbers and adhesion promoters. The application is preferably effected by dip, spray or flow coating on to a preform or article such as a container, followed by drying and curing, preferably with IR, other radiation, blown air or other suitable means. In one embodiment, the outer surface of the article is suitable for printing directly thereon with any desired graphic design, such as by using inks and pigments including those suitable for use in the food and beverage packaging arts.

The resultant containers can be suitable for use in cold fill, hot fill and pasteurization processes. In another embodiment, where gas barrier properties are not needed or desirable for a layer but high water vapor barrier is important, a coating layer may be applied directly onto the base article without the need to apply a coating of high gas barrier material.

In a related embodiment, the final coating and drying of the preform provides scuff resistance to the surface of the preform and finished container in that the solution or dispersion contains diluted or suspended paraffin or wax, slipping agent, polysilane or low molecular weight polyethylene to reduce the coefficient of friction of the container.

C. Enhanced Adhesion of Preferred Materials

As described herein, using a surface pre-treatment prior to coating or between coatings, it is possible to achieve excellent adhesion between certain materials. In some embodiments, one material would not have good adhesion to another material but for a surface pretreatment. The surface treatment may be used to enhance the adhesion between layers comprising the same or different materials.

In some embodiments, the adhesion between a layer comprising one or more polyolefins and a layer comprising one or more selected from polylactic acid, polymer or copolymers of vinyl alcohols, or polyesters may be increased by a surface treatment as described herein. In certain of these embodiments, a surface treatment increases the adhesion of a layer comprising polypropylene (with or without modification or grafting of maleic anhydride or other compound) and a layer comprising polylactic acid, polymers or copolymers of vinyl alcohols (e.g., EVOH & PVOH), or PET. In another embodiments, the adhesion between a layer comprising polylactic acid and polyethylene (with or without modification or grafting of maleic anhydride or other compound) may be increased by a surface treatment as described herein.

In other embodiments, the adhesion between a layer comprising one or more polymers or copolymers of vinyl alcohols (e.g., EvOH) and acrylates (e.g., EAA) or polyolefins (e.g., polypropylene) may be increased by a surface treatment as described herein.

The methods described herein are not limited to any particular method and includes increasing adhesion of layers comprising any and all combinations of the above individual materials with each other and with other resins. In some particular embodiments, a layer comprising any of the described materials may have increased adhesion to one or more layers comprising resins such as phenoxy-type thermoplastics, thermoplastic epoxy resins, and other thermoplastics.

In a preferred method, a substrate, such as a preform or bottle, is treated with plasma and/or other surface treatment, the treated substrate is then coated with a first layer of coating material to form a coated substrate. The coating may be done by flow coating, dip coating, spray coating, overmolding (such as by IOI or index), or any other suitable coating process. In some circumstances, most notably where the coating is solvent based, the coating is preferably cured and/or dried. The coated substrate is optionally treated with air plasma and/or chemical plasma, and then coated with a further layer. The process of treating, coating, and optionally curing/drying may be repeated as often as desired to obtain the desired number and character of layers upon the article. In some embodiments, the treating step is not performed between each coating step.

The foregoing process can be used in connection with a dip, spray or flow coating process wherein the substrate comprises a material such as PET, PP, or PLA, one or more coating layers comprise a phenoxy-type thermoplastic (e.g. PHAE or BLOX resins) or EVOH, and optional top coat layer(s) comprise EAA, EAA with PPMA (polypropylene modified or grafted with maleic anhydride), or PEMA (polyethylene modified or grafted with maleic anhydride). Other materials, including those mentioned elsewhere in the present disclosure, may be used as substrate, coating or top coating materials in accordance with this method.

The foregoing process may also be used with injection molding wherein the substrate (first injection, inner layer) comprises PET, PP, PLA, or Phenoxy-type thermoplastic materials (including PHAE and hydroxy-phenoxyethers) and the overmolded layer comprises PET, PP, Nylon, PE, PLA or PPMA. Other materials, including those mentioned elsewhere in the present disclosure, may be used in the inner and/or overmolded layer in accordance with this method.

In another embodiment, one or more compounds are applied to the surface of a layer or substrate prior to coating to increase adhesion, e.g. by altering surface tension, polarity, and/or other surface properties that can affect adhesion. For example, a liquid comprising one or more polar molecules may be applied to a preform, container or other article by dip, flow or spray coating (with or without using the particular apparatus described herein). In one embodiment, the liquid comprises monomer, oligomer, and or polymer corresponding to the polymer of the layer or substrate. For example, a PLA substrate may be coated or otherwise exposed to a liquid comprising lactic acid, PLA oligomer and/or PLA polymer. The article may then be coated with a material such as EAA, polyolefin or a blend thereof.

D. Methods and Apparatus for Preparation of Coated Articles

Once suitable coating materials are chosen, the preform is preferably coated in a manner that promotes adhesion between the two materials. Although the discussion which follows is in terms of preforms, such discussion should not be taken as limiting, in that the methods and apparatus described may be applied or adapted for containers and other articles. Generally, adherence between coating materials and the preform substrate increases as the surface temperature of the preform increases. Therefore it is preferable to perform coating on a heated preform, although preferred coating materials will adhere to the preform at room temperature. In addition, adherence between coating materials and/or the preform substrate may be increased by one or more of the surface treatment methods described herein.

Plastics generally, and PET preforms specifically, have static electricity that results in the preforms attracting dust and getting dirty quickly. In one embodiment, the preforms are taken directly from the injection-molding machine and coated, including while still warm. In another embodiment, the preforms are taken directly from the injection molding machine and treated with one or more surface treatments as described herein, followed by coating. By coating the preforms immediately after they are removed from the injection-molding machine, or surface treating the preforms prior to coating, not only is the dust problem avoided, it is believed that the warm preforms and/or the surface treated preforms enhance the coating process. However, the methods also allow for coating of preforms that are stored prior to coating. For example, the preforms may be stored and then surface treated prior to coating. Such a method is believed to enhanced adhesion between the preform and coating material. Preferably, the preforms are substantially clean, however cleaning is not necessary.

Prior to one or all coating steps and/or following a coating, drying, curing, and/or cooling step, the preform substrate may be subjected to a surface treatment, such as flame, corona or plasma. Such treatment may be done to increase the surface energy, clean the surface, deposit material, microetch the surface, cross-link the surface, modify the mechanical properties of the surface, modify the chemical properties of the surface and/or modify the morphology of the surface.

In one embodiment, a treatment apparatus, such as a plasma treatment apparatus or module, is placed in the coating system so that the preforms are conveyed through the treatment apparatus and treated as part of the coating process. In one embodiment, a Dyn-A-Mite plasma treatment (e.g. glow discharge) apparatus or similar apparatus is used to treat the surface using a suitable gas, including but not limited to one or more of oxygen, hydrogen, hydrocarbon, fluorinated material, fluorocarbon, inert/noble gas, nitrogen containing gas (e.g. N₂O, NH₃, N₂), carbon dioxide, silicon oxide, and other suitable materials. In a preferred embodiment, the treatment is performed to a bare substrate prior to coating and/or between coating layers.

1. Dip, Spray or Flow Coating

In one embodiment, the articles to be coated can first be exposed to a surface treatment which provides the effect of surface modification and/or cleaning. This treatment may be effected in-line as part of the coating apparatus, including treating the substrate by performing the treatment immediately after the preforms are taken into the system, such as by a star wheel from the in-feed. In one embodiment, the first coating layer is applied to the treated surface, and has enhanced adhesion to the surface of the preform or container substrate as a result thereof. The increased adhesion may be from the reduction or absence of dirt or grease particles on the surface and/or from the activation of the surface of the substrate resulting from the ionized air or plasma treatment. After the first coating layer has been applied and dried and/or cured, the coated preform or container may then be exposed to a further treatment of the same or different kind. In one embodiment, the further treatment is by exposing the coated substrate to a plasma treatment which provides the effect of enhancing the adhesion of the next coating layer to be applied, such as a top coat. In another embodiment, the plasma treatment may be applied to only the coating layers and not to the substrate. In yet another embodiment, the outermost coating layer is subject to plasma treatment to create desired properties in the finished outer surface. Such treatments may occur before or after blowmolding or other processing to form a container.

In a preferred embodiment an automated system is used. One preferred method involves entry of the preform into the system, surface treating the preform, dip, spray, or flow coating of the preform, optional removal of excess material, drying/curing, cooling, and ejection from the system. The system may also optionally include a recycle step. The system may also optionally include a second surface treatment to provide a desired finish. In one embodiment, the apparatus is a single integrated processing line that contains two or more surface treating units, two or more dip, flow, or spray coating units and two or more curing/drying units that produce a preform with multiple coatings. In another embodiment, the system comprises one or more coating modules. Each coating module comprises a self-contained processing line with one or more dip, flow, or spray coating units and one or more curing/drying units. The coating module may optionally comprise a surface treating unit.

Depending on the module configuration, a preform may receive one or more coatings. For example, one configuration may comprise three coating modules wherein the preform is transferred from one module to the next, in another configuration, the same three modules may be in place but the preform is transferred from the first to the third module skipping the second. This ability to switch between different module configurations allows for flexibility in coatings and surface treatments. In a further preferred embodiment either the modular or the integrated systems may be connected directly to a preform injection-molding machine and/or a blow-molding machine. In certain machines, the injection molding machine may also comprise a surface treatment module to treat the preform prior to one or more coatings. In some embodiments, the injection molding machine prepares preforms.

The following describes a preferred embodiment of a coating system that is fully automated. This system is described in terms of currently preferred materials, but it is understood by one of ordinary skill in the art that certain parameters will vary depending on the materials used and the particular physical structure of the desired end-product preform. This method is described in terms of producing coated 24 gram preforms having about 0.05 to about 0.75 total grams of coating material deposited thereon, including about 0.07, 0.09, 0.10, 0.15, 0.20, 0.25, 0.30, 0.35, 0.40, 0.45, 0.50, 0.55, 0.60, 0.65, and 0.70 grams. In the method described below, the coating solution/dispersion is preferably at a suitable temperature and viscosity to deposit about 0.06 to about 0.20 grams of coating material per coating layer on a 24 gram preform, also including about 0.07, 0.08, 0.09, 0.1, 0.11, 0.12, 0.13, 0.14, 0.15, 0.16. 0.17, 0.18, and 0.19 grams per coating layer on a 24 gram preform. Preferred deposition amounts for articles of varying sizes may be scaled according to the increase or decrease in surface area as compared to a 24 gram preform. Accordingly, articles other than 24 gram preforms may fall outside of the ranges stated above. Furthermore, in some embodiments, it may be desired to have a single layer or total coating amount on a 24 gram preform that lies outside of the ranges stated above.

In some particular embodiments, the methods described herein may be used to make coated articles comprising a gas barrier layer and a water-resistant coating layer. An aqueous solution, emulsion or dispersion comprising a gas-barrier composition may be applied to an article. In certain embodiments, this occurs prior to or after a surface treatment. In some preferred embodiments, the gas barrier composition comprises one or more of EVOH, PVOH, and polyhydroxyaminoethers. In some particular embodiments, the gas barrier composition comprises mixtures of EVOH and a polyhydroxyaminoether. In some of these embodiments, the composition comprises about 20 to about 80 wt % of the EVOH and about 20 to about 80 wt % of the polyhydroxyaminoether, based on the total weight of the EVOH and polyhydroxyaminoether. Additionally, the gas barrier composition may comprise polyethyeleneimine which further reduces the transmission of gas across the gas barrier layer. After the layer is disposed on the article substrate, it is dried to form a first coating layer. To this layer may be deposited one or more of a gas barrier layer, a water-resistant layer, or a tie layer. In some embodiments, a tie layer is applied to the substrate prior to the application of the gas barrier layer or applied to the top of the gas barrier layer. A tie layer may comprise one or more of PPMA and PEMA is applied to the gas barrier layer. PEMA and PPMA may also be added directly to the gas barrier layer prior to drying.

After the inner layers have partially or fully dried, one or more of water-resistant coating layer comprising a water-resistant coating material made by applied as an aqueous solution, dispersion, or emulsion. The water-resistant coating material may occur prior to or after a surface treatment. In some embodiments, the water-resistant coating material is a wax. In some embodiments, the water-resistant coating material is a polyolefin such as PE or PP. In some embodiments, the water-resistant coating material is EAA. In some embodiments, the water-resistant coating material comprises EAA/PP blends wherein the blend comprises about 5, 10,15, 20, 25, 30, 35, 40, 45, 50, 55, 60, 65, 70, 75, 80, 85, 90, and 95 wt % of EAA based on the total weight of the blend. The water-resistant coating layer is allowed to dry to form a water-resistant coating layer.

For example, in some embodiments of methods described herein, a 24 gram preforms having about 0.05 to about 0.75 total grams of coating material deposited thereon, including about 0.07, 0.09, 0.10, 0.15, 0.20, 0.25, 0.30, 0.35, 0.40, 0.45, 0.50, 0.55, 0.60, 0.65, and 0.70 grams. In the method described below, the aqueous solution, dispersion or emulsion coating is preferably at a suitable temperature and viscosity to deposit about 0.06 to about 0.20 grams of gas barrier material per gas barrier coating layer on a 24 gram preform, also including about 0.07, 0.08, 0.09, 0.1, 0.11, 0.12, 0.13, 0.14, 0.15, 0.16. 0.17, 0.18, and 0.19 grams per coating layer on a 24 gram preform. This gas barrier coating layer can comprise one or more of EVOH, PVOH, and a polyhydroxyaminoether. The material may also include PEI. In the method described below, the aqueous solution, dispersion or emulsion coating is preferably at a suitable temperature and viscosity to deposit about 0.06 to about 0.20 grams of water-resistant coating material per water-resistant coating coating layer on a 24 gram preform, also including about 0.07, 0.08, 0.09, 0.1, 0.11, 0.12, 0.13, 0.14, 0.15, 0.16. 0.17, 0.18, and 0.19 grams per coating layer on a 24 gram preform. This water-resistant coating layer can comprise one or more of a wax, a polyolefin such as polypropylene, and EAA. In addition, a tie layer may be disposed between the bas barrier coating layer and the water-resistant coating layer. Preferably, an aqueous solution, dispersion or emulsion may be used to deposit about 0.01 to about 0.15 grams of an adhesion material per tie layer on a 24 gram preform. Preferred deposition amounts for articles of varying sizes may be scaled according to the increase or decrease in surface area as compared to a 24 gram preform. Accordingly, articles other than 24 gram preforms may fall outside of the ranges stated above. Furthermore, in some embodiments, it may be desired to have a single layer or total coating amount on a 24 gram preform that lies outside of the ranges stated above. In any of the foregoing, surface treatments may be applied to the preform prior to, between or after coatings.

The apparatus and methods may also be used for other similarly sized preforms and containers, or may adapted for other sizes of articles as will be evident to those skilled in the art in view of the discussion which follows. Currently preferred coating materials include, TPEs, preferably phenoxy type resins, more preferably PHAEs, including the BLOX resins noted supra. These materials and methods are given by way of example only and are not intended to limit the scope of the invention in any way.

a. Entry Into the System

The preforms are first brought into the system. An advantage of one preferred method is that ordinary preforms such as those normally used by those of skill in the art may be used. For example, 24 gram monolayer preforms of the type in common use to make 16 ounce bottles can be used without any alteration prior to entry into the system. In one embodiment the system is connected directly to a preform injection molding machine providing warm preforms to the system. In another embodiments, the system is connected directly to a surface treatment module to provide enhanced adhesion between the article substrate and subsequent coatings. In another embodiment stored preforms are added to the system by methods well known to those skilled in the art including those which load preforms into an apparatus for additional processing. Preferably the stored preforms are pre-warmed to about 100° F. to about 130° F., including about 120° F., prior to entry into the system. The stored preforms are preferably clean, although cleaning is not necessary. Cleaning may be affected by a surface treatment method as described herein. PET preforms are preferred, however other preform and container substrates can be used. Other suitable article substrates include, but are not limited to, various polymers such as polyesters, polyolefins, including polypropylene and polyethylene, polycarbonate, polyamides, including nylons, or acrylics.

b. Dip, Spray, or Flow Coating

Once a suitable coating material is chosen, it can be prepared and used for either dip, spray, or flow coating. The material preparation is essentially the same for dip, spray, and flow coating. The coating material comprises a solution/dispersion made from one or more solvents into which the resin of the coating material is dissolved and/or suspended.

The temperature of the coating solution/dispersion can have a drastic effect on the viscosity of the solution/dispersion. As temperature increases, viscosity decreases and vice versa. In addition, as viscosity increases the rate of material deposition also increases. Therefore temperature can be used as a mechanism to control deposition. In one embodiment using flow coating, the temperature of the solution/dispersion is maintained in a range cool enough to minimize curing of the coating material but warm enough to maintain a suitable viscosity. In one embodiment, the temperature is about 60° F.-80° F., including about 70° F. In some cases, solutions/dispersions that may be too viscous to use in spray or flow coating may be used in dip coating. Similarly, because the coating material may spend less time at an elevated temperature in spray coating, higher temperatures than would be recommended for dip or flow coating because of curing problems may be utilized in spray coating. In any case, a solution or dispersion may be used at any temperature wherein it exhibits suitable properties for the application. In preferred embodiments, a temperature control system is used to ensure constant temperature of the coating solution/dispersion during the application process. In certain embodiments, as the viscosity increases, the addition of water may decrease the viscosity of the solution/dispersion. Other embodiments may also include a water content monitor and/or a viscosity monitor that provides a signal when viscosity falls outside a desired range and/or which automatically adds water or other solvent to achieve viscosity within a desired range.

In a preferred embodiment, the solution/dispersion is at a suitable temperature and viscosity to deposit about 0.06 to about 0.2 grams per coat on a 24 gram preform, also including about 0.07, 0.08, 0.09, 0.1, 0.11, 0.12, 0.13, 0.14, 0.15, 0.16. 0.17, 0.18, and 0.19 grams per coating layer on a 24 gram preform. Preferred deposition amounts for articles of varying sizes may be scaled according to the increase or decrease in surface area as compared to a 24 gram preform. Accordingly, articles other than 24 gram preforms may fall outside of the ranges stated above. Furthermore, in some embodiments, it may be desired to have a single layer on a 24 gram preform that lies outside of the ranges stated above.

In one embodiment, coated preforms produced from dip, spray, or flow coating are of the type seen in FIG. 3. The coating 22 is disposed on the body portion 4 of the preform and does not coat the neck portion 2. The interior of the coated preform 16 is preferably not coated. In a preferred embodiment this is accomplished through the use of a holding mechanism comprising an expandable collet or grip mechanism that is inserted into the preform combined with a housing surrounding the outside of the neck portion of the preform. The collet expands thereby holding the preform in place between the collet and the housing. The housing covers the outside of the neck including the threading, thereby protecting the inside of the preform as well as the neck portion from coating.

In preferred embodiments, coated preforms produced from dip, spray, or flow coating produce a finished product with substantially no distinction between layers. Further, in dip and flow coating procedures, it has been found that the amount of coating material deposited on the preform decreases slightly with each successive layer.

In other preferred embodiments, a surface treatment such as corona, flame, or plasma treatment may be used on the preform prior to, between or after coatings.

i. Dip Coating

In a preferred embodiment, the coating is applied through a dip coating process. The preforms are dipped into a tank or other suitable container that contains the coating material. The dipping of the preforms into the coating material can be done manually by the use of a retaining rack or the like, or it may be done by a fully automated process. In a preferred embodiment, the preforms are rotating while being dipped into the coating material. The preform preferably rotates at a speed of about 30-80 RPM, more preferably about 40 RPM, but also including 50, 60, and 70 RPM. This allows for thorough coating of the preform. Other speeds may be used, but preferably not so high as to cause loss of coating material due to centrifugal forces.

The preform is preferably dipped for a period of time sufficient to allow for thorough coverage of the preform. Generally, this ranges from about 0.25 to about 5 seconds although times above and below this range are also included. Without wishing to be bound to any theory, it appears that longer residence time does not provide any added coating benefit.

In determining the dipping time and therefore speed, the turbidity of the coating material should also be considered. If the speed is too high the coating material may become wavelike and splatter causing coating defects. Another consideration is that many coating material solutions or dispersions form foam and/or bubbles which can interfere with the coating process. To avoid this interference, the dipping speed is preferably chosen to avoid excessive agitation of the, coating material. If necessary, anti-foam/bubble agents may be added to the coating solution/dispersion.

ii. Spray Coating

In a preferred embodiment, the coating is applied through a spray coating process. The preforms are sprayed with a coating material that is in fluid connection with a tank or other suitable container that contains the coating material. The spraying of the preforms with the coating material can be done manually with the use of a retaining rack or the like, or it may be done by a fully automated process. In a preferred embodiment, the preforms are rotating while being sprayed with the coating material. The preform preferably rotates at a speed of about 30-80 RPM, more preferably about 40 RPM, but also including about 50, 60, and 70 RPM. Preferably, the preform rotates at least about 360° while proceeding through the coating spray. This allows for thorough coating of the preform. The preform may, however, remain stationary while spray is directed at the preform.

The preform is preferably sprayed for a period of time sufficient to allow for thorough coverage of the preform. The amount of time required for spraying depends upon several factors, which may include the spraying rate (volume of spray per unit time), the area encompassed by the spray, and the like.

The coating material is contained in a tank or other suitable container in fluid communication with the production line. Preferably a closed system is used in which unused coating material is recycled. In one embodiment, this may be accomplished by collecting any unused coating material in a coating material collector which is in fluid communication with the coating material tank. Many coating material solutions or dispersions form foam and/or bubbles which can interfere with the coating process. To avoid this interference, the coating material is preferably removed from the bottom or middle of the tank. Additionally, it is preferable to decelerate the material flow prior to returning to the coating tank to further reduce foam and/or bubbles. This can be done by means known to those of skill in the art. If necessary, anti-foam/bubble agents may be added to the coating solution/dispersion.

In determining the spraying time and associated parameters such as nozzle size and configuration, the properties of the coating material should also be considered. If the speed is too high and/or the nozzle size incorrect, the coating material may splatter causing coating defects. If the speed is too slow or the nozzle size incorrect, the coating material may be applied in a manner thicker than desired. Suitable spray apparatus include those sold by Nordson Corporation (Westlake, Ohio). Another consideration is that many coating material solutions or dispersions form foam and/or bubbles which can interfere with the coating process. To avoid this interference, the spraying speed, nozzle used and fluid connections are preferably chosen to avoid excessive agitation of the coating material. If necessary, anti-foam/bubble agents may be added to the coating solution/dispersion.

iii. Flow Coating

In a preferred embodiment, the coating is applied through a flow coating process. The object of flow coating is to provide a sheet of material, similar to a falling shower curtain or waterfall, that the preform passes through for thorough coating. Advantageously, preferred methods of flow coating allow for a short residence time of the preform in the coating material. The preform need only pass through the sheet a period of time sufficient to coat the surface of the preform. Without wishing to be bound to any theory, it appears that longer residence time does not provide any added coating benefit.

In order to provide an even coating the preform is preferably rotating while it proceeds through the sheet of coating material. The preform preferably rotates at a speed of about 30-80 RPM, more preferably about 40 RPM, but also including 50, 60, and 70 RPM. Preferably, the preform rotates at least about two full rotations or 7200 while being proceeding through the sheet of coating material. In one preferred embodiment, the preform is rotating and placed at an angle while it proceeds through the coating material sheet. The angle of the preform is preferably acute to the plane of the coating material sheet. This advantageously allows for thorough coating of the preform without coating the neck portion or inside of the preform. In another preferred embodiment, the preform 1 as shown in FIG. 16 is vertical, or perpendicular to the floor, while it proceeds through the coating material sheet. It has been found that as the coating material sheet comes into contact with the preform the sheet tends to creep up the wall of the preform from the initial point of contact. One of skill in the art can control this creep effect by adjusting parameters such as the flow rate, coating material viscosity, and physical placement of the coating sheet material relative to the preform. For example, as the flow increases the creep effect may also increase and possibly cause the coating material to coat more of the preform than is desirable. As another example, by decreasing the angle of the preform relative to the coating material sheet, coating thickness may be adjusted to retain more material at the center or body of the preform as the angle adjustment decreases the amount of material removed or displaced to the bottom of the preform by gravity. The ability to manipulate this creep effect advantageously allows for thorough coating of the preform without coating the neck portion or inside of the preform.

The coating material is contained in a tank or other suitable container in fluid communication with the production line in a closed system. It is preferable to recycle any unused coating material. In one embodiment, this may be accomplished by collecting the returning waterfall flow stream in a coating material collector which is in fluid communication with the coating material tank. Many coating material solutions or dispersions form foam and/or bubbles which can interfere with the coating process. To avoid this interference, the coating material is preferably removed from the bottom or middle of the tank. Additionally, it is preferable to decelerate the material flow prior to returning to the coating tank to further reduce foam and/or bubbles. This can be done by means known to those of skill in the art. If necessary, anti-foam/bubble agents may be added to the coating solution/dispersion.

In choosing the proper flow rate of coating materials, several variables should be considered to provide proper sheeting, including coating material viscosity, flow rate velocity, length and diameter of the preform, line speed and preform spacing.

The flow rate velocity determines the accuracy of the sheet of material. If the flow rate is too fast or too slow, the material may not accurately coat the preforms. When the flow rate is too fast, the material may splatter and overshoot the production line causing incomplete coating of the preform, waste of the coating material, and increased foam and/or bubble problems. If the flow rate is too slow the coating material may only partially coat the preform.

The length and the diameter of the preform to be coated should also be considered when choosing a flow rate. The sheet of material should thoroughly cover the entire preform, therefore flow rate adjustments may be necessary when the length and diameter of preforms are changed.

Another factor to consider is the spacing of the preforms on the line. As the preforms are run through the sheet of material a so-called wake effect may be observed. If the next preform passes through the sheet in the wake of the prior preform it may not receive a proper coating. Therefore it is important to monitor the speed and center line of the preforms. The speed of the preforms will be dependant on the throughput of the specific equipment used.

c. Removal of Excess Material

Advantageously preferred methods provide such efficient deposition that virtually all of the coating on the preform is utilized (i.e. there is virtually no excess material to remove). However there are situations where it is necessary to remove excess coating material after the preform is coated by dip, spray or flow methods. Preferably, the rotation speed and gravity will work together to normalize the sheet on the preform and remove any excess material. Preferably, preforms are allowed to normalize for about 5 to about 15 seconds, more preferably about 10 seconds. If the tank holding the coating material is positioned in a manner that allows the preform to pass over the tank after coating, the rotation of the preform and gravity may cause some excess material to drip off of the preform back into the coating material tank. This allows the excess material to be recycled without any additional effort. If the tank is situated in a manner where the excess material does not drip back into the tank, other suitable means of catching the excess material and returning it to be reused, such as a coating material collector or reservoir in fluid communication with the coating tank or vat, may be employed.

Where the above methods are impractical due to production circumstances or insufficient, various methods and apparatus, such as a drip remover, known to those skilled in the art may be used to remove the excess material. For example, suitable drip removers include one or more of the following: a wiper, brush, sponge roller, air knife or air flow, which may be used alone or in conjunction with each other. Further, any of these methods may be combined with the rotation and gravity method described above. Preferably any excess material removed by these methods is recycled for further use.

d. Drying and Curing

After the preform has been coated and any excess material removed, the coated preform is then dried and cured. The drying and curing process is preferably performed by infrared (IR) heating. Such heating is described in PCT/US2005/024726, entitled “Coating Process and Apparatus for Forming Coated Articles”, now published as WO 2006/010141 A2, which is incorporated by reference. In one embodiment, a 1000 W quartz IR lamp 200 is used as the source. A preferred source is a General Electric Q1500 T3/CL Quartzline Tungsten-Halogen lamp. This particular source and equivalent sources may be purchased commercially from any of a number of sources including General Electric and Phillips. The source may be used at full capacity, or it may be used at partial capacity such as at about 50%, about 65%, about 75% and the like. Preferred embodiments may use a single lamp or a combination of multiple lamps. For example, six IR lamps may be used at 70% capacity.

Preferred embodiments may also use lamps whose physical orientation with respect to the preform is adjustable. The lamp position may be adjusted to position the lamp closer to or farther away from the preform. For example, in one embodiment with multiple lamps, it may be desirable to move one or more of the lamps located below the bottom of the preform closer to the preform. This advantageously allows for thorough curing of the bottom of the preform. Embodiments with adjustable lamps may also be used with preforms of varying widths. For example, if a preform is wider at the top than at the bottom, the lamps may be positioned closer to the preform at the bottom of the preform to ensure even curing. The lamps are preferably oriented so as to provide relatively even illumination of all surfaces of the coating.

In other embodiments reflectors are used in combination with IR lamps to provide thorough curing. In preferred embodiments lamps are positioned on one side of the processing line while one or more reflectors are located on the opposite side of or below the processing line. This advantageously reflects the lamp output back onto the preform allowing for a more thorough cure. More preferably an additional reflector is located below the preform to reflect heat from the lamps upwards towards the bottom of the preform. This advantageously allows for thorough curing of the bottom of the preform. In other preferred embodiments various combinations of reflectors may be used depending on the characteristics of the articles and the IR lamps used. More preferably reflectors are used in combination with the adjustable IR lamps described above.

In addition, the use of infrared heating allows for the thermoplastic epoxy (for example PHAE) coating to dry without overheating the PET substrate and can be used during preform heating prior to blow molding, thus making for an energy efficient system. Also, it has been found that use of IR heating can reduce blushing and improve chemical resistance.

Although this process may be performed without additional air, it is preferred that IR heating be combined with forced air. The air used may be hot, cold, or ambient. The combination of IR and air curing provides the unique attributes of superior chemical, blush, and scuff resistance of preferred embodiments. Further, without wishing to be bound to any particular theory, it is believed that the coating's chemical resistance is a function of crosslinking and curing. The more thorough the curing, the greater the chemical resistance.

In determining the length of time necessary to thoroughly dry and cure the coating several factors such as coating material, thickness of deposition, and preform substrate should be considered. Different coating materials cure faster or slower than others. Additionally, as the degree of solids increases, the cure rate decreases. Generally, for IR curing, 24 gram preforms with about 0.05 to about 0.75 grams of coating material the curing time is about 5 to 60 seconds, although times above and below this range may also be used. In some embodiments, the article may be cured by a low intensity IR cute for a long period of time. In some embodiments, a low intensity IR cure allows for full crosslinking of the articles. In other embodiments, the article may be cured by a high intensity IR cure for a shorter period of time than required for low intensity IR. In some embodiments, lower deposition weights of material or layers can be cured in combination with low intensity IR curing. In some embodiments, the deposition weight of the material or layer (if there is more than one material used to make the layer) to be cured is about 0.01 to about 0.75 g on a 24 gram preform. In other embodiments, the deposition weight of the material or layer to be cured is about 0.1 to about 0.5 grams on a 24 gram preform. In other embodiments, the deposition weight is less than 0.6 grams, including about 0.55, 0.5, 0.45, 0.4, 0.35, 0.3, 0.25, 0.2, 0.15, or about 0.1 grams of material or layer.

Another factor to consider is the surface temperature of the preform as it relates to the glass transition temperature (T_{g}) of the substrate and coating materials. Preferably the surface temperature of the coating exceeds the T_{g} of the coating materials without heating the substrate above the substrate T_{g} during the curing/drying process. This provides the desired film formation and/or crosslinking without distorting the preform shape due to overheating the substrate. For example, where the coating material has a higher T_{g} than the preform substrate material, the preform surface is preferably heated to a temperature above the T_{g} of the coating while keeping the substrate temperature at or below the substrate T_{g}. One way of regulating the drying/curing process to achieve this balance is to combine IR heating and air cooling, although other methods may also be used.

An advantage of using air in addition to IR heating is that the air regulates the surface temperature of the preform thereby allowing flexibility in controlling the penetration of the radiant heat. If a particular embodiment requires a slower cure rate or a deeper IR penetration, this can be controlled with air alone, time spent in the IR unit, or the IR lamp frequency. These may be used alone or in combination.

Preferably, the preform rotates while proceeding through the IR heater. The preform preferably rotates at a speed of about 30-80 RPM, more preferably about 40 RPM. If the rotation speed is too high, the coating will spatter causing uneven coating of the preform. If the rotation speed is too low, the preform dries unevenly. More preferably, the preform rotates at least about 360° while proceeding through the IR heater. This advantageously allows for thorough curing and drying.

In other preferred embodiments, Electron Beam Processing may be employed in lieu of IR heating or other methods. Electron Beam Processing (EBP) has not been used for curing of polymers used for and in conjunction with injection molded preforms and containers primarily due to its large size and relatively high cost. However recent advances in this technology, are expected to give rise to smaller less expensive machines. EBP accelerators are typically described in terms of their energy and power. For example, for curing and crosslinking of food film coatings, accelerators with energies of 150-500 keV are typically used.

EBP polymerization is a process in which several individual groups of molecules combine together to form one large group (polymer). When a substrate or coating is exposed to highly accelerated electrons, a reaction occurs in which the chemical bonds in the material are broken and a new, modified molecular structure is formed. This polymerization causes significant physical changes in the product, and may result in desirable characteristics such as high gloss and abrasion resistance. EBP can be a very efficient way to initiate the polymerization process in many materials.

Similar to EBP polymerization, EBP crosslinking is a chemical reaction, which alters and enhances the physical characteristics of the material being treated. It is the process by which an interconnected network of chemical bonds or links develop between large polymer chains to form a stronger molecular structure. EBP may be used to improve thermal, chemical, barrier, impact, wear and other properties of inexpensive commodity thermoplastics. EBP of crosslinkable plastics can yield materials with improved dimensional stability, reduced stress cracking, higher set temperatures, reduced solvent and water permeability and improved thermomechanical properties.

The effect of the ionizing radiation on polymeric material is manifested in one of three ways: (1) those that are molecular weight-increasing in nature (crosslinking); (2) those that are molecular weight-reducing in nature (scissioning); or (3), in the case of radiation resistant polymers, those in which no significant change in molecular weight is observed. Certain polymers may undergo a combination of (1) and (2). During irradiation, chain scissioning occurs simultaneously and competitively with crosslinking, the final result being determined by the ratio of the yields of these reactions. Polymers containing a hydrogen atom at each carbon atom predominantly undergo crosslinking, while for those polymers containing quaternary carbon atoms and polymers of the —CX₂—CX₂— type (when X=halogen), chain scissioning predominates. Aromatic polystyrene and polycarbonate are relatively resistant to EBP.

For polyvinylchloride, polypropylene and PET, both directions of transformation are possible; certain conditions exist for the predominance of each one. The ratio of crosslinking to scissioning may depend on several factors, including total irradiation dose, dose rate, the presence of oxygen, stabilizers, radical scavengers, and/or hindrances derived from structural crystalline forces.

Overall property effects of crosslinking can be conflicting and contrary, especially in copolymers and blends. For example, after EBP, highly crystalline polymers like HDPE may not show significant change in tensile strength, a property derived from the crystalline structure, but may demonstrate a significant improvement in properties associated with the behavior of the amorphous structure, such as impact and stress crack resistance.

Aromatic polyamides (Nylons) are considerably responsive to ionizing radiation. After exposure the tensile strength of aromatic polyamides does not improve, but for a blend of aromatic polyamides with linear aliphatic polyamides, an increase in tensile strength is derived together with a substantial decrease in elongation.

EBP may be used as an alternative to IR for more precise and rapid curing of TPE coatings applied to preforms and containers.

It is believed that when used in conjunction with dip, spray, or flow coating, EBP may have the potential to provide lower cost, improved speed and/or improved control of crosslinking when compared to IR curing. EBP may also be beneficial in that the changes it brings about occur in solid state as opposed to alternative chemical and thermal reactions carried out with melted polymer.

In other preferred embodiments, gas heaters, UV radiation, and flame may be employed in addition to or in lieu of IR or EPB curing. Preferably the drying/curing unit is placed at a sufficient distance or isolated from the coating material tank and/or the flow coating sheet as to avoid unwanted curing of unused coating material.

e. Cooling

The preform may then be cooled. The preform may be subjected to a surface treatment prior to cooling or after cooling The cooling process combines with the curing process to provide enhanced chemical, blush and scuff resistance. It is believed that this is due to the removal of solvents and volatiles after a single coating and between sequential coatings.

In one embodiment the cooling process occurs at ambient temperature. In another embodiment, the cooling process is accelerated by the use of forced ambient or cool air.

There are several factors to consider during the cooling process. It is preferable that the surface temperature of the preform is below the T_{g} of the lower of the T_{g} of the preform substrate or coating. For example, some coating materials have a lower T_{g} than the preform substrate material, in this example the preform should be cooled to a temperature below the T_{g} of the coating. Where the preform substrate has the lower T_{g} the preform should be cooled below the T_{g} of the preform substrate.

Cooling time is also affected by where in the process the cooling occurs. In a preferred embodiment multiple coatings are applied to each preform. When the cooling step is prior to a subsequent coating, cooling times may be reduced as elevated preform temperature is believed to enhance the coating process. Although cooling times vary, they are generally about 5 to 40 seconds for 24 gram preforms with about 0.05 to about 0.75 grams of coating material.

f. Ejection from System

In one embodiment, once the preform has cooled it will be ejected from the system and prepared for packaging. In another embodiment the preform will be ejected from the coating system and sent to a blow-molding machine for further processing. In yet another embodiment, the coated preform is handed off to another coating module where a further coat or coats are applied. This further system may or may not be connected to further coating modules or a blow molding-machine.

g. Recycle

Advantageously, bottles made by, or resulting from, a preferred process described above may be easily recycled. Using current recycling processes, the coating can be easily removed from the recovered PET. For example, a polyhydroxyaminoether based coating applied by dip coating and cured by IR heating can be removed in 30 seconds when exposed to an 80° C. aqueous solution with a pH of 12. Additionally, aqueous solutions with a pH equal to or lower than 4 can be used to remove the coating. Variations in acid salts made from the polyhydroxyaminoethers may change the conditions needed for coating removal. For example, the acid salt resulting from the acetic solution of a polyhydroxyaminoether resin can be removed with the use of an 80° C. aqueous solution at a neutral pH. Alternatively, the recycle methods set forth in U.S. Pat. No. 6,528,546, entitled Recycling of Articles Comprising Hydroxy-phenoxyether Polymers, may also be used. The methods disclosed in this application are herein incorporated by reference.

2. Overmolding

One method of producing a coated preform is referred to herein generally as overmolding, and sometimes as inject-over-inject (“IOI”). The name refers to a procedure which uses injection molding to inject one or more layers of barrier material over an existing preform, preferably that which was itself made by injection molding. The terms “overinjecting” and “overmolding” are used herein to describe the coating process whereby a layer of material, preferably comprising barrier material, is injected over an existing preform. In one embodiment, the overinjecting process is performed while the underlying preform has not yet fully solidified. Overinjecting may be used to place one or more additional layers of materials such as those comprising barrier material, recycled PET, or other materials over a coated or uncoated preform.

The same surface pre-treatment concept can be applied to any multilayer injection overmolding system (including IOI and Index systems, including, but not limited to those known in the art), insert molding systems, and any other method whereby one plastic material adheres to another, to enhance the adhesion between layers of similar or dissimilar materials. As such, any of the previously described methods may also be applied to an overmolding process. In the case of injection-based coatings, a surface treatment material may be introduced using individual heads for each preform or by a tunnel.

In some embodiments, a preform may be formed by an injection molding process. As the preform is cooled, it may be ejected from the injection molding apparatus and be exposed to a field of treatment according to one or more treatment processes as described herein. Subsequently, the preform may be subjected to an overmolding process as further described herein. Such a method may improve adhesion between the base substrate layer of the preform and the coating layer.

The overmolding is carried out by using an injection molding process using equipment similar to that used to form the uncoated preform itself. A preferred mold for overmolding, with an uncoated preform in place is shown in FIG. 14. The mold comprises two halves, a cavity half 52 and a mandrel half 51, and is shown in FIG. 14 in the closed position prior to overinjecting. The cavity half 52 comprises a cavity in which the uncoated preform is placed. The support ring 6 of the preform rests on a ledge 58 and is held in place by the mandrel half 51 which exerts pressure on the support ring 6, thus sealing the neck portion off from the body portion of the preform. The cavity half 52 has a plurality of tubes or channels 55 therein which carry a fluid. Preferably the fluid in the channels circulates in a path in which the fluid passes into an input in the cavity half 52, through the channels 55, out of the cavity half 52 through an output, through a chiller or other cooling means, and then back into the input. The circulating fluid serves to cool the mold, which in turn cools the plastic melt which is injected into the mold to form the coated preform.

The mandrel half of the mold comprises a mandrel. The mandrel 96, sometimes called a core, protrudes from the mandrel half 51 of the mold and occupies the central cavity of the preform. In addition to helping to center the preform in the mold, the mandrel 96 cools the interior of the preform. The cooling is done by fluid circulating through channels 57 in the mandrel half 51 of the mold, most importantly through the length of the mandrel 96 itself. The channels 57 of the mandrel half 51 work in a similar to the channels 55 in the cavity half 52, in that they create the portion of the path through which the cooling fluid travels which lies in the interior of the mold half.

As the preform sits in the mold cavity, the body portion of the preform is centered within the cavity and is completely surrounded by a void space 60. The preform, thus positioned, acts as an interior die mandrel in the subsequent injection procedure. The melt of the overmolding material, preferably comprising a barrier material, is then introduced into the mold cavity from the injector via gate 56 and flows around the preform, preferably surrounding at least the body portion 4 of the preform. Following overinjection, the overmolded layer will take the approximate size and shape of the void space 60.

To carry out the overmolding procedure, one preferably heats the initial preform which is to be coated to a temperature above its Tg. In the case of PET, that temperature is preferably 100 to 200° C., more preferably 180-225° C. If a temperature at or above the temperature of crystallization for PET is used, which is about 120° C., care should be taken when cooling the PET in the preform. The cooling should be sufficient to allow for the PET in the preform to take the preferred amorphous state, rather than the crystalline state. Alternatively, the initial preform used may be one which has been very recently injection molded and not fully cooled, as to be at an elevated temperature as is preferred for the overmolding process.

The coating material is heated to form a melt of a viscosity compatible with use in an injection molding apparatus. The temperature for this, the inject temperature, will differ among materials, as melting ranges in polymers and viscosities of melts may vary due to the history, chemical character, molecular weight, degree of branching and other characteristics of a material. For the preferred barrier materials disclosed above, the inject temperature is preferably in the range of about 175-325° C., more preferably 200 to 275° C. For example, for the Copolyester Barrier Material B-010, the preferred temperature is around 275° C., whereas for the PHAE XU-19040.00, the preferred temperature is around 200° C. If recycled PET is used, the inject temperature is preferably 250-300° C. The coating material is then injected into the mold in a volume sufficient to fill the void space 60. If the coating material comprises barrier material, the coating layer is a barrier layer.

The coated preform is preferably cooled at least to the point where it can be displaced from the mold or handled without being damaged, and removed from the mold where further cooling may take place. If PET is used, and the preform has been heated to a temperature near or above the temperature of crystallization for PET, the cooling should be fairly rapid and sufficient to ensure that the PET is primarily in the amorphous state when the preform is fully cooled. As a result of this process, a strong and effective bonding takes place between the initial preform and the subsequently applied coating material.

Overmolding can be also used to create coated preforms with three or more layers. In FIG. 9, there is shown a three-layer embodiment of preform of the present invention. The preform shown therein has two coating layers, a middle layer 80 and an outer layer 82. The relative thickness of the layers shown in FIG. 9 may be varied to suit a particular combination of layer materials or to allow for the making of different sized bottles. As will be understood by one skilled in the art, a procedure analogous to that disclosed above would be followed, except that the initial preform would be one which had already been coated, as by one of the methods for making coated preforms described herein, including overmolding.

a. Preferred Apparatus for Surface Treatment Overmolding

The preferred apparatus for performing the overmolding process is based upon the use of a 330-330-200 machine by Engel (Austria), the mold portion of which comprises a stationary half and a movable half. Both halves are preferably made from hard metal. The stationary half comprises at least two mold sections, wherein each mold section comprises N (N>0) identical mold cavities, an input and output for cooling fluid, channels allowing for circulation of cooling fluid within the mold section, injection apparatus, and hot runners channeling the molten material from the injection apparatus to the gate of each mold cavity. Because each mold section forms a distinct preform layer, and each preform layer is preferably made of a different material, each mold section is separately controlled to accommodate the potentially different conditions required for each material and layer. The injector associated with a particular mold section injects a molten material, at a temperature suitable for that particular material, through that mold section's hot runners and gates and into the mold cavities. The mold section's own input and output for cooling fluid allow for changing the temperature of the mold section to accommodate the characteristics of the particular material injected into a mold section. Consequently, each mold section may have a different injection temperature, mold temperature, pressure, injection volume, cooling fluid temperature, etc. to accommodate the material and operational requirements of a particular preform layer.

Referring to FIG. 15, the movable half of the mold comprises a turntable 202 and a plurality of cores or mandrels 96. The alignment pins guide the plate to slidably move in a preferably horizontal direction towards or away from the stationary half. The turntable may rotate in either a clockwise or counterclockwise direction, and is mounted onto the plate. The plurality of mandrels are affixed onto the turntable. These mandrels serve as the mold form for the interior of the preform, as well as serving as a carrier and cooling means for the preform during the molding operation. The cooling means in the mandrels is separate from the cooling means in the mold sections.

The mold temperature or cooling for the mold is controlled by means of circulating fluid. There is separate cooling fluid circulation for the movable half and for each of the mold sections of the stationary half. Therefore, in a mold having two mold sections in the stationary half, there is separate cooling for each of the two mold sections plus separate cooling for the movable half of the mold. Analogously, in a mold having three mold sections in the stationary half, there are four separate cooling fluid circulation set ups: one for each mold section, for a total of three, plus one for the movable half. Each cooling fluid circulation set up works in a similar manner. The fluid enters the mold, flows through a network of channels or tubes inside as discussed above for FIG. 9, and then exits through an output. From the output, the fluid travels through a pump means, which keeps the fluid flowing, and a chilling means to keep the fluid within the desired temperature range, before going back into the mold.

In a preferred embodiment, the mandrels and cavities comprise a high heat transfer material, such a beryllium, which is coated with a hard metal, such as tin or chrome. The hard coating keeps the beryllium from direct contact with the preform, as well as acting as a release for ejection and providing a hard surface for long life. The high heat transfer material allows for more efficient cooling, and thus assists in achieving lower cycle times. The high heat transfer material may be disposed over the entire area of each mandrel and/or cavity, or it may be only on portions thereof. Preferably the at least the tips of the mandrels comprise high heat transfer material.

The number of mandrels is equal to the total number of cavities, and the arrangement of the mandrels on the movable half mirrors the arrangement of the cavities on the stationary half. To close the mold, the movable half moves towards the stationary half, mating the mandrels with the cavities. To open the mold, the movable half moves away from the stationary half such that the mandrels are well clear of the block on the stationary half. After the mandrels are fully withdrawn from the mold sections, the turntable of the movable half rotates the mandrels into alignment with a different mold section. Thus, the movable half rotates 360°/(number of mold sections in the stationary half) degrees after each withdrawal of the mandrels from the stationary half. When the machine is in operation, during the withdrawal and rotation steps, there will be preforms present on some or all of the mandrels.

The size of the cavities in a given mold section will be identical, however the size of the cavities will differ among the mold sections. The cavities in which the uncoated preforms are first molded, the preform molding cavities, are smallest in size. The size of the cavities in the mold section in which the first coating step is performed are larger than the preform molding cavities, in order to accommodate the uncoated preform and still provide space for the coating material to be injected into to form the overmolded coating. The cavities in each subsequent mold section wherein additional overmolding steps are performed will be increasingly larger in size to accommodate the preform as it gets larger with each coating step.

After a set of preforms has been molded and overmolded to completion, a series of ejectors eject the finished preforms off of the mandrels. The ejectors for the mandrels operate independently, or at least there is a single ejector for a set of mandrels equal in number and configuration to a single mold section, so that only the completed preforms are ejected. Uncoated or incompletely-coated preforms remain on the mandrels so that they may continue in the cycle to the next mold section. The ejection may cause the preforms to completely separate from the mandrels to fall into a bin or onto a conveyor. Alternatively, the preforms may remain on the mandrels after ejection, after which a robotic arm or other such apparatus grasps a preform or group of preforms for removal to a bin, conveyor, or other desired location.

FIGS. 15 and 16 illustrate a schematic for an embodiment of the apparatus described above. FIG. 16 is the stationary half of the mold. In this embodiment, the block 201 has two mold sections, one comprising a set of three preform molding cavities 98 and the other comprising a set of three preform coating cavities 200. Each of the preform coating cavities 200 is preferably like that shown in FIG. 14, discussed above. Each of the preform molding cavities 98 is preferably similar to that shown in FIG. 14, in that the material is injected into a space defined by the mandrel (albeit without a preform already thereon) and the wall of the mold which is cooled by fluid circulating through channels inside the mold block. Consequently, one full production cycle of this apparatus will yield three two-layer preforms. If more than three preforms per cycle is desired, the stationary half can be reconfigured to accommodate more cavities in each of the mold sections. An example of this is seen in FIG. 18, wherein there is shown a stationary half of a mold comprising two mold sections, one comprising forty-eight preform molding cavities 98 and the other comprising forty-eight preform coating cavities 200. If a three or more layer preform is desired, the stationary half can be reconfigured to accommodate additional mold sections, one for each preform layer.

FIG. 15 illustrates the movable half of the mold. The movable half comprises six identical mandrels 96 mounted on the turntable 202. Each mandrel corresponds to a cavity on the stationary half of the mold. The movable half also comprises alignment pegs 93, which correspond to the receptacles 95 on the stationary half. When the movable half of the mold moves to close the mold, the alignment pegs 93 are mated with their corresponding receptacles 95 such that the molding cavities 98 and the coating cavities 200 align with the mandrels 96. After alignment and closure, half of the mandrels 96 are centered within preform molding cavities 98 and the other half of the mandrels 96 are centered within preform coating cavities 200.

The configuration of the cavities, mandrels, and alignment pegs and receptacles must all have sufficient symmetry such that after the mold is separated and rotated the proper number of degrees, all of the mandrels line up with cavities and all alignment pegs line up with receptacles. Moreover, each mandrel must be in a cavity in a different mold section than it was in prior to rotation in order to achieve the orderly process of molding and overmolding in an identical fashion for each preform made in the machine.

Two views of the two mold halves together are shown in FIGS. 19 and 20. In FIG. 19, the movable half is moving towards the stationary half, as indicated by the arrow. Two mandrels 96, mounted on the turntable 202, are beginning to enter cavities, one enters a molding cavity 98 and the other is entering a coating cavity 200 mounted in the block 201. In FIG. 16, the mandrels 96 are fully withdrawn from the cavities on the stationary side. In this figure, the cooling arrangement is shown schematically, wherein the preform molding cavity 98 has cooling circulation 206 which is separate from the cooling circulation 208 for the preform coating cavity 200 which comprises the other mold section. The two mandrels 96 are cooled by a single system 204 which links all the mandrels together. The arrow in FIG. 20 shows the rotation of the turntable 202. The turntable could also rotate clockwise. Not shown are coated and uncoated preforms which would be on the mandrels if the machine were in operation. The alignment pegs and receptacles have also been left out for the sake of clarity.

The operation of the overmolding apparatus will be discussed in terms of the preferred two mold section apparatus for making a two-layer preform. The mold is closed by moving the movable half towards the stationary half until they are in contact. A first injection apparatus injects a melt of first material into the first mold section, through the hot runners and into the preform molding cavities 98 via their respective gates to form the uncoated preforms each of which become the inner layer of a coated preform. The first material fills the void between the preform molding cavities 98 and the mandrels 96. Simultaneously, a second injection apparatus injects a melt of second material into the second mold section of the stationary half, through the hot runners and into each preform coating cavity 200 via their respective gates, such that the second material fills the void (60 in FIG. 14) between the wall of the coating cavity 200 and the uncoated preform mounted on the mandrel 96 therein.

During this entire process, cooling fluid is circulating through the three separate areas 206, 208, and 204, corresponding to the mold section of the preform molding cavities, mold section of the preform coating cavities, and the movable half of the mold, respectively. Thus, the melts and preforms are being cooled in the center by the circulation in the movable half that goes through the interior of the mandrels, as well as on the outside by the circulation in each of the cavities. The operating parameters of the cooling fluid in the first mold section containing preform molding cavities 98 are separately controlled from the operating parameters of the cooling fluid in the second mold section containing the coating cavities to account for the different material characteristics of the preform and the coating. These are in turn separate from those of the movable half of the mold which provides constant cooling for the interior of the preform throughout the cycle, whether the mold is open or closed.

The movable half then slides back to separate the two mold halves and open the mold, until all of the mandrels 96 having preforms thereon are completely withdrawn from the preform molding cavities 98 and preform coating cavities 200. The ejectors eject the coated, finished preforms off of the mandrels 96 which were just removed from the preform coating cavities. As discussed above, the ejection may cause the preforms 96 to completely separate from the mandrels and fall into a bin or onto a conveyor, or if the preforms remain on the mandrels after ejection, a robotic arm or other apparatus may grasp a preform or group of preforms for removal to a bin, conveyor, or other desired location. The turntable 202 then rotates 180□ so that each mandrel 96 having an uncoated preform thereon is positioned over a preform coating cavity 200, and each mandrel from which a coated preform was just ejected is positioned over a preform molding cavity 98. Rotation of the turntable 202 may occur as quickly as 0.3 seconds. Using the alignment pegs 93, the mold halves again align and close, and the first injector injects the first material into the preform molding cavity while the second injector injects the barrier material into the preform coating cavity.

A production cycle of closing the mold, injecting the melts, opening the mold, ejecting finished barrier preforms, rotating the turntable, and closing the mold is repeated, so that preforms are continuously being molded and overmolded.

When the apparatus first begins running, during the initial cycle, no preforms are yet in the preform coating cavities 200. Therefore, the operator should either prevent the second injector from injecting the second material into the second mold section during the first injection, or allow the second material to be injected and eject and then discard the resulting single layer preform comprised solely of the second material. After this start-up step, the operator may either manually control the operations or program the desired parameters such that the process is automatically controlled.

b. Method of Making 2-Layer Preforms Using Preferred Overmolding Apparatus

Two layer preforms may be made using the preferred overmolding apparatus described above. In one preferred embodiment, the two layer preform comprises an inner layer comprising polyester and an outer layer comprising barrier material. In especially preferred embodiments, the inner layer comprises virgin PET. The description hereunder is directed toward the especially preferred embodiments of two layer preforms comprising an inner layer of virgin PET. The description is directed toward describing the formation of a single set of coated preforms of the type seen in FIG. 3, that is, following a set of preforms through the process of molding, overmolding and ejection, rather than describing the operation of the apparatus as a whole. The process described is directed toward preforms having a total thickness in the wall portion 3 of about 3 mm, comprising about 2 mm of virgin PET and about 1 mm of barrier material. The thickness of the two layers will vary in other portions of the preform, as shown in FIG. 3.

It will be apparent to one skilled in the art that some of the parameters detailed below will differ if other embodiments of preforms are used. For example, the amount of time which the mold stays closed will vary depending upon the wall thickness of the preforms. However, given the disclosure below for this preferred embodiment and the remainder of the disclosure herein, one skilled in the art would be able to determine appropriate parameters for other preform embodiments.

The apparatus described above is set up so that the injector supplying the mold section containing the preform molding cavities 98 is fed with virgin PET and that the injector supplying the mold section containing the preform coating cavities 200 is fed with a barrier material. Both mold halves are cooled by circulating fluid, preferably water, at a temperature of preferably 0-50° C., more preferably 10-15° C.

The movable half of the mold is moved so that the mold is closed. A melt of virgin PET is injected through the back of the block 201 and into each preform molding cavity 98 to form an uncoated preform which becomes the inner layer of the coated preform. The injection temperature of the PET melt is preferably 250 to 300° C., more preferably 265 to 280° C. The mold is kept closed for preferably 3 to 10 seconds, more preferably 4 to 6 seconds while the PET is cooled by the water circulating in the mold. During this time, surfaces of the preforms which are in contact with surfaces of preform molding cavities 98 or mandrels 96 begin to form a skin while the cores of the preforms remain molten and unsolidified.

The movable half of the mold is then moved so that the two halves of the mold are separated at or past the point where the newly molded preforms, which remain on the mandrels 96, are clear of the stationary side of the mold. The interior of the preforms, in contact with the mandrel 96, continues to cool. The cooling is preferably done in a manner which removes heat at a rate greater than the crystallization rate for the PET so that in the preform the PET will be in the amorphous state. The chilled water circulating through the mold, as described above, should be sufficient to accomplish this task. However, while the inside of the preform is cooling, the temperature of the exterior surface of the preform begins to rise, as it absorbs heat from the molten core of the preform. This heating begins to soften the skin on the exterior surface of the newly molded preform.

The turntable 202 then rotates 180° so that each mandrel 96 having a molded preform thereon is positioned over a preform coating cavity 200. Thus positioned, each of the other mandrels 96 which do not have molded preforms thereon, are each positioned over a preform molding cavity 98. The mold is again closed. Preferably the time between removal from the preform molding cavity to insertion into the preform coating cavity is 1 to 10 seconds, more preferably 1 to 3 seconds.

When the molded preforms are first placed into preform coating cavities 200, the exterior surfaces of the preforms are not in contact with a mold surface. Thus, the exterior skin is still softened and hot as described above because the contact cooling is only from the mandrel inside. The high temperature of the exterior surface of the uncoated preform (which forms the inner layer of the coated preform) aids in promoting adhesion between the PET and barrier layers in the finished barrier coated preform. It is postulated that the surfaces of the materials are more reactive when hot, and thus chemical interactions between the barrier material and the virgin PET will be enhanced by the high temperatures. Barrier material will coat and adhere to a preform with a cold surface, and thus the operation may be performed using a cold initial uncoated preform, but the adhesion is markedly better when the overmolding process is done at an elevated temperature, as occurs immediately following the molding of the uncoated preform.

A second injection operation then follows in which a melt of a barrier material, is injected into each preform coating cavity 200 to coat the preforms. The temperature of the melt of barrier material is preferably 160 to 300° C. The exact temperature range for any individual barrier material is dependent upon the specific characteristics of that barrier material, but it is well within the abilities of one skilled in the art to determine a suitable range by routine experimentation given the disclosure herein. For example, if the PHAE barrier material XU19040.00L is used, the temperature of the melt (inject temperature) is preferably 160 to 240° C., more preferably 200 to 220° C. If the Copolyester Barrier Material B-010 is used, the injection temperature is preferably 160 to 240° C., more preferably 200 to 220° C. During the same time that this set of preforms are being overmolded with barrier material in the preform coating cavities 200, another set of uncoated preforms is being molded in the preform molding cavities as described above.

The two halves of the mold are again separated preferably 3 to 10 seconds, more preferably 4 to 6 seconds following the initiation of the injection step. The preforms which have just been barrier coated in the preform coating cavities 200, are ejected from the mandrels 96. The uncoated preforms which were just molded in preform molding cavities 98 remain on their mandrels 96. The turntable is then rotated 180° so that each mandrel having an uncoated preform thereon is positioned over a coating cavity 200 and each mandrel 96 from which a coated preform was just removed is positioned over a molding cavity 98.

The cycle of closing the mold, injecting the materials, opening the mold, ejecting finished barrier preforms, rotating the turntable, and closing the mold is repeated, so that preforms are continuously being molded and overmolded. After the first mold, the preforms may be surface treated according to methods described herein.

One of the many advantages of using the process disclosed herein is that the cycle times for the process are similar to those for the standard process to produce uncoated preforms; that is the molding and coating of preforms by this process is done in a period of time similar to that required to make uncoated PET preforms of similar size by standard methods currently used in preform production. Therefore, one can make barrier coated PET preforms instead of uncoated PET preforms without a significant change in production output and capacity.

If a PET melt cools slowly, the PET will take on a crystalline form. Because crystalline polymers do not blow mold as well as amorphous polymers, a preform of crystalline PET would not be expected to perform as well in forming containers according to the present invention. If, however, the PET is cooled at a rate faster than the crystal formation rate, as is described herein, it will take on an amorphous form. The amorphous form is ideal for blow molding. Thus, sufficient cooling of the PET is crucial to forming preforms which will perform as needed when processed.

The rate at which a layer of PET cools in a mold such as described herein is proportional to the thickness of the layer of PET, as well as the temperature of the cooling surfaces with which it is in contact. If the mold temperature factor is held constant, a thick layer of PET cools more slowly than a thin layer. This is because it takes a longer period of time for heat to transfer from the inner portion of a thick PET layer to the outer surface of the PET which is in contact with the cooling surfaces of the mold than it would for a thinner layer of PET because of the greater distance the heat must travel in the thicker layer. Thus, a preform having a thicker layer of PET needs to be in contact with the cooling surfaces of the mold for a longer time than does a preform having a thinner layer of PET. In other words, with all things being equal, it takes longer to mold a preform having a thick wall of PET than it takes to mold a preform having a thin wall of PET.

The uncoated preforms of this invention, including those made by the first injection in the above-described apparatus, are preferably thinner than a conventional PET preform for a given container size. This is because in making the barrier coated preforms of the present invention, a quantity of the PET which would be in a conventional PET preform can be displaced by a similar quantity of one of the preferred barrier materials. This can be done because the preferred barrier materials have physical properties similar to PET, as described above. Thus, when the barrier materials displace an approximately equal quantity of PET in the walls of a preform or container, there will not be a significant difference in the physical performance of the container. Because the preferred uncoated preforms which form the inner layer of the barrier coated preforms of the present invention are thin-walled, they can be removed from the mold sooner than their thicker-walled conventional counterparts. For example, the uncoated preform of the present invention can be removed from the mold preferably after about 4-6 seconds without crystallizing, as compared to about 14-24 seconds for a conventional PET preform having a total wall thickness of about 3 mm. All in all, the time to make a barrier coated preform of the present invention is equal to or slightly greater (up to about 30%) than the time required to make a monolayer PET preform of this same total thickness.

Additionally, because the preferred barrier materials are amorphous, they will not require the same type of treatment as the PET. Thus, the cycle time for a molding-overmolding process as described above is generally dictated by the cooling time required by the PET. In the above-described method, barrier coated preforms can be made in about the same time it takes to produce an uncoated conventional preform.

The physical characteristics of the preferred barrier materials of the present invention help to make this type of preform design workable. Because of the similarity in physical properties, containers having wall portions which are primarily barrier material can be made without sacrificing the performance of the container. If the barrier material used were not similar to PET, a container having a variable wall composition as in FIG. 4 would likely have weak spots or other defects that could affect container performance.

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; U.S. patent application Ser. No. 09/745,013 (Publication No. 2002-0100566); U.S. patent application Ser. No. 10/168,496 (Publication No. 2003-0220036); U.S. patent application Ser. No. 09/844,820 (2003-0031814); 10/090,471 (Publication No. 2003-0012904); U.S. patent application Ser. No. 10/395,899 (Publication No. 2004-0013833); U.S. patent application Ser. No. 10/614,731 (Publication No. 2004-0071885), U.S. patent application Ser. No. 11/149,984 (Publication No. 2006-0051451A1); provisional application 60/563,021, filed Apr. 16, 2004, provisional application 60/575,231, filed May 28, 2004, provisional application 60/586,399, filed Jul. 7, 2004, provisional application 60/620,160, filed Oct. 18, 2004, provisional application 60/621,511, filed Oct. 22, 2004, and provisional application 60/643,008, filed Jan. 11, 2005, U.S. patent application Ser. No. 11/108,342 entitled MONO AND MULTI-LAYER ARTICLES AND COMPRESSION METHODS OF MAKING THE SAME, filed on Apr. 18, 2005, U.S. patent application Ser. No. 11/108,345 entitled MONO AND MULTI-LAYER ARTICLES AND INJECTION METHODS OF MAKING THE SAME, filed on Apr. 18, 2005, U.S. patent application Ser. No. 11/108,607 entitled MONO AND MULTI-LAYER ARTICLES AND EXTRUSION METHODS OF MAKING THE SAME, filed on Apr. 18, 2005, which are hereby incorporated by reference in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A method of applying one or more coatings to an article, the method comprising:
treating a surface of an article substrate with one or more selected from the group consisting of flame treatment, corona treatment, ionized air treatment, plasma air treatment and plasma arc treatment;
applying a first water-based solution, dispersion, or emulsion of a gas barrier material to a surface of the article substrate by dip, spray or flow coating to form a first coating layer; and
drying the first coating layer.

2. The method of claim 1, further comprising:
applying a second water-based solution, dispersion or emulsion of a water-resistant coating material to an outer surface of the article by dip, spray or flow coating to form a second coating layer,
drying the second coating layer.

3. The method of claim 1, wherein the step of treating a surface of an article substrate is prior to the step of applying the gas barrier material.

4. The method of claim 3, further comprising:
treating the dried, first coating layer with one or more selected from the group consisting of flame treatment, corona treatment, ionized air treatment, plasma air treatment and plasma arc treatment;
applying a second water-based solution, dispersion or emulsion of a water-resistant coating material to an outer surface of the article by dip, spray or flow coating to form a second coating layer,
drying the second coating layer.

5. The method of claim 1, wherein gas barrier material comprises one or more of a vinyl alcohol polymer or copolymer and a Phenoxy-type Thermoplastic.

6. The method of claim 1, wherein the gas barrier material comprises PGA.

7. The method of claim 1, wherein the gas barrier material comprises a vinyl alcohol polymer or copolymer.

8. The method of claim 1, wherein the gas barrier material comprises one or more selected from EVOH and PVOH.

9. The method of claim 1, wherein the gas barrier material comprises a Phenoxy-type Thermoplastic.

10. The method of claim 9, wherein the gas barrier materials comprises a PHAE.

11. The method of claim 10, wherein the gas barrier material comprises a blend of two or more selected from EVOH, PVOH, and a PHAE.

12. The method of claim 2, wherein the water resistant coating material comprises a polyolefin polymer or copolymer.

13. The method of claim 12, wherein the water resistant coating material comprises PE, PP, or copolymers thereof.

14. The method of claim 2, wherein the water resistant coating material comprises a wax.

15. The method of claim 2, wherein the water resistant coating material comprises an acrylic polymer or copolymer.

16. The method of claim 2, wherein the water resistant coating material comprises blend of polypropylene and EAA.

17. The method of claim 1, wherein the article substrate comprises one or more selected from the group consisting of PET, PP, and PLA.

18. The method of claim 1, wherein a top coat layer comprises PEI.

19. The method of claim 2, wherein the second coating layer is a top coat layer.

20. A method for making a barrier coated article comprising:
providing an article, said article having a surface;
treating a surface of the article with one or more selected from the group consisting of flame treatment, corona treatment, ionized air treatment, plasma air treatment and plasma arc treatment;
placing a first barrier material on the surface of the article to form a barrier-layered article;
wherein the first barrier material is placed on the surface by a coating method selected from the group consisting of dip coating, spray coating, flow coating, and overmolding.

21. The method of claim 20, wherein the coating method is overmolding.

22. The method of claim 20, wherein the coating method is flow coating.

23. The method of claim 20, wherein the surface of the article comprises one or more selected from PET, PP, or PLA.

24. The method of claim 20, wherein the first barrier material comprises one or more selected from a vinyl alcohol polymer or copolymer and a Phenoxy-type Thermoplastic.

25. The method of claim 20, wherein the first barrier material comprises PGA.

26. The method of claim 20, further comprising:
treating a surface of the barrier layered article with one or more selected from the group consisting of flame treatment, corona treatment, ionized air treatment, plasma air treatment and plasma arc treatment.

27. The method of claim 26, further comprising:
placing a second barrier material on the surface of the article to form a barrier-layered article;
wherein the second barrier material is placed on the surface by a coating method selected from the group consisting of dip coating, spray coating, flow coating, and overmolding.

28. The method of claim 27, wherein the second barrier material comprises one or more selected from the group consisting of an acrylic polymer or copolymer, a polyolefin polymer or copolymer, a polyurethane, an epoxy polymer, and a wax.

29. A method of forming an injected molded preform comprising:
injection molding a first material in a first mold cavity, the first material comprising one or more selected from the group consisting of polyester, polyolefin, polylactic acid, and a Phenoxy-thermplastic to form an article;
treating at least a portion of a surface of the article with a plasma treatment;
injection molding a second material on the article in a second mold cavity, the second material comprising one or more selected from the group consisting of a polyester, a polyolefin, polylactic acid, and a polyamide;
wherein the second material is directly in contact with the plasma treated portion of the surface.

30. The method of claim 29, wherein the first material comprises PEI.

31. The method of claim 29, wherein the plasma treatment is delivered to the article by one or more plasma heads.

32. The method of claims 29, further comprising delivering the plasma treatment to the article by a tunnel configured to expose a surface of the article to the plasma treatment.
